(19) United States
(12) Patent Application Publication
(10) Pub. No.: US 2025/0063293 A1
(43) Pub. Date: Feb. 20, 2025

(54) ACOUSTIC OUTPUT DEVICES

(71) Applicant: SHENZHEN SHOKZ CO., LTD., Shenzhen (CN)

(72) Inventors: Lei ZHANG, Shenzhen (CN); Guangyuan ZHU, Shenzhen (CN); Junjiang FU, Shenzhen (CN); Liwei WANG, Shenzhen (CN); Xin QI, Shenzhen (CN)

(73) Assignee: SHENZHEN SHOKZ CO., LTD., Shenzhen (CN)

(21) Appl. No.: 18/939,466

(22) Filed: Nov. 6, 2024

Related U.S. Application Data
(63) Continuation of application No. PCT/CN2022/133230, filed on Nov. 21, 2022.

(51) Int. Cl. H04R 1/28; H04R 9/02; H04R 9/04; H04R 9/06

(52) U.S. Cl. CPC H04R 1/2811; H04R 9/025; H04R 9/045; H04R 9/06; H04R 2460/13

(57) ABSTRACT

Embodiments of the present disclosure provide an acoustic output device comprising a transducer device configured to generate a mechanical vibration based on an electrical signal, the transducer device including a magnetic circuit assembly and an elastic support component; a housing configured to accommodate the transducer device, wherein the housing includes a panel and a shell, the transducer device transmitting the mechanical vibration to a user through the panel; and an additional element connected to the panel through a vibration path, the vibration path at least including an elastic element, the additional element being located at a sidewall of the shell adjacent to the panel, and the elastic support component connecting the magnetic circuit assembly and the sidewall disposed with the additional element.

### CROSS-REFERENCE TO RELATED APPLICATIONS

This application is a Continuation of International Application No. PCT/CN2022/133230 filed on Nov. 21, 2022, the contents of which are hereby incorporated by reference to its entirety.

### TECHNICAL FIELD

The present disclosure relates to a field of acoustic technology, and in particular, to acoustic output devices.

### BACKGROUND

In the design of certain acoustic output devices (e.g., headphones, hearing aids, glasses, helmets, augmented reality/virtual reality (AR/VR) equipment), it is necessary to dispose additional element(s) alongside the loudspeakers. These elements are essential for ensuring the normal operation of the loudspeakers and for enhancing the functionality of the acoustic output devices. The loudspeakers typically include a bone conduction loudspeaker and an air-conduction loudspeaker. The bone conduction loudspeaker can convert electrical signals into mechanical vibration signals, and then transmit the mechanical vibration signals to the auditory nerves of the human body through body tissues and bones, allowing a wearer to hear sounds. However, the additional element(s) (e.g., a microphone, a sensor, an air-conduction loudspeaker, a battery, a circuit board, etc.) disposed alongside the bone conduction loudspeaker have certain mass, which affects the vibrational output of the bone conduction loudspeaker and weakens the sensitivity of the bone conduction loudspeaker. Moreover, the additional element(s) and a magnetic circuit assembly in a transducer device may attract or repel to each other, causing deformation or inversion of the magnetic circuit assembly.

Therefore, it is desirable to reduce the influence of the mass of the additional element(s) disposed on the bone conduction loudspeaker on the vibration output of the bone conduction speaker to ensure that the bone conduction loudspeaker has a relatively strong sensitivity.

### SUMMARY

One of the embodiments of the present disclosure provides an acoustic output device. The acoustic output device may include a transducer, a housing, and an additional element. The transducer device may be configured to generate a mechanical vibration based on an electrical signal. The transducer device may include a magnetic circuit assembly and an elastic support component. The housing may be configured to accommodate the transducer device. The housing may include a panel and a shell, and the transducer device may transmit the mechanical vibration to a user through the panel. The additional element may be connected to the panel through a vibration path, and the vibration path at least may include an elastic element. The additional element may be located at a sidewall of the shell adjacent to the panel, and the elastic support component may connect the magnetic circuit assembly and the sidewall disposed with the additional element.

One embodiment of the present disclosure provides an acoustic output device including a transducer device, a panel and a back panel opposite to the panel, a support component, and an additional element. The transducer device may be configured to generate a mechanical vibration based on an electrical signal. The transducer device may include a magnetic circuit assembly and an elastic support component. The panel may be rigidly connected to the back panel through a housing body, and the transducer device may transmit the mechanical vibration to a user through the panel. The additional element may be rigidly connected to the support component. The support component may be disposed between a plane in which the panel is located and a plane in which the back panel is located. The support component may be connected to a housing through an elastic element. The magnetic circuit assembly may be connected to the housing body or the support component through the elastic support component.

One embodiment of the present disclosure further provides an acoustic output device including a transducer device, a panel and a back panel opposite to the panel, a support component, and an additional element. The transducer device may be configured to generate a mechanical vibration based on an electrical signal. The transducer device may include a magnetic circuit assembly and an elastic support component. The panel may be rigidly connected to the back panel through a housing body, and the transducer device may transmit the mechanical vibration to a user through the panel. The additional element may be rigidly connected to the support component. The support component may be disposed between a plane in which the panel is located and a plane in which the back panel is located. The support component may be connected to a housing through an elastic element. The magnetic circuit assembly may be connected to the housing body or the support component through the elastic support component. The magnetic circuit assembly may include an aperture portion and a positioning rod. The aperture portion may penetrate the magnetic circuit assembly in a vibration direction of the transducer device. An end of the positioning rod away from the panel may be connected to the back panel in the housing body opposite to the panel, and another end of the positioning rod passes through the aperture portion and may be connected to the panel.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary acoustic output device according to some embodiments of the present disclosure;

FIG. 2 is a schematic diagram illustrating an exemplary structure of an acoustic output device according to some embodiments of the present disclosure;

FIG. 3 is a graph of frequency response curves of acoustic output devices according to some embodiments of the present disclosure;

FIG. 4 is a schematic diagram illustrating an exemplary structure of an acoustic output device according to some embodiments of the present disclosure;

FIG. 5 is a graph of frequency response curves of acoustic output devices according to some embodiments of the present disclosure;

FIG. 6 is a graph of frequency response curves of acoustic output devices according to some embodiments of the present disclosure;

FIG. 7 is a schematic diagram illustrating an exemplary structure of an acoustic output device according to some embodiments of the present disclosure;

FIG. 8 is a graph of frequency response curves of acoustic output devices according to some embodiments of the present disclosure;

FIG. 9 is a schematic diagram illustrating an exemplary structure of an acoustic output device according to some embodiments of the present disclosure;

FIG. 10 is a graph of frequency response curves of acoustic output devices according to some embodiments of the present disclosure;

FIG. 11 is a graph of frequency response curves of an acoustic output device according to some embodiments of the present disclosure;

FIG. 12 is a schematic diagram illustrating an exemplary structure of an acoustic output device according to some embodiments of the present disclosure;

FIG. 13 is a schematic diagram illustrating an exemplary structure of an acoustic output device according to some embodiments of the present disclosure;

FIG. 14 is a graph of frequency response curves of acoustic output devices according to some embodiments of the present disclosure;

FIG. 15 is a schematic diagram illustrating an exemplary structure of an acoustic output device according to some embodiments of the present disclosure;

FIG. 16 is a graph of frequency response curves of an acoustic output device according to some embodiments of the present disclosure;

FIG. 17 is a schematic diagram illustrating an exemplary structure of an acoustic output device according to some embodiments of the present disclosure;

FIG. 18 is a schematic diagram illustrating an exemplary structure of an acoustic output device according to some embodiments of the present disclosure;

FIG. 19 is a schematic diagram illustrating an exemplary structure of an acoustic output device according to some embodiments of the present disclosure;

FIG. 20 is a schematic diagram illustrating an exemplary structure of an acoustic output device according to some embodiments of the present disclosure;

FIG. 21 is a graph of frequency response curves of an acoustic output device according to some embodiments of the present disclosure;

FIG. 22 is a schematic diagram illustrating an exemplary structure of an acoustic output device according to some embodiments of the present disclosure;

FIG. 23 is a graph of frequency response curves of an acoustic output device according to some embodiments of the present disclosure;

FIG. 24 is a schematic diagram illustrating an exemplary structure of an acoustic output device according to some embodiments of the present disclosure;

FIG. 25 is a schematic diagram illustrating an exemplary structure of an acoustic output device according to some embodiments of the present disclosure;

FIG. 26 is a schematic diagram illustrating an exemplary structure of an acoustic output device according to some embodiments of the present disclosure;

FIG. 27 is a schematic diagram illustrating an exemplary structure of an acoustic output device according to some embodiments of the present disclosure;

FIG. 28 is a graph of sound leakage frequency response curves of acoustic output devices according to some embodiments of the present disclosure;

FIG. 29 is a schematic diagram illustrating an exemplary structure of an acoustic output device according to some embodiments of the present disclosure;

FIG. 30 is a schematic diagram illustrating an exemplary structure of an acoustic output device according to some embodiments of the present disclosure;

FIG. 31 is a schematic diagram illustrating an exemplary structure of an acoustic output device according to some embodiments of the present disclosure;

FIG. 32 is a schematic diagram illustrating an exemplary structure of an acoustic output device according to some embodiments of the present disclosure;

FIG. 33 is a schematic diagram illustrating an exemplary structure of an acoustic output device according to some embodiments of the present disclosure;

FIG. 34 is a graph of frequency response curves of an acoustic output device according to some embodiments of the present disclosure;

FIG. 35 is a schematic diagram illustrating an exemplary structure of an acoustic output device according to some embodiments of the present disclosure;

FIG. 36 is a graph of frequency response curves of an acoustic output device according to some embodiments of the present disclosure;

FIG. 37 is a schematic diagram illustrating an exemplary structure of an acoustic output device according to some embodiments of the present disclosure;

FIG. 38 is a schematic diagram illustrating an exemplary structure of an acoustic output device according to some embodiments of the present disclosure;

FIG. 39 is a schematic diagram illustrating an exemplary structure of an acoustic output device according to some embodiments of the present disclosure;

FIG. 40 is a schematic diagram illustrating an exemplary structure of an acoustic output device according to some embodiments of the present disclosure;

FIG. 41 is a schematic diagram illustrating an exemplary structure of an acoustic output device according to some embodiments of the present disclosure;

FIG. 42 is a graph of frequency response curves of an acoustic output device according to some embodiments of the present disclosure;

FIG. 43 is a graph of frequency response curves of an acoustic output device according to some embodiments of the present disclosure;

FIG. 44 is a graph of sound leakage frequency response curves of an acoustic output device according to some embodiments of the present disclosure;

FIG. 45 is a graph of sound leakage frequency response curves of an acoustic output device according to some embodiments of the present disclosure;

FIG. 46 is a schematic diagram illustrating structures of vibration transmission sheets form a top view according to some embodiments of the present disclosure; and

FIG. 47 is a schematic diagram illustrating stereoscopic structures of vibration transmission sheets according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

Embodiments of the present disclosure describe an acoustic output device. In some embodiments, the acoustic output device may include a transducer device, a housing, and an additional element. The transducer device may be configured to generate a mechanical vibration based on an electrical signal. The transducer device may include a magnetic circuit assembly and an clastic support component. The housing may be configured to accommodate the transducer device. The housing may include a panel and a shell. The transducer device may transmit the mechanical vibration to a user through the panel. The additional element may be connected to the panel through a vibration path, and the vibration path may at least include an elastic element. The additional element may be located at a sidewall of the shell adjacent to the panel, and the clastic support component may connect the magnetic circuit assembly and the sidewall disposed with the additional element. In some embodiments, a vibration transmission sheet (also referred to as the clastic support component) in the transducer device may connect the magnetic circuit assembly and the sidewall of the shell adjacent to the panel. That is, the vibration transmission sheet connects the magnetic circuit assembly and the sidewall of the shell disposed with the additional element. In some embodiments, the transducer device may include at least two vibration transmission sheets. One of the at least two vibration transmission sheets may be disposed on a side of the transducer device facing the panel, so as to elastically connect the transducer device and the panel. The other one of the at least two vibration transmission sheets may be disposed on a side of the transducer device back away from the panel, so as to connect the transducer device and the shell, and support the transducer device to ensure that the transducer device can vibrate stably along an axial direction. In addition, the vibration transmission sheet disposed on the side of the transducer device back away from the panel may connect the magnetic circuit assembly and the sidewall of the shell where the additional element is disposed, so as to reduce or avoid the problem that the additional element and the magnetic circuit assembly in the transducer device may attract or repel each other, causing deformation or inversion of the magnetic circuit assembly. In some embodiments, when the additional element is rigidly connected to the clastic support component, the vibration transmission sheet of the transducer device may connect the magnetic circuit assembly and the elastic support component. At this time, the vibration transmission sheet can provide support in a relative movement direction between the magnetic circuit assembly and the additional element, so that the vibration transmission sheet can provide better support for the magnetic circuit assembly, thereby improving the stability between the magnetic circuit assembly and the shell. This can prevent the additional element and the magnetic circuit assembly in the transducer device from attracting or repelling to each other and causing the deformation or inversion of the magnetic circuit assembly, thereby ensuring that the vibration of the transducer device is relatively stable.

In the acoustic output device according to some embodiments of the present disclosure, the additional element and the magnetic circuit assembly can vibrate with respect to the panel to generate a resonance peak located within a target frequency, which ensures that the sensitivity of the acoustic output device is not affected by the additional element when the acoustic output device is within a frequency range that is greater than a resonance frequency corresponding to the resonance peak. Therefore, the sensitivity of the acoustic output device disposed with the additional element is not affected by the additional element when the acoustic output device is within the frequency range that is greater than the resonance frequency, and the problem that a sensitivity of a bone conduction acoustic output device is weakened due to the additional installation of the additional element on the bone conduction loudspeaker can be avoided. In addition, when the acoustic output device according to some embodiments of the present disclosure is within the frequency range that is greater than the resonance frequency corresponding to the resonance peak, a frequency response curve of the acoustic output device can be relatively flat, which ensures that the acoustic output device has a better acoustic output effect, improving the user's listening experience. Further, when the transducer device generates low frequency (lower than the frequency range of the resonance frequency corresponding to the resonance peak) mechanical vibrations, low frequency (lower than the frequency range of the resonance frequency corresponding to the resonance peak) vibrations of the panel can be transmitted to the additional element to drive the additional element to vibrate with the low frequency vibrations of the panel. A mass of the additional element can increase a loading mass of the vibration of the transducer device, which causes that the sensitivity of the acoustic output device is affected by the additional element in a frequency range lower than the frequency range of the resonance frequency corresponding to the resonance peak. When the transducer device generates high frequency (higher than the frequency range of the resonance frequency corresponding to the resonance peak) mechanical vibrations, high frequency vibrations of the panel can not lead to vibrations of the additional element due to an elastic connection (e.g., the presence of the vibration transmission sheet) between the additional element and/or the magnetic circuit assembly and the panel, and the mass of the additional element does not affect the loading mass of the vibration of the transducer device. This ensures that the sensitivity of the acoustic output device is not affected by the additional element in a frequency range higher than the frequency range of the resonance frequency corresponding to the resonance peak.

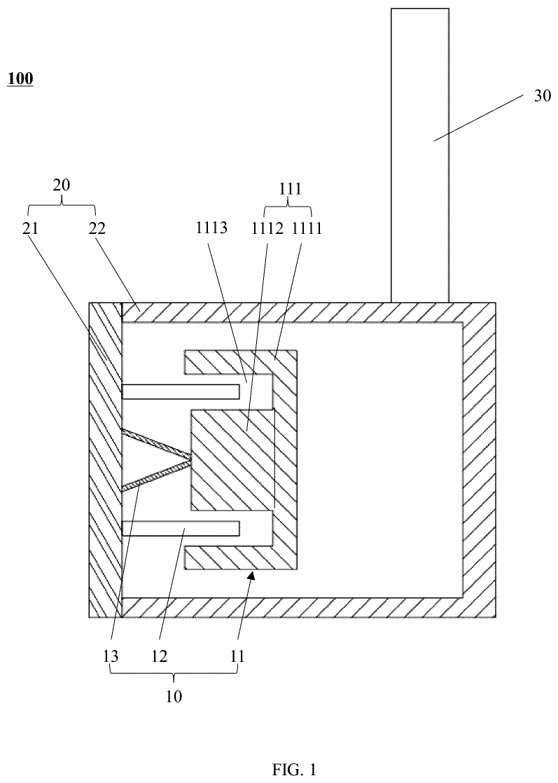

FIG. 1 is a schematic diagram illustrating an exemplary acoustic output device 100 according to some embodiments of the present disclosure. As shown in FIG. 1, in some embodiments, the acoustic output device 100 may include a transducer device 10 and a housing 20 configured to accommodate the transducer device 10. In some embodiments, the housing 20 may include a panel 21 and a shell 22. The shell 22 may be a structural body with a hollow interior, and the panel 21 and the shell 22 may form an accommodating chamber to accommodate the transducer device 10. The transducer device 10 may be connected to the panel 21, and the transducer device 10 may transmit a mechanical vibration to a user through the panel 21. In some embodiments, the panel 21 and the shell 22 may be an integrated structure. In some embodiments, the shell 22 may be an integrated structure or a structure formed by connecting multiple components. For example, in some embodiments, the shell 22 may include an annular side panel and a back panel. The back panel may be fixed to a side of the annular side panel opposite to the panel 21, so as to form the shell 22. In some embodiments, the panel 21 and the shell 22 may also be independent structures. The shell 22 may be a structural body that has a hollow interior and an open opening at one end. The panel 21 may be rigidly connected to the end of the shell 22 that has the open opening, and cover the open opening of the shell 22 to form the accommodating chamber for accommodating the transducer device 10. In some embodiments, when the user wears the acoustic output device 100, the panel 21 may fit against the user's head, and then transmit the mechanical vibration to the user's auditory nerves through the body tissues and bones, enabling the user to hear bone conduction sound. It should be noted that the rigid connection in the present disclosure refers to a connection between two connecting members (e.g., the panel 21 and the shell 22) such that when one (e.g., a first connecting member) of the connecting members is displaced or deformed with respect to the other connecting member (e.g., a second connecting member), the other connecting member connected thereto is substantially free from displacement or deformation relative to the first connecting member. That is, the two connecting members may be substantially considered as a whole during the vibration process. For example, two connecting members are directly connected to each other, and an overall tensile strength (Pa) of the two connecting members is greater than 50% of a tensile strength of a base material of either of the two connecting members. As another example, the two connecting members are connected by a rigid connecting element, and a tensile strength of the rigid connecting element is greater than the tensile strength of the base material of either of the two connecting members. The rigid connection also refers to that high frequency vibrations (e.g., vibrations whose vibration frequency is greater than 6 kilohertz. (KHz), 8 KHz, or 10 KHz) can be efficiently transmitted between the two connecting members. In addition, the rigid connection also refers to that a resonance frequency generated by the vibration transmission between the two connecting members is relatively high. For example, the resonance frequency generated by the vibration transmission between the two connecting members is greater than 6000 Hz. As another example, the resonance frequency generated by the vibration transmission between the two connecting members is greater than 8000 Hz. As yet another example, the resonance frequency generated by the vibration transmission between the two connecting members is greater than 10000 Hz.

The transducer device 10 may be configured to convert an electrical signal into a mechanical vibration, and then transmit the mechanical vibration to the user via the panel 21. In some embodiments, the transducer device 10 may include a magnetic circuit assembly 11, a coil 12, and a vibration transmission sheet 13 (also referred to as an clastic support component). In some embodiments, the magnetic circuit assembly 11 may include at least one magnet 111, and the magnet 111 may generate a magnetic field. In some embodiments, the magnet 111 may include a magnetic conductor 1111 and a magnetic member 1112. The magnetic conductor 1111 may be a structural body having a concave groove. The magnetic member 1112 may be located in the concave groove and fixedly connected to the magnetic guide member 1111. A magnetic gap 1113 may be formed between a sidewall of the magnetic conductor 1111 corresponding to the concave groove and a circumferential sidewall of the magnetic member 1112. In some embodiments, the magnetic conductor 1111 may be made of a soft magnetic material. In some embodiments, the soft magnetic material may include a metallic material, a metal alloy, a metal oxide material, an amorphous metallic material, etc. For example, the soft magnetic material may include iron, iron-silicon alloy, iron-aluminum alloy, nickel-iron alloy, iron-cobalt alloy, low carbon steel, silicon steel sheet, ferrite, etc. In some embodiments, the magnetic member 1112 refers to any element capable of generating a magnetic field. In some embodiments, the magnetic member 1112 may include a metal alloy magnet, a ferrite, etc. Exemplary metal alloy magnets may include neodymium-iron-boron, samarium cobalt, aluminum-nickel-cobalt, iron-chromium-cobalt, aluminum-iron-boron, iron-carbon-aluminum, or the like, or any combination thereof. Exemplary ferrites may include a barium ferrite, a steel ferrite, a magnesium-manganese ferrite, a lithium-manganese ferrite, or the like, or any combination thereof.

In some embodiments, the magnetic circuit assembly 11 may be elastically connected to the housing 20 through the vibration transmission sheet 13. In some embodiments, the magnetic circuit assembly 11 may be elastically connected to the panel 21 through the vibration transmission sheet 13. In some embodiments, the magnetic circuit assembly 11 and the shell 22 (e.g., a sidewall in the housing 21 adjacent or opposite to the panel 21) may be elastically connected through the vibration transmission sheet 13. In some embodiments, the magnetic circuit assembly 11 may be elastically connected to the panel 21 and the shell 22 through different vibration transmission sheets 13, respectively. For example, the vibration transmission sheet 13 may include a first vibration transmission sheet and a second vibration transmission sheet. The first vibration transmission sheet is disposed between the magnetic circuit assembly 11 and the panel 21, and the magnetic circuit assembly 11 is elastically connected to the panel 21 through the first vibration transmission sheet. The second vibration transmission sheet is disposed between the magnetic circuit assembly 11 and a sidewall on the shell 22 opposite to the panel 21, and the magnetic circuit assembly 11 is elastically connected to the shell 22 through the second vibration transmission sheet. In some embodiments, at least a portion of the coil 12 may be disposed in the magnetic circuit assembly 11. For example, in some embodiments, one end of the coil 12 may be connected to the panel 21, and the other end of the coil 12 may extend into the magnetic gap 1113 of the magnetic circuit assembly 11. When the transducer device 10 operates, the coil 12 may be energized with a signal current. The coil 12 is in the magnetic field generated by the magnet 111, and is subjected to an ampere force to generate a mechanical vibration to drive the panel 21 and the shell 22 to perform the mechanical vibration. At the same time, the magnetic circuit assembly 11 is subjected to a reaction force opposite to that of the coil. It should be noted that the “clastic connection” in the present disclosure refers to an elastic connection between two connecting members such that when one (e.g., the first connecting member) of the connecting members is displaced or deformed, the other connecting member (e.g., the second connecting member) has an ability to displace or deform with respect to the first connecting member. Alternatively, the two connecting members are connected through an elastic member. In addition, the elastic connection also refers to that an overall structure formed by the connection of the two connecting members has a specific resonance frequency that is less than a target threshold. In some embodiments, the target threshold may be 400 hertz. (Hz), 600 Hz, 800 Hz, 1500 Hz, 2000 Hz, etc.

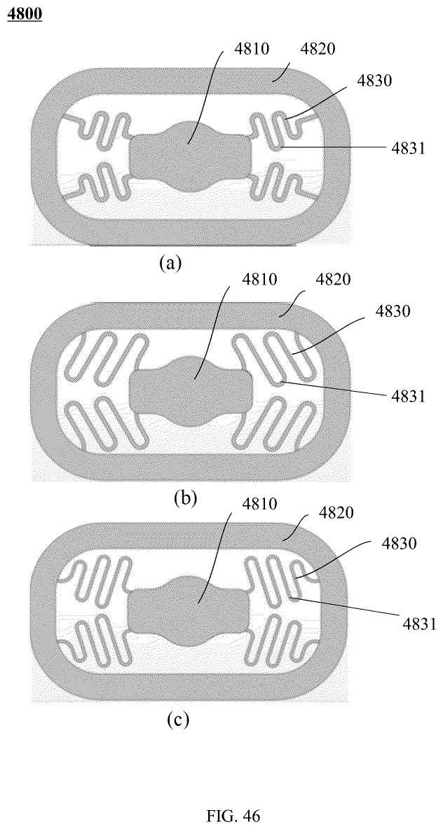

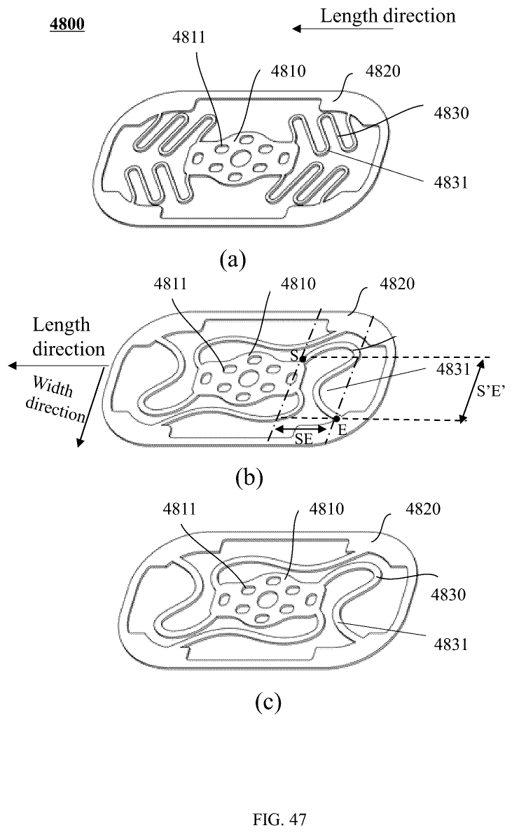

More descriptions regarding the vibration transmission sheet 13 may be found elsewhere in the present disclosure (e.g., FIGS. 46 and 47, and relevant descriptions thereof).

It should be noted that an energy conversion manner in the transducer device 10 in the embodiments of the present disclosure can be a moving-coil type described above, and also be an electrostatic type, a piezoelectric type, a moving-iron type, a pneumatic type, an electromagnetic type, etc. The acoustic output device (e.g., the acoustic output device 100) according to the embodiments of the present disclosure may be any one of a loudspeaker, a headphone, a hearing aid, eyeglasses, an augmented reality (AR) device, a virtual reality (VR) device, or a helmet. Further, the transducer device 10, the panel 21, the shell 22, the magnetic circuit assembly 11, the coil 12, the vibration transmission sheet 13, etc., may be regarded as acoustic output units (also referred to as bone conduction loudspeakers) of the acoustic output device 100 to generate sound.

In some embodiments, the acoustic output device 100 may also include a support structure 30. The support structure 30 may be configured to wear the bone conduction loudspeaker of the acoustic output device 100 on an car or head region (e.g., the mastoid process, temporal bone, parietal bone, frontal bone, etc., on the head, or a position on the left and right sides of the head and in a front side of the user's car on a sagittal axis of the human body) of the user without blocking the car canal of the user. In some embodiments, the support structure 30 may be connected to the housing 20 (e.g., the panel 21 or the shell 22). In some embodiments, the support structure 30 may also be configured as an car hook and a rear hook structure that can fit with each other, so as to wrap around the back side of the head. In some embodiments, the support structure 30 may be configured as a headband structure and wound around the top of the user's head. In some embodiments, the support structure 30 may be a structure having a shape adapted to the human car, such as a circular shape, an oval shape, a polygonal (regular or irregular) shape, a U-shape, a V-shape, a semi-circular shape, so that the support structure 30 can be directly hooked up at the car of the user.

It should be noted that, in practice, the user can wear two bone conduction loudspeakers at the same time (i.e., each of the left car and the right car wears one bone conduction loudspeaker), so that the user can hear stereo sound. In some application scenarios where requirement(s) on the stereo sound are not relatively high (e.g., hearing aids for a hearing patient, a live teleprompter for a presenter, etc.), the user can also wear only one bone conduction loudspeaker.

In some embodiments, when the user wears two bone conduction loudspeakers at the same time, the support structure 30 may include a back hook assembly and two car hook assemblies. Each of two ends of the back hook assembly may be connected to one end of a corresponding one of the car hook assemblies, respectively, and another end of each car hook assembly back away from the back hook may be connected to a corresponding bone conduction loudspeaker. Furthermore, the back hook assembly may be configured in a curved shape for wrapping around the back side of the user's head. Each of the car hook assemblies may be configured in a curved shape for hanging between the user's car and the head, which facilitates to wear the two bone conduction loudspeakers at the same time. In this case, the two bone conduction loudspeakers are located on the left side and the right side of the user's head, respectively, the two bone conduction loudspeakers are also attached to the user's car or head region (e.g., a facial region on a front side of the car) under a cooperating action of the support structure 30, and the user also hears the sound output from the two bone conduction loudspeakers.

The acoustic output device usually needs to be disposed with certain additional components (e.g., a microphone, a sensor, an air-conduction loudspeaker, etc.) on the basis of the bone conduction loudspeaker in order to fulfill more functional requirements. For example, the microphone may be disposed on the bone conduction loudspeaker for capturing the user voice. As another example, a sensor (e.g., a temperature sensor, a humidity sensor, a speed sensor, a displacement sensor, etc.) may be disposed on the bone conduction loudspeaker for collecting user information (e.g., health status, exercise conditions, etc., of the user), environmental information, etc. As yet another example, the air-conduction loudspeaker may be disposed on top of the bone conduction loudspeaker to form a bone-air combination loudspeaker for outputting bone conduction sound and/or air-conduction sound to the user, so as to ensure that the user has better hearing experience. In addition, internal components (e.g., a battery, a circuit board, etc.) of the acoustic output device may also be integrated into the bone conduction loudspeaker. The internal components of the acoustic output device and the additional components described above may be considered as additional element(s) of the bone conduction loudspeaker. The additional element(s) may be directly integrated onto the housing of the bone conduction loudspeaker, or also be attached to the magnetic circuit assembly 11.

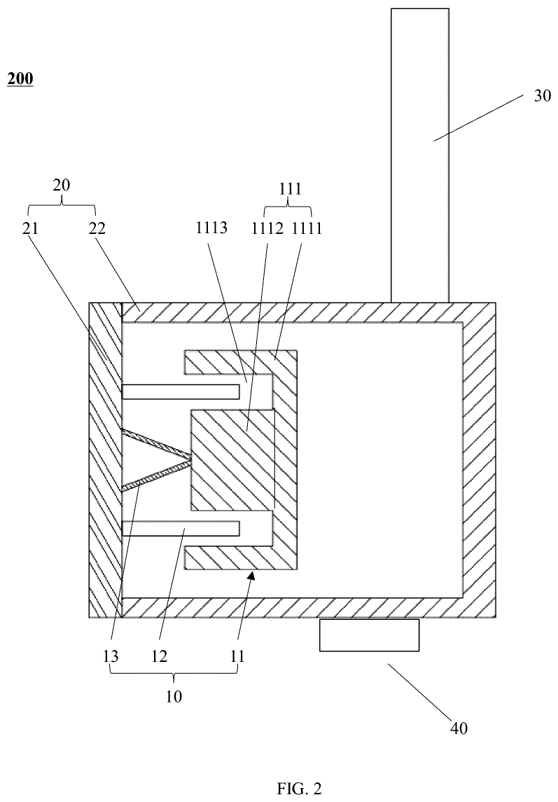

FIG. 2 is a schematic diagram illustrating an exemplary structure of an acoustic output device 200 according to some embodiments of the present disclosure. As shown in FIG. 2, the acoustic output device 200 is configured with an additional element 40 on the basis of the acoustic output device 100. In some embodiments, the additional element 40 may be rigidly connected to the shell 22. The additional element 40 may be rigidly connected to the shell 22, which causes a loading mass of the vibration of a structure (the panel 21, the shell 22, and the additional element 40) driven by the transducer device 10 to increase with respect to a loading mass of the vibration of a structure (the panel 21 and the shell 22) that is not configured with the additional element 40. Therefore, the sensitivity of the acoustic output device 200 is weakened, resulting in a decrease in a volume of the bone conduction sound output by the acoustic output device 200. The effect of the additional element on the loudspeaker (the bone conduction loudspeaker) may be illustrated below in combination with frequency response curves of the acoustic output device 100 and the acoustic output device 200. It should be noted that, in the present disclosure, the additional element 40 may be disposed inside the accommodating chamber formed by the panel 21 and the shell 22, or may be fixed outside the accommodating chamber. For example, the additional element 40 may be disposed on an outer surface of the shell 22.

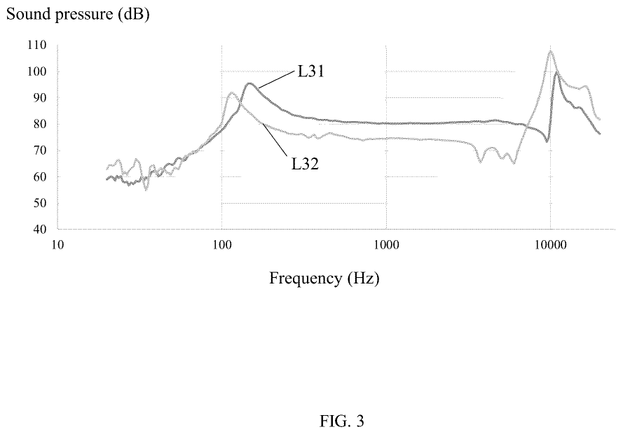

FIG. 3 is a graph of frequency response curves of acoustic output devices according to some embodiments of the present disclosure. As shown in FIG. 3, the horizontal coordinates represent frequencies (Hz.), the vertical coordinates represent sound pressures (dB) corresponding to an acoustic output device at different frequencies, a curve L31 represents a frequency response curve of the acoustic output device 100, and a curve L32 represents a frequency response curve of the acoustic output device 200. The vibration of the panel 21 also drives the air on the side of the panel 21 to vibrate to generate the air-conduction sound. In order to facilitate the measurement of the frequency response curves of the acoustic output device 100 and the acoustic output device 200, in the embodiments of the present disclosure, a vibration force level of the bone conduction sound of the acoustic output device is represented by measuring the sound pressure level of the air-conduction sound near the panel 21. Merely by way of example, a sound sensor (e.g., a microphone) may be provided proximate to the panel 21 to detect a sound pressure level of the air-conduction sound generated by the vibration of the air on the side of the panel 21 driven by the vibration of the panel 21. Merely by way of example, a sound sensor (e.g., a microphone) may be disposed near the panel 21 to detect the sound pressure level of the air-conducted sound generated by the air on the side of the panel 21 driven by the vibration of the panel 21. It can be understandable that, unless otherwise specified, the determination of the frequency response curve of the acoustic output device in the present disclosure can be achieved by using the above manner.

Combined with the frequency response curves L31 and L32, it can be seen that, in a frequency range of 20 Hz, to 8000 Hz, the sound pressure of the acoustic output device 200 is overall smaller than the sound pressure of the acoustic output device 100. That is, the sensitivity of the acoustic output device 200 is weaker than the sensitivity of the acoustic output device 100. It can be seen that, when the additional element is disposed on the bone conduction loudspeaker in the acoustic output device, the additional element can affect the sensitivity of the bone conduction loudspeaker. For instance, the sensitivity of the bone conduction loudspeaker is weakened. This is caused by the additional element 40 having a certain mass, which increases the loading mass of the vibration of the transducer device 10. The increase of the loading mass of the vibration of the transducer device 10 (at this time, the loading mass of the vibration of the transducer device 10 may at least include the mass of the panel 21, the shell 22, and the additional element 40) can cause the weaken of the sensitivity of the bone conduction loudspeaker, resulting in a relatively low volume of the sound (e.g., the bone conduction sound) output by the acoustic output device 200.

Based on the problem that the sensitivity of the bone conduction loudspeaker is weakened in the case where the additional element is disposed on the bone conduction loudspeaker in the acoustic output device 200, some embodiments of the present disclosure provide an acoustic output device. In some embodiments, the additional element may be connected to the panel through a vibration path, and the vibration path may at least include an elastic element. In the loudspeaker according to some embodiments of the present disclosure, the panel, the elastic element, the shell, and the additional element may form a resonance system. The resonance system may be in a second resonance position, and the resonance system generates, at the second resonance position, a second resonance frequency that is located within a target frequency range. In a frequency range greater than the second resonance frequency, a vibration transmission between the additional element and the panel can be suppressed. That is, the influence of the additional element on the vibration of the panel is reduced, thereby ensuring that the sensitivity of the bone conduction loudspeaker is not or less affected by the additional element in the frequency range greater than the second resonance frequency. In some embodiments, by setting the second resonance frequency at a lower-frequency position, the frequency range in which the sensitivity of the bone conduction loudspeaker is weakened due to the additional element disposed on the bone conduction loudspeaker may be reduced. In addition, in the frequency range greater than the second resonance frequency, the frequency response curve of the acoustic output device is flatter due to the smaller influence of the additional element on the vibration of the panel, which can ensure that the acoustic output device has a better acoustic output effect in a wider frequency range, thus improving the user's listening experience. In some embodiments, the second resonance frequency described above may be generated when the panel and the additional element vibrate in opposite directions and a distance between the panel and the additional element reaches a maximum value. When the transducer device generates a low frequency (below the second resonance frequency) mechanical vibration, a low frequency vibration (below the second resonance frequency) of the panel may be transmitted to the additional element to drive the additional element to vibrate together with the vibration of the panel. The mass of the additional element may increase the loading mass of the vibration of the transducer device, which makes the sensitivity of the loudspeaker to be affected by the additional element (similar to the acoustic output device 200) in a frequency range below the second resonance frequency. When the transducer device generates a high frequency (higher than the second resonance frequency) mechanical vibration, a high frequency vibration of the panel hardly drives the additional element to vibrate together due to the presence of the clastic element. The mass of the additional element may not influence the loading mass of the vibration of the transducer device, thus ensuring that the sensitivity of the acoustic output device is not or less affected by the additional element in a frequency range higher than the second resonant frequency.

In some specific application scenarios, since the additional element may have a magnetic part (e.g., a part, energized coil, etc., made of magnetic materials, such as metal alloy magnets, ferrite, etc.) or a magnetically conductive part (e.g., a part made of soft magnetic materials such as iron, nickel-iron alloy, etc.), the additional element may be attracted or repelled by the magnetic circuit assembly in the transducer device of the acoustic output device, resulting in the deformation or inversion of the magnetic circuit assembly of the transducer device. Therefore, the stability of the vibration of the transducer device is reduced, resulting in the poor acoustic output effect of the acoustic output device.

Based on the problem that the additional element and the magnetic circuit assembly in the transducer device may attract or repel to each other to cause the deformation or inversion of the magnetic circuit assembly, when the additional element is located at a sidewall on the shell adjacent to the panel, a vibration transmission sheet (also referred to as an elastic support component) in the transducer device may connect the magnetic circuit assembly to the sidewall of the shell adjacent to the panel. That is, the vibration transmission sheet connects the magnetic circuit assembly and the sidewall of the shell where the additional element is disposed. In some embodiments, the transducer device may include at least two vibration transmission sheets. One of the at least two vibration transmission sheets may be disposed on a side of the transducer device facing the panel to elastically connect the transducer device and the panel. The other one of the least two vibration transmission sheets may be disposed on a side of the transducer device back away from the panel to connect the transducer device to the shell, and support the transducer device to ensure that the transducer device can vibrate stably in an axial direction. In addition, the vibration transmission sheet disposed on the side of the transducer device back away from the panel may connect the magnetic circuit assembly and the sidewall of the shell where the additional element is disposed, so as to reduce or avoid the problem that the additional element and the magnetic circuit assembly in the transducer device may attract or repel to each other to cause the deformation or inversion of the magnetic circuit assembly. In some embodiments, when the additional element is rigidly connected to the clastic support component, the vibration transmission sheet of the transducer device may connect the magnetic circuit assembly to the clastic support component. At this time, the vibration transmission sheet may provide support in a relative movement direction between the magnetic circuit assembly and the additional element, so that the vibration transmission sheet provides a better support to the magnetic circuit assembly and improves the stability between the magnetic circuit assembly and the shell. Thus, the problem that the additional element and the magnetic circuit assembly in the transducer device may attract or repel to each other to cause the deformation or inversion of the magnetic circuit assembly can be avoided, ensuring that the vibration of the transducer device is relatively stable. In order to improve the support effect of the vibration transmission sheet on the magnetic circuit assembly, in some embodiments, at least a portion of a connection end of the vibration transmission sheet connecting the sidewall of the shell may be located within an orthographic projection of the additional element on the sidewall of the shell. For example, at least one of support rods of the vibration transmission sheet is disposed within the orthographic projection of the additional element on the sidewall of the shell. In some embodiments, the vibration transmission sheet may include a center region and a plurality of support rods, and the plurality of support rods may be disposed at intervals along a circumferential side of the center region of the vibration transmission sheet. The center region of the vibration transmission sheet may be connected to a side of the magnetic circuit assembly away from the panel, and an end of each support rod away from the center region may be connected with the shell. In some embodiments, the vibration transmission sheet may be connected to the side of the magnetic circuit assembly back away from the panel and may be connected to an intermediate region on the side of the magnetic circuit assembly back away from the panel. The intermediate region refers to a geometric center region of the side of the magnetic circuit assembly back away from the panel. For instance, the center region of the vibration transmission sheet may be connected to the intermediate region on the side of the magnetic circuit assembly back away from the panel. Merely by way of example, a count of support rods may be four. In this case, a structure of the vibration transmission sheet may be approximately regarded as an “X”-shaped structure. The “X”-shaped structure may provide elasticity in the vibration direction of the transducer device. In addition, the plurality of support rods may have high structural strengths in the vibration direction of the transducer device, which can provide a good support effect on the magnetic circuit assembly to avoid the deformation or inversion of the transducer device during the vibration. In some embodiments, the vibration transmission sheet may further include an edge region. The edge region may be connected to an end of each support rod away from the center region, and a circumferential side of the edge region may be connected to the shell. More descriptions regarding the structure of the vibration transmission sheet may be found elsewhere in the present disclosure (e.g., FIGS. 46 and 47, and relevant descriptions thereof).

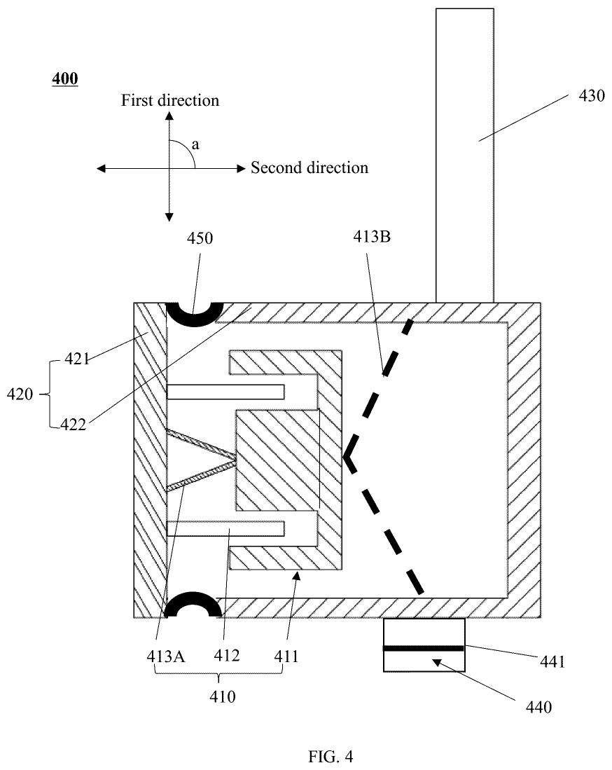

The acoustic output device according to some embodiments of the present disclosure may be described in detail below in combination with the accompanying drawings (FIG. 4-FIG. 32).

FIG. 4 is a schematic diagram illustrating an exemplary structure of an acoustic output device 400 according to some embodiments of the present disclosure. Structures of a transducer device 410 (including a magnetic circuit assembly 411, a coil 412, a vibration transmission sheet 413A), a housing 420 (including a panel 421, a shell 422), a support structure 430, etc., in the acoustic output device 400 shown in FIG. 4 may be similar to the transducer device 10 (including the magnetic circuit assembly 11, the coil 12, the vibration transmission sheet 13), the housing 20 (including the panel 21, the shell 22), the support structure 30, etc., in the acoustic output device 200 shown in FIG. 2, respectively, which are not be further described herein. The main difference between the acoustic output device 400 shown in FIG. 4 and the acoustic output device 200 shown in FIG. 2 may include that an additional element 440 is connected to the panel 421 through a vibration path including an elastic element 450. In other words, the panel 421 is elastically connected to the shell 422 through the elastic element 450. That is, the panel 421 (and structure(s) rigidly connected to the panel 421 (e.g., the coil 412)), the elastic element 450, and the shell 422 (and structure(s) rigidly connected to the shell 422 (e.g., the additional element 400 and the support structure 430)) form a resonance system. It should be noted that, when there are other structures rigidly connected to the panel 421 or the shell 422, these structures are also considered to be part of the resonance system. Taking the additional element 440 being rigidly connected to the shell 422 and the panel 421 being elastically connected to the shell 422 disposed with the additional element 440 through the clastic element 450 as an example, in a relatively low frequency band (e.g., a frequency band range less than 20 Hz), the connection of the panel 421 and the shell 422 may be approximately regarded as a rigid connection, the transducer device may drive the panel 421 to vibrate, and the panel 421 may drive the shell 422 and the additional element 440 to vibrate together through the elastic element 45. Since the additional element 440 has a certain mass, the acoustic output device having the additional element 440 may have a relatively weak sensitivity. In a relatively high frequency band (e.g., a frequency band range greater than 20 Hz.), the panel 421, the clastic element 450, and the shell 422 may be approximately regarded as a resonance system. The transducer device may drive the panel 421 to vibrate, and under the action of the clastic element 450, a relative motion may occur between the panel 421 and the shell 422 (and component(s) (e.g., the additional element 440) rigidly connected to the shell 422. For instance, the vibration of the panel 421 is at a minimum value (e.g., the panel 421 vibrates relatively little or not at all), and the shell 422 and the additional element 440 vibrate strongly. This time may be considered as a first resonance position of the resonance system, and a resonance frequency when the resonance system is located at this first resonance position may be a first resonance frequency. In the resonance system of some embodiments, a frequency response curve of the acoustic output device 400 may have a resonance valley at the first resonance frequency. It can be understandable that, in the resonance system of some other embodiments, the frequency response curve of the acoustic output device 400 may not have a distinct resonance valley at the first resonance frequency. As the vibration frequency of the resonance system further increases, the panel 421, the shell 422, and the additional element 440 rigidly connected to the shell 422 may vibrate strongly until the panel 421 and the shell 422 (and the additional element 440 rigidly connected to the shell 422) vibrate in the opposite directions and a distance between the panel 421 and the shell 422 reaches a maximum value. This time may be regarded as a second resonance position of the resonance system, and the resonance frequency when the resonance system is located at the second resonance position may be a second resonance frequency. In the resonance system of some embodiments, the frequency response curve of the acoustic output device 400 may have a resonance peak at the second resonance frequency. It can be understandable that, in the resonance system of some other embodiments, the frequency response curve of the acoustic output device 400 may not have a distinct resonance peak at the second resonance frequency. When the frequency is greater than the second resonance frequency, the panel 421 and the shell 422 (and the additional element 440 rigidly connected to the shell 422) may vibrate in the opposite directions. At this time, the vibration transmission between the shell 422 (and the additional element 440) and the panel 421 may be suppressed. That is, the effect of the shell 422 and the additional element 440 on the vibration of the panel 421 is reduced.

From a phase of the resonance system, the panel 421 and the shell 422 first move together. At this time, the panel 421 and the shell 422 (and the additional element 440 connected to the shell 422) may vibrate together, and a phase difference between the panel 421 and the shell 422 may be 0 degrees. As the frequency increases, the panel 421 and the shell 422 (and the additional element 440) may first move along a same direction until the panel 421 vibrates little or stops vibration, and the shell 422 and the additional element 440 vibrate relatively strongly, i.e., the first resonance position. As the frequency continues to increase, a value corresponding to the phase of the resonance system may increase, and the panel 421, the shell 422, and the additional element 440 rigidly connected to the shell 422 all vibrate strongly until the panel 421 and the shell 422 (and the additional element 440) vibrate in the opposite directions and the distance between the panel 421 and the shell 422 (and the additional element 440) reaches the maximum value, i.e., the second resonance position. At this time, the phase difference between the panel 421 and the shell 422 may be within a range of 150 degrees to 210 degrees, and the resonance system may be located at the second resonance position. Then, as the frequency continues to increase, the value corresponding to the phase of the resonance system progressively may decrease. In the acoustic output device according to the embodiments of the present disclosure, the panel 421 and the shell 422 having the additional element 440 may be connected through the clastic element 450, so that the panel 421 and the shell 422 having the additional element 440 can be resonate and generate the second resonance frequency within a target frequency range. In a frequency range greater than the second resonance frequency, the vibration transmission between the additional element 440 and the panel 421 may be suppressed. That is, the effect of the additional element 440 on the vibration of the panel 421 can be reduced, thereby ensuring that the sensitivity of the bone conduction loudspeaker in the acoustic output device is not or less affected by the additional element 440 in the frequency range greater than the second resonance frequency. In some embodiments, by setting the second resonance frequency at a relatively low frequency position, a frequency range in which the sensitivity of the bone conduction loudspeaker in the acoustic output device is weakened due to the additional element 440 being disposed on the acoustic output device may be reduced. In addition, in the frequency range greater than the second resonance frequency, the frequency response curve of the acoustic output device may be flatter due to the smaller influence of the additional element 440 on the vibration of the panel 421, which ensures that the acoustic output device has a better acoustic output effect in a larger frequency range, improving the user's listening experience.

It can be understandable that, if there are other structure(s) rigidly connected to the panel 421 or other structure(s) rigidly connected to the shell 422, for example, the panel 421 and the structure(s) rigidly connected to the panel 421, the clastic element 450, the shell 422 and the structure(s) rigidly connected to the shell 422 may form the resonance system.

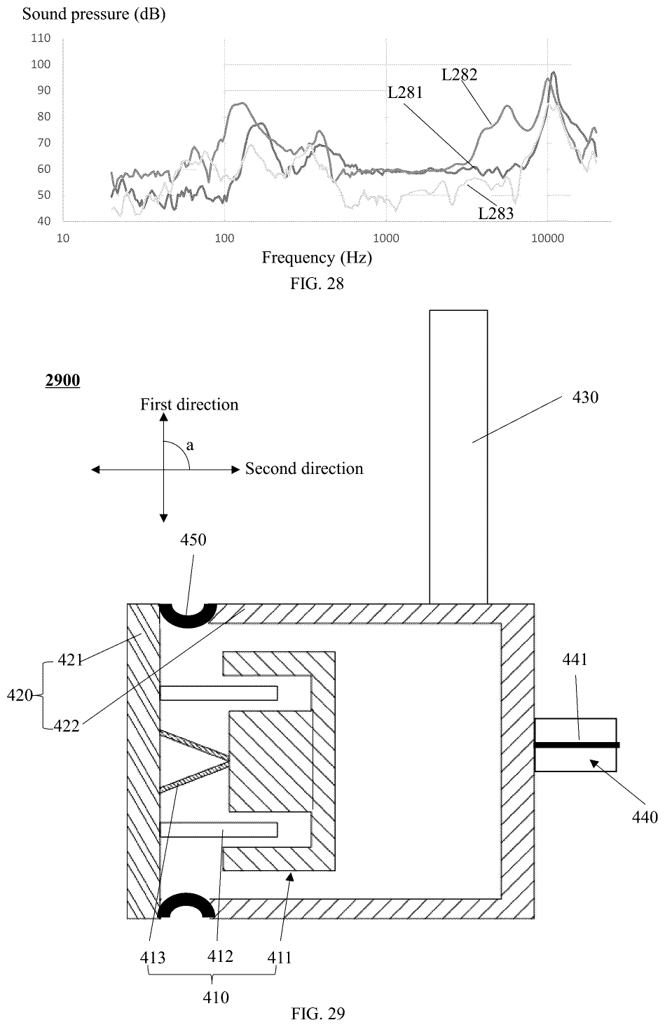

As shown in FIG. 4, in some embodiments, the shell 422 may be a structure that is internally hollow and has an open opening at one end, and the panel 421 may be disposed at the end of the shell 422 that has the open opening. The clastic element 450 may be disposed between the panel 421 and the shell 422 to realize an clastic connection between the panel 421 and the shell 422. The clastic element 450 herein may also be considered as a portion of the housing 420 in the acoustic output device 400. The panel 421, the shell 422, and the clastic element 450 may form an accommodating chamber for accommodating the transducer device 10. In some embodiments, the clastic element 450 may be a ring structure with elasticity. The panel 421 may be elastically connected to the shell 422 through the ring structure, so as to form the accommodating chamber for accommodating the transducer device 410. In some embodiments, the clastic element 450 may be the ring structure made of an elastic material, such as silicone, polyurethane, etc. In some embodiments, the ring structure may be a single ring structure or a structure including a plurality of folded rings with a pre-deformation capability. When the panel 421 is connected to the shell 422 through the ring structure, the ring structure with the pre-deformation capability may support the panel 421 and the shell 422 to a certain extent, improving the structural stability of the acoustic output device. In some embodiments, the panel 421 and the shell 422 may be elastically connected through adhering. The adhesive used to adhere the panel 421 and the shell 422 may have elasticity, which may be regarded as the clastic element 450. In some embodiments, the adhesive used to adhere the panel 421 and the shell 422 may include a gel type, an organic-silicone type, an acrylic type, a polyurethane type, a rubber type, an epoxy type, a hot melt type, a light curing type, or the like, or any combination thereof. Preferably, the adhesive may be a silicone adhering type glue, a silicone sealing type glue. In some embodiments, the additional element 440 may be rigidly connected to the shell 422 directly or indirectly. For example, in some embodiments, the additional element 440 may be rigidly connected to a sidewall of the shell 422 (e.g., a sidewall on the shell 422 adjacent to the panel 421 or a sidewall on the shell 422 opposite to the panel 421) by welding, snap-fitting, threading, adhesive connection, etc. As another example, the additional element 440 may be rigidly connected to the shell 422 through a connection such as a bracket, a connecting rod, etc. In some embodiments, the additional element 440 shown in FIG. 4 may include an element (e.g., a loudspeaker, an air-conduction microphone, an accelerometer) that is sensitive to the vibration direction. In the embodiment shown in FIG. 4, the additional element 440 may be an air-conduction microphone that is sensitive to the vibration direction. A vibration direction (a “second direction” shown in FIG. 4) of a diaphragm 441 of the air-conduction microphone may be approximately perpendicular to a vibration direction (a “first direction” shown in FIG. 4) of the transducer device 410. The approximately perpendicular can be understood as that an included angle between the vibration direction of the diaphragm and the vibration direction of the transducer device is within a range of 75 degrees to 100 degrees, for example 80 degrees. 90 degrees, 95 degrees, etc. The diaphragm may generate the vibration during an operation of the air-conduction loudspeaker. When the vibration direction of the transducer device is approximately perpendicular to the vibration direction of the diaphragm in the air-conduction loudspeaker, there is almost no superposition effect between the vibration generated by the diaphragm and the vibration generated by the transducer device. In other words, while the diaphragm generates the vibration, and when the vibration direction of the transducer device is approximately perpendicular to the vibration direction of the diaphragm in the air-conduction loudspeaker, a sound leakage volume generated by the acoustic output device may be relatively low, thereby enabling the acoustic output device to have a better leakage reduction effect when disposing the element that is sensitive to the vibration direction. More descriptions regarding the additional element being the element that is sensitive to the vibration direction may be found elsewhere in the present disclosure (e.g., FIGS. 4 and 28, and relevant descriptions thereof). It should be noted that, the additional element 440 may not be limited to the element that is sensitive to the vibration direction shown in FIG. 4, but may also be a battery, a circuit board, or a sensor (e.g., a temperature sensor, a humidity sensor, etc.) that is not sensitive to the vibration direction. At this time, the additional element may be located at an arbitrary position on the shell 422. In some embodiments, the additional element 440 may include an element that is sensitive to the vibration direction and an element that is insensitive to the vibration direction. For example, the element that is sensitive to the vibration direction is an accelerometer sensor, and the element that is insensitive to the vibration direction is a circuit board. The circuit board may be fixedly connected to the shell 422, and the accelerometer sensor may be disposed on the circuit board.

The panel 421 (and the structure(s) (e.g., the coil 412) rigidly connected to the panel 421) and the shell 422 (and the structure(s) (e.g., the additional element 440) rigidly connected to the shell 422) may be elastically connected to each other through the elastic element 450, which can be approximately regarded as a resonance system. In some embodiments, the resonance system may be located at the second resonance position, and generate the second resonance frequency whose resonant frequency is within a target frequency range. In the frequency range greater than the resonance frequency corresponding to the second resonance frequency, the vibration transmission between the additional element 440 and the panel may be suppressed. That is, the influence of the additional element 440 on the vibration of the panel 421 may be reduced, so that the sensitivity of the acoustic output device 400 is not or less affected by the additional element 440 in the frequency range that is greater than the resonance frequency corresponding to the second resonance frequency. In some embodiments, by setting the resonance frequency corresponding to the second resonance frequency at a relatively low frequency position, the frequency range in which the sensitivity of the acoustic output device 400 is weakened due to the additional element 440 can be reduced. In addition, in a frequency range greater than the resonance frequency corresponding to the second resonance frequency, the frequency response curve of the acoustic output device 400 is flatter due to the smaller influence of the additional element 440 on the vibration of the panel 421, which can ensure that the acoustic output device has a better acoustic output effect in a wider frequency range, improving the user's listening experience. In order to reduce the frequency range in which the additional element 440 has the influence on the acoustic output device 400, and to enable the acoustic output device 400 to have a flat frequency response curve in a wider frequency band, in some embodiments, a ratio of a sum of the mass of the panel 421 and the mass of the element(s) rigidly connected to the panel 421 to a sum of the mass of the shell 422 and the mass of the element(s) fixedly connected to the shell 422, an elastic coefficient of the clastic element 450, etc., may be adjusted, so that the resonance frequency corresponding to the second resonance frequency is located within a specific low frequency range (also referred to as a target frequency range). In some embodiments, the target frequency range may be within a range of 20 Hz, to 800 Hz. For example, the target frequency range may be within a range of 100 Hz, to 600 Hz. As another example, the target frequency range may be within a range of 150 Hz, to 500 Hz. As yet another example, the target frequency range may be within a range of 200 Hz, to 400 Hz. More descriptions regarding the adjusting the resonance frequency may be found elsewhere in the present disclosure (e.g., FIG. 6 and relevant descriptions thereof).

In the resonance system formed by elastically connecting the panel 421 (and the structure(s) (e.g., the coil 412) rigidly connected to the panel 421) and the shell 422 having the additional element 440 (and the structure(s) (e.g., the additional element 440) rigidly connected to the shell 422) through the clastic element 450, when the panel 421 does not vibrate substantially, the shell 422 may continue to vibrate. At this time, the acoustic output device 400 may also generate the first resonance frequency whose resonance frequency is within the target frequency range. In some embodiments, the first resonance frequency may be less than the second resonance frequency. Furthermore, the closer the frequencies corresponding to the first resonance frequency and the second resonance frequency are to each other, the less the influence on the flatness of the frequency response curve of the acoustic output device 400 in the overall frequency band may be, and accordingly, the better the sound quality of the acoustic output device 400 in the overall frequency band may be. In order to make the frequency response curve of the acoustic output device 400 in the overall frequency band flatter, in some embodiments, a difference between the frequency corresponding to the second resonance frequency and the frequency corresponding to the first resonance frequency may not be greater than 300 Hz. For example, the difference between the frequency corresponding to the second resonant frequency and the frequency corresponding to the first resonant frequency may not be greater than 200 Hz. As another example, the difference between the frequency corresponding to the second resonance frequency and the frequency corresponding to the first resonance frequency may not be greater than 100 Hz.

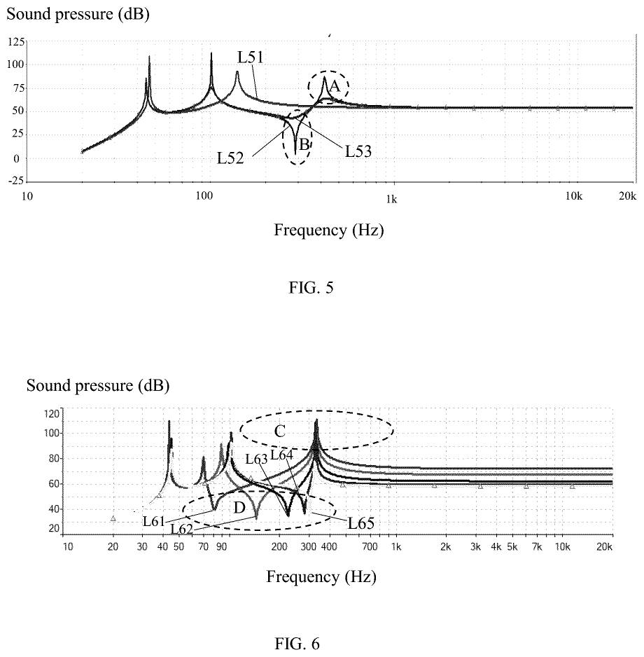

FIG. 5 is a graph of frequency response curves of acoustic output devices according to some embodiments of the present disclosure. FIG. 5 shows frequency response curves of the acoustic output device 100 and the acoustic output device 400. The horizontal coordinates represent frequencies (Hz), the vertical coordinates represent sound pressures (dB) corresponding to an acoustic output device at different frequencies, a curve L51 represents a frequency response curve of the acoustic output device 100, a curve L52 represents a frequency response curve of the acoustic output device 400, and a curve L53 represents a frequency response curve of the acoustic output device 400 after adding damping. In the embodiment shown in FIG. 5, the frequency response curve of the acoustic output device 400 has a resonance valley at a first resonance frequency, and the frequency response curve of the acoustic output device 400 has a second resonance frequency with a resonance peak. It should be noted that in the present disclosure, for the convenience of illustrations, the embodiment in which the frequency response curve of the acoustic output device has a distinct resonance valley at the first resonance frequency and has a distinct resonance peak at the second resonance frequency is merely for illustration. It can be understandable that the frequency response curve of the acoustic output device in the present disclosure may also have no distinct resonance valley at the first resonance frequency and no distinct resonance peak at the second resonance frequency. The resonance peaks in a region A are generated by the resonance system when the distance between the panel 421 and the shell 422 reaches a maximum value, and the resonance valleys in a region B are generated by the resonance system when the panel 421 does not vibrate or the vibration of the panel 421 is at a minimum value and the shell 422 vibrates. According to the curve L52, the acoustic output device 400 generates the resonance peak and the resonance valley in a frequency range of 200 Hz, to 600 Hz. The resonance peak is generated when the panel 421 and the additional element 440 vibrate in opposite directions and the distance between the panel 421 and the additional element 440 reaches the maximum value, and the resonance valley is generated when the panel 421 does not vibrate or the vibration of the panel 421 is at the minimum value and the shell 422 vibrates. Referring to FIG. 3 again, the sensitivity of the acoustic output device 100 disposed with no additional element in FIG. 3 is overall stronger than the sensitivity of the acoustic output device 200 disposed with the additional element in a frequency range of 200 Hz, to 8000 Hz. In FIG. 5, combining the curves L51. L52, and L53, the frequency response curves of the acoustic output device 400 and the acoustic output device 100 approximately overlap in a frequency range greater than the resonance frequency. It can be scen, the acoustic output device 400 (the additional element 440 is connected to the panel 421 through a vibration path including the elastic element 450) has a relatively strong sensitivity in a specific frequency band (e.g., a frequency range greater than the resonance frequency corresponding to the resonance peak A) as compared to the acoustic output device 200 shown in FIG. 2 (the panel 21 is rigidly connected to the shell 22 disposed with the additional element 40). Furthermore, combining the curves L51. L52, and L53, the curves L152, L153 and L151 substantially overlap and are relatively flat in the frequency range greater than the resonance frequency corresponding to the resonance peak. It can be seen, the frequency response curve of the acoustic output device 400 is flatter when the frequency is greater than the resonance frequency corresponding to the resonance peak, and the additional element 440 (e.g., an air-conduction loudspeaker, a sensor, a battery, a circuit board, etc.) in the acoustic output device 400 do not affect the sensitivity of the speaker 400 in the frequency range higher than the resonance frequency corresponding to the resonance peak. To enable the acoustic output device 400 to have a flat frequency response curve over a wider frequency band, in some embodiments, by adjusting a ratio of the mass of the panel 421 to a sum of the mass of the shell 422 and the mass of the additional element 440, an clastic coefficient of the clastic element 450, etc., the resonance frequency corresponding to the resonance peak may be located within a specific frequency range (e.g., less than 2000 Hz, less than 1500 Hz, less than 800 Hz, less than 600 Hz, etc.). More descriptions regarding the adjusting the resonance frequency may be found elsewhere in the present disclosure (e.g., FIG. 6 and relevant descriptions thereof).

In some embodiments, it can be seen that from curve L53, the steepness of the resonance peak and the resonance valley of the acoustic output device 400 decrease and become flatter after adding the damping to the acoustic output device 400. This allows the acoustic output device 400 to have a flatter frequency response curve in a wider frequency range, enabling the acoustic output device 400 to output a better sound quality in the wider frequency range. In some embodiments, a damping material may be disposed in the elastic element 450 to increase the damping of the acoustic output device 400. In some embodiments, the damping material may include butyl, acrylate, polysulfide, nitrile and silicone rubbers, urethanes, polyvinyl chloride, epoxies, or the like, or any combination thereof.

FIG. 6 is a graph of frequency response curves of acoustic output devices according to some embodiments of the present disclosure. FIG. 6 shows frequency response curves of the acoustic output device 400 when ratios of the mass of the panel 421 to a sum of the mass of the shell 422 and the mass of the additional element 440 are different. The horizontal coordinates represent frequencies (Hz.), and the vertical coordinates represent sound pressures (dB) corresponding to an acoustic output device at different frequencies. A curve L61 represents a frequency response curve of the acoustic output device 400 when a ratio of a sum of the mass of the panel 421 and the mass of element(s) (e.g., the coil 412) rigidly connected to the panel 421 to the sum of the mass of the shell 422 and the mass of element(s) (e.g., the additional element 440) rigidly connected to the shell 422 is 0.16 and an elasticity coefficient is 588 Newton per meter (N/m). The curve L62 represents a frequency response curve of the acoustic output device 400 when the ratio of the sum of the mass of the panel 421 and the mass of the element(s) rigidly connected to the panel 421 to the sum of the mass of the shell 422 and the mass of the element(s) rigidly connected to the shell 422 is 0.36 and the elasticity coefficient is 2000 N/m. The curve L63 represents a frequency response curve of the acoustic output device 400 when the ratio of the sum of the mass of the panel 421 and the mass of the element(s) rigidly connected to the panel 421 to the sum of the mass of the shell 422 and the mass of the element(s) rigidly connected to the shell 422 is 1.03. The curve L64 represents a frequency response curve of the acoustic output device 400 when the ratio of the sum of the mass of the panel 421 and the mass of the element(s) rigidly connected to the panel 421 to the sum of the mass of the shell 422 and the mass of the element(s) rigidly connected to the shell 422 is 3.07. The curve L65 represents a frequency response curve of the acoustic output device 400 when the ratio of the sum of the mass of the panel 421 and the mass of the element(s) rigidly connected to the panel 421 to the sum of the mass of the shell 422 and the mass of the element(s) rigidly connected to the shell 422 is 5.14. The resonance peaks in a region C are resonance peaks generated during vibrations of the resonance system formed by the panel 421, the additional element 440, and the clastic element 450. The resonance peaks of the curves L61 to L65 overlap in region C. The resonance valleys in a region D are resonance valleys generated during the vibrations of the resonance system formed by the panel 421, the additional element 440, and the clastic element 450.

In some embodiments, it can be seen that, in combination with the curves L61 to L65, the frequency response curves of the acoustic output device 400 are flatter in a frequency range higher than the resonance frequency corresponding to the resonance peak, which enables the acoustic output device 400 to output a better sound quality in the frequency range higher than the resonance frequency corresponding to the resonance peak.

Continuing to refer to FIG. 6 as shown, as the ratio of the sum of the mass of the panel 421 and the mass of the element(s) rigidly connected to the panel 421 to the sum of the mass of the shell 422 and the mass of the element(s) rigidly connected to the shell 422 increases, the frequency corresponding to the resonance valley may be consequently increased, the difference between the frequency corresponding to the resonance valley and the frequency corresponding to the resonance peak may be reduced, the difference between the resonance valley and the resonance peak may be reduced, the influence of the additional element 440 on the frequency response of the acoustic output device 400 may be reduced, the frequency response curve of the acoustic output device 400 may be flatter, and the sound quality of the acoustic output device 400 may be better. Accordingly, the influence of the additional element on the frequency response of the acoustic output device 400 can be reduced by adjusting the ratio of the sum of the mass of the panel 421 and the mass of the element(s) rigidly connected to the panel 421 to the sum of the mass of the shell 422 and the mass of the element(s) rigidly connected to the shell 422. In some embodiments, the ratio of the sum of the mass of the panel 421 and the mass of the element(s) rigidly connected to the panel 421 to the sum of the mass of the shell 422 and the mass of the element(s) rigidly connected to the shell 422 may be within a range of 0.16 to 7. In some embodiments, the ratio of the sum of the mass of the panel 421 and the mass of the element(s) rigidly connected to the panel 421 to the sum of the mass of the shell 422 and the mass of the element(s) rigidly connected to the shell 422 may be within a range of 0.36 to 6. In some embodiments, the ratio of the sum of the mass of the panel 421 and the mass of the element(s) rigidly connected to the panel 421 to the sum of the mass of the shell 422 and the mass of the element(s) rigidly connected to the shell 422 may be within a range of 1.03 to 5.14. In some embodiments, the ratio of the sum of the mass of the panel 421 and the mass of the element(s) rigidly connected to the panel 421 to the sum of the mass of the shell 422 and the mass of the element(s) rigidly connected to the shell 422 may be within a range of 1.03 to 3.07.

As shown in FIG. 4, the acoustic output device 400 may also include a support structure 430. The support structure 430 may be rigidly connected to the shell 422. For example, the support structure 430 may be rigidly connected to a sidewall of the shell 422 opposite to the panel 421.

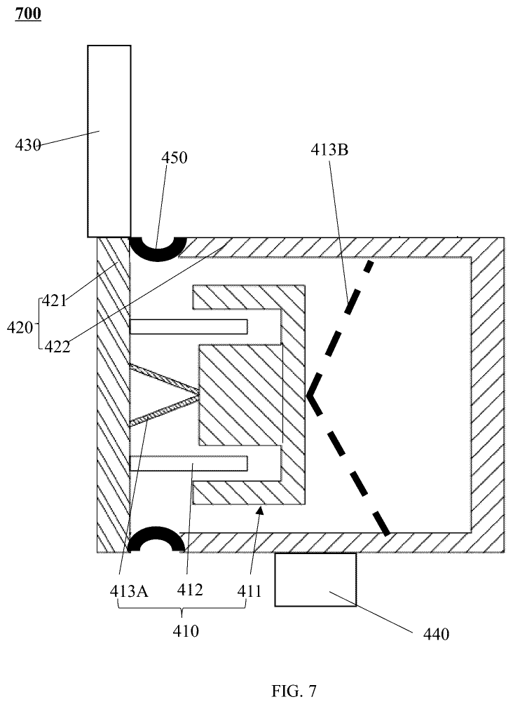

FIG. 7 is a schematic diagram illustrating an exemplary structure of an acoustic output device 700 according to some embodiments of the present disclosure. As shown in FIG. 7, the support structure 430 in the acoustic output device 700 may be rigidly connected to the panel 421.

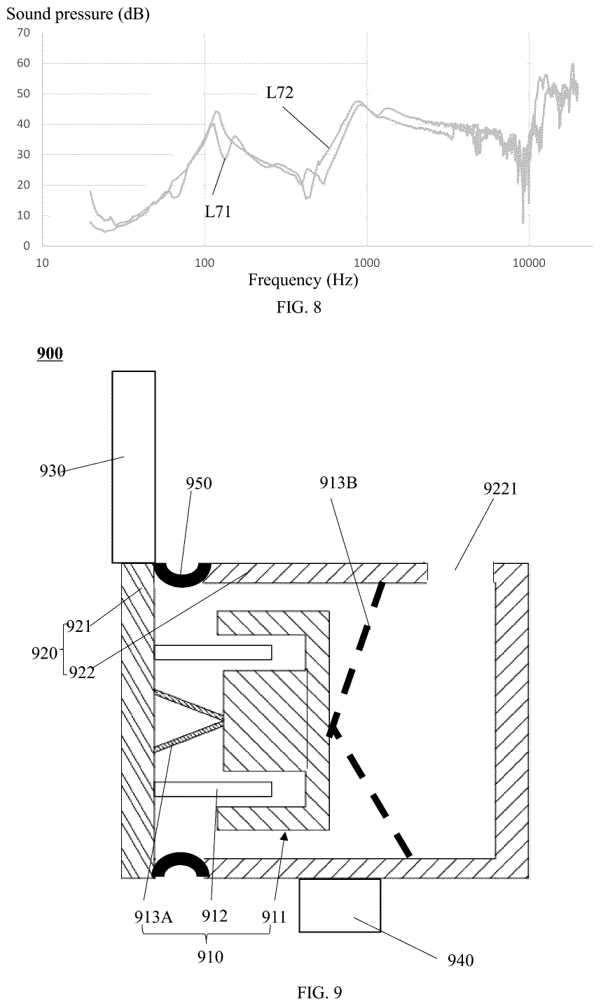

In some embodiments, the connection between the support structure 430 and the panel 421 or the shell 422 has less influence on the frequency response of the acoustic output device. Taking the acoustic output device being a headphone or a hearing aid as an example for illustration, the support structure 430 may be an car hook. The car hook is typically made of a flexible material, and has a better ability to undergo clastic deformation. Accordingly, the support structure 430 typically affects the vibration of the bone conduction loudspeaker in a relatively low frequency band (e.g., near and below 20 Hz), and the frequency band is typically inaudible to the human car. More descriptions may be found in FIG. 8 and relevant descriptions thereof. FIG. 8 is a graph of frequency response curves of acoustic output devices according to some embodiments of the present disclosure.

FIG. 8 shows the frequency response curves of the acoustic output device 400 and an acoustic output device 700. The horizontal coordinates represent frequencies (Hz), and the vertical coordinates represent sound pressures (dB) corresponding to an acoustic output device at different frequencies. A curve L71 represents a frequency response curve of the acoustic output device 400 when the support structure 430 is rigidly connected to the shell 422, and a curve L72 represents a frequency response curve of the acoustic output device 700 when the support structure 430 is rigidly connected to the panel 421. It can be seen that, in combination with the curves L71 and L72, the support structure 430 being rigidly connected to the panel 421 or being rigidly connected to the shell 422 has little influence on the frequency response of the acoustic output device 400 or 700. Thus, in the acoustic output device 400 of the embodiments of the present disclosure, the support structure 430 may be rigidly connected to the panel 421 or rigidly connected to the shell 422.

In the acoustic output device 400 or 700, the connection between the magnetic circuit assembly 411 and the panel 421 through the vibration transmission sheet 413A may cause the problem that the additional element and the magnetic circuit assembly in the transducer device may attract or repel to each other to cause the deformation or inversion of the magnetic circuit assembly, thereby affecting the vibration stability of the transducer device 410. In order to avoid the additional element and the magnetic circuit assembly in the transducer device from being attracting or repelling to each other to cause the deformation or inversion of the magnetic circuit assembly and affecting the vibration stability of the transducer device, in some embodiments, the vibration transmission sheet 413A between the magnetic circuit assembly 411 and the panel 421 may be replaced with a vibration transmission sheet 413B (indicated by dashed lines in FIGS. 4 and 7). Merely by way of example, the vibration transmission sheet 413B may be disposed between the magnetic circuit assembly 411 and a sidewall of the shell 422 opposite to the panel 421. A side of the vibration transmission sheet 413B may be connected to a side of the magnetic circuit assembly 411 back away from the panel 421, and a circumferential side of the vibration transmission sheet 413B may be connected to a sidewall of the shell 422 adjacent to the panel 421. By disposing the vibration transmission sheet 413B between the magnetic circuit assembly 411 and the sidewall of the shell 422 opposite to the panel 421, the vibration transducer 413B can enhance the support effect of the magnetic circuit assembly 411 on a position near the additional element 440 and improve the vibration stability of the transducer device (especially the magnetic circuit assembly 411). In some embodiments, in order to further improve the vibration stability of the transducer device 410, the acoustic output device 400 or 700 may include both the vibration transmission sheet 413A and the vibration transmission sheet 413B.

FIG. 9 is a schematic diagram illustrating an exemplary structure of an acoustic output device 900 according to some embodiments of the present disclosure. Structures of a transducer device 910 (including a magnetic circuit assembly 911, a coil 912, a vibration transmission sheet 913A, a vibration transmission sheet 913B), a housing 920 (including a panel 921), a support structure 930, an additional element 940, an clastic element 950, etc., illustrated in FIG. 9 may be similar to the transducer device 410 (including the magnetic circuit assembly 411, the coil 412, the vibration transmission sheet 413A, vibration transmission sheet 413B), the housing 420 (including the panel 421), the support structure 430, the additional element 440, the clastic element 450, etc., respectively, which are not be further described herein. The main difference between the acoustic output device 900 illustrated in FIG. 9 and the acoustic output device 700 illustrated in FIG. 7 may include that, in the acoustic output device 900, the shell 922 includes one or more pressure relief holes 9221 configured to connect air inside and outside the housing 920. In some embodiments, the pressure relief holes 9221 may be opened in a sidewall of the shell 922 opposite and/or adjacent to the panel 921. In some embodiments, the pressure relief holes 9221 may also be disposed at the elastic element 950. For example, when the elastic element 950 is a ring structure with elasticity, the pressure relief holes 9221 may be disposed at the ring structure. As another example, the clastic element 950 may also be a reed with through holes or an elastic web, and the through holes or slits in the clastic web may replace the pressure relief holes 9221 to connect the air inside and outside shell 922. It should be noted that the pressure relief holes 9221 herein may also be applied in the acoustic output devices according to other embodiments of the present disclosure, such as acoustic output devices 300, 400, 700, 1200, 1300, 1500, 1700, 1800, 1900, 2000, 2200, 2400, 2500, 2600, 2700, 2900, 3000, 3100, etc.

In the acoustic output device 900, the magnetic circuit assembly 911 may be connected to the panel 921 through the vibration transmission sheet 913A, which causes the problem that the magnetic circuit assembly 911 and the additional element 940 may attract or repel to each other to cause the deformation or inversion of the magnetic circuit assembly 911, thereby affecting the vibration stability of the transducer device 910. In order to avoid the magnetic circuit assembly 911 and the additional element 940 from being attracting or repelling to each other to cause the deformation or inversion of the magnetic circuit assembly 911 and affecting the vibration stability of the transducer device 910, in some embodiments, the vibration transmission sheet 913A between the magnetic circuit assembly 911 and the panel 921 may be replaced with the vibration transmission sheet 913B (indicated by dashed lines in FIG. 9). Merely by way of example, the vibration transmission sheet 913B may be disposed between the magnetic circuit assembly 911 and the sidewall on the shell 922 opposite to the panel 921. A side of the vibration transmission sheet 913B may be connected to a side of the magnetic circuit assembly 911 back away from the panel 921, and a circumferential side of the vibration transmission sheet 913B may be connected to a sidewall of the shell 922 adjacent to the panel 921. By locating the vibration transmission sheet 913B between the magnetic circuit assembly 911 and the sidewall of the shell 922 opposite to the panel 921, the vibration transmission sheet 913B can enhance the support effect of the magnetic circuit assembly 911 on a position near the additional element 940, and improve the vibration stability of the transducer device 910 (especially the magnetic circuit assembly 911). In some embodiments, in order to further improve the vibration stability of the transducer device 910, the acoustic output device 900 may include the vibration transmission sheet 913A and the vibration transmission sheet 913B.

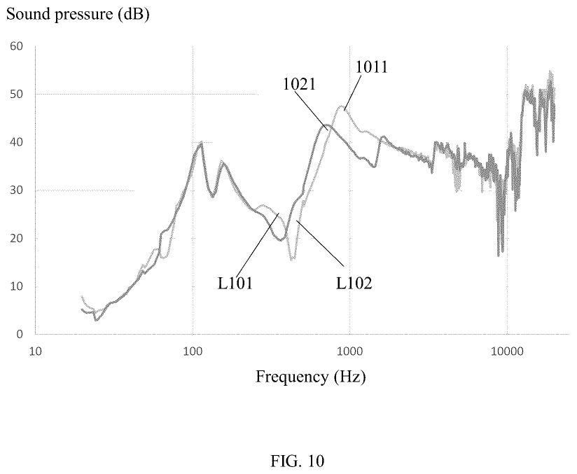

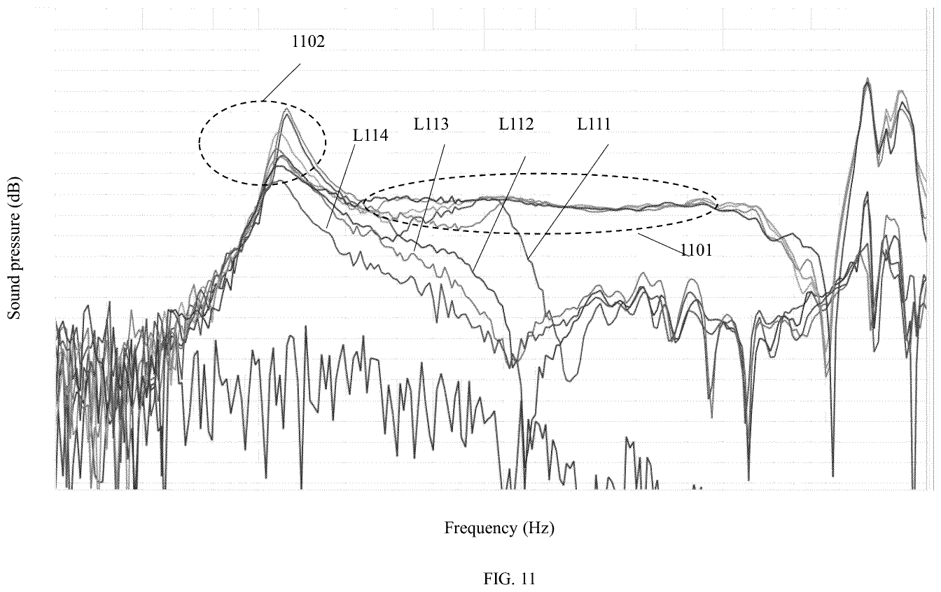

FIG. 10 is a graph of frequency response curves of acoustic output devices according to some embodiments of the present disclosure. FIG. 10 shows the frequency response curves of the acoustic output device 700 and the acoustic output device 900. The horizontal coordinates represent frequencies (Hz.), and the vertical coordinates represent sound pressures (dB) corresponding to an acoustic output device at different frequencies. A curve L101 represents a frequency response curve of the acoustic output device 700, and the curve L101 includes a resonance peak 1011. A curve L102 represents a frequency response curve of the acoustic output device 900, and the curve L102 includes a resonance peak 1021. Combining the curves L101 and L102, it can be seen that, a resonance frequency corresponding to the resonance peak 1011 is higher than a resonance frequency corresponding to the resonance peak 1021, and a frequency range (i.e., a frequency range greater than the resonance frequency corresponding to the resonance peak 1021) in which the sensitivity of the acoustic output device 900 is not or less affected by the additional element is wider than a frequency range (i.e., a frequency range greater than the resonance frequency corresponding to the resonance peak 1011) in which the sensitivity of the acoustic output device 700 is not or less affected by the additional element. It can be seen that, by opening the pressure relief holes on the shell, the resonance frequency corresponding to a resonance peak generated by the additional element that is driven by the clastic element to vibrate with respect to the panel can be reduced, so as to broaden the frequency range in which the sensitivity of the acoustic output device is not or less affected by the additional element. In addition, sound leakage may be generated by the vibration of the outside air driven by the vibration of the shell and/or the panel. The pressure relief holes disposed on the shell of the acoustic output device can also reduce a volume of the sound leakage of the acoustic output device. For instance, the pressure relief holes may export sound generated by the vibration of the magnetic circuit assembly inside the accommodating chamber to the outside world, and the sound may offset the sound leakage generated by the vibration of the shell and/or the panel, thereby reducing the volume of the sound leakage of the acoustic output device.

In some embodiments, the mass of the additional element may be adjusted to reduce the volume of the sound leakage of the acoustic output device in a frequency range higher than the resonance frequency corresponding to the resonance peak. FIG. 11 is a graph of frequency response curves of an acoustic output device according to some embodiments of the present disclosure. FIG. 11 illustrates sound leakage frequency response curves of the back panel (i.e., the sidewall of the shell 922 opposite to the panel 921) of the acoustic output device 900 and frequency response curves of the panel 921 of the acoustic output device 900 when the additional element have different masses. The horizontal coordinates represent frequencies (Hz.), and the vertical coordinates represent sound pressures (dB) corresponding to an acoustic output device at different frequencies. A curve L111 represents a sound leakage frequency response curve of the acoustic output device 900 when the mass of the additional element is 0 grams (g). The curve L112 represents a sound leakage frequency response curve of the acoustic output device 900 when the mass of the additional element is 0.7 g. The curve L113 represents a sound leakage frequency response curve of the acoustic output device 900 when the mass of the additional element is 1.4 g. The curve L114 represents a sound leakage frequency response curve of the acoustic output device 900 when the mass of the additional element is 2.1 g. A region 1101 represents frequency response curves of the acoustic output device 900 having the additional element with different masses. A region 1102 represents a resonance peak region of the acoustic output device 900 having the additional element with different masses. In some embodiments, the sound leakage frequency response curves of the acoustic output device 900 may be measured by collecting air-conduction sound on the sidewall of the shell 922 opposite to the panel 921, and the frequency response curves of the acoustic output device 900 may be measured by collecting air-conduction sound on the panel 921. As shown in FIG. 11, the region 1101 and the region 1102 shows that the acoustic output device 900 has essentially the same sensitivity when the acoustic output device 900 has the additional element with different masses in a frequency range (including the frequency range corresponding to the region 1101) higher than the resonance frequency corresponding to the resonance peak region (the region 1102). That is, the sensitivity of the acoustic output device 900 does not weaken with an increase of the mass of the additional element. In some embodiments, in combination with the curves L111 to L114, it can be seen that, as the mass of the additional element increases, the resonance frequency corresponding to the resonance peak in the leakage sound response curve of the acoustic output device 900 may reduce. In some embodiments, the mass of the additional element may be adjusted, such that the resonance frequency corresponding to the resonance peak in the sound leakage frequency response curve of the acoustic output device is less than the resonance frequency corresponding to the resonance peak in the frequency response curve of the acoustic output device. Therefore, the acoustic output device 900 in a frequency range (e.g., 300 Hz to 8000 Hz) where the sensitivity of the acoustic output device is not affected by the mass of the additional element can generate a relatively small volume of the sound leakage. In some embodiments, the resonance frequency corresponding to the resonance peak in the sound leakage frequency response curve of the acoustic output device may not be greater than 700 Hz. For example, the resonance frequency corresponding to the resonance peak in the sound leakage frequency response curve of the acoustic output device may not be greater than 500 Hz. As another example, the resonance frequency corresponding to the resonance peak in the sound leakage frequency response curve of the acoustic output device may not be greater than 300 Hz. As yet another example, the resonance frequency corresponding to the resonance peak in the sound leakage frequency response curve of the acoustic output device may not be greater than 200 Hz.

It should be noted that the pressure relief holes and the scheme of adjusting the mass of the additional element are not only applicable to the acoustic output device 900, but also to other acoustic output devices according to some embodiments of the present disclosure (e.g., the acoustic output devices 400, 700, 1200, etc.).

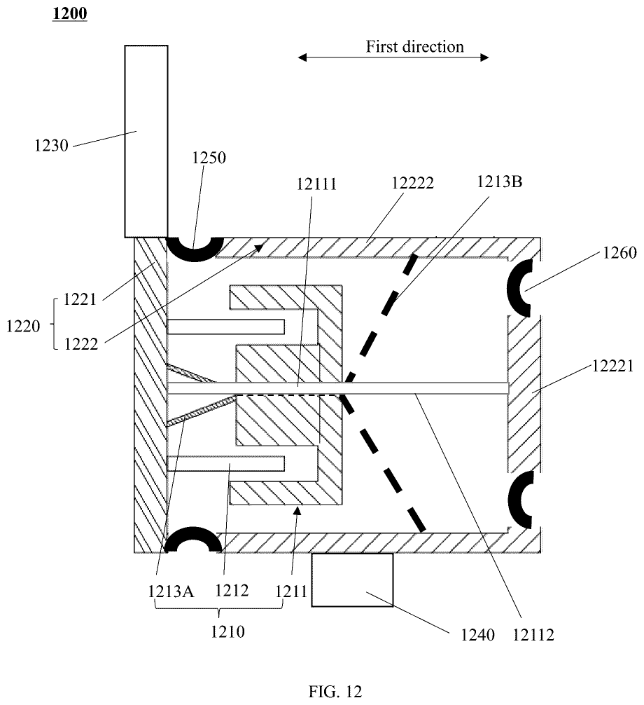

FIG. 12 is a schematic diagram illustrating an exemplary structure of an acoustic output device 1200 according to some embodiments of the present disclosure. A transducer device 1210 (including a magnetic circuit assembly 1211, a coil 1212, a vibration transmission sheet 1213A, a vibration transmission sheet 1213B), a housing 1220 (including a panel 1221), a support structure 1230, and an additional element 1240 in the acoustic output device 1200 shown in FIG. 12 may be similar to the transducer device 410 (including the magnetic circuit assembly 411, the coil 412, the vibration transmission sheet 413A, and the vibration transmission sheet 413B), the housing 420 (including the panel 421), the support structure 430, and the additional element 440 in the acoustic output device 700, respectively, which are not be further described herein. The main difference between the acoustic output device 1200 and the acoustic output device 700 may include that a sidewall (also referred to as a back panel 12221) of the shell 1222 of the acoustic output device 1200 opposite to the panel 1221 is connected to other sidewalls of the shell 1222 (sidewalls adjacent to the panel 1221, also referred to as a housing body 12222) through an clastic element 1260. In some embodiments, the clastic element 1260 may be a ring structure as shown in FIG. 12, and the ring structure may be made of an elastomeric material. Merely by way of example, the shell 1222 may include the housing body 12222 and the back panel 12221. The housing body 12222 includes the panels on the shell 1222 adjacent to the panel 1221, and the back panel 12221 is the sidewall of the shell 1222 opposite to the panel 1221. The back panel 1221 is independently disposed with respect to the housing body 12222, the ring structure is disposed around a circumferential side of the back panel 12221, and the circumferential side of the ring structure is connected to a sidewall of the housing body 12222. It should be noted that the structure of the elastic element 1260 illustrated in FIG. 12 is merely for illustration, and is not intended to limit the scope of the present disclosure. In some embodiments, the clastic element 1260 may also be a structure having other shapes (e.g., a strip, a sheet, a plate, etc.) made of an elastic material. In some embodiments, the clastic material may include polycarbonate (PC), polyamides (PA), acrylonitrile butadiene styrene (ABS), polystyrene (PS), high impact polystyrene (HIPS), polypropylene (PP), polyethylene terephthalate (PET), polyvinyl chloride (PVC), polyurethanes (PU), polyethylene (PE), phenol formaldehyde (PF), urea-formaldehyde (UF), melamine-formaldehyde (MF), polyarylate (PAR), polyetherimide (PEI), pcolyimide (PI), polyethylene naphthalate two formic acid glycol ester (PEN), polyetheretherketone (PEEK), carbon fiber, graphene, silica gel, or the like, or any combination thereof. In some embodiments, the clastic element 1260 may be an elastic structural body. The clastic structural body refers to a structure that is inherently elastic. That is, even though the material is hard, the clastic element 1260 is inherently elastic since the structure is inherently clastic. In some embodiments, the elastic structure may include a structure such as a reed structure. That is, the clastic element 1260 may be the reed structure. In some embodiments, the elastic element 1260 may also be a glue with a certain elasticity used to adhere the housing body 12222 and the back panel 12221. In some embodiments, the glue having a certain elasticity may be a silicone bonding type of glue, a silicone glue, etc. In some embodiments, the housing body 12222 may be in a sealed connection with the back panel 12221. In some embodiments, the connection between the housing body 12222 and the back panel 12221 may also not be a sealed connection, and a gap between the housing body 12222 and the back panel 12221 may act as a pressure relief hole, connecting the air inside and outside the shell 1222 to reduce the resonance frequency corresponding to the resonance peak of the acoustic output device 1200. Thus, the frequency range in which the sensitivity of the acoustic output device 1200 is not affected by the additional element (or the frequency range corresponding to a flat frequency response curve) can be wider.

The back panel 12221 of the acoustic output device 1200 may be connected to the housing body 12222 through the clastic element 1260, and the back panel 12221 and the clastic element 1260 may be equivalent to a mass-elastic module. The mass-elastic module may have an vibration isolation effect, so that the high frequency vibration generated by the transducer device 1210 cannot be transmitted to the back panel 12221. Therefore, the high frequency vibration of the back panel 12221 that generates the high frequency sound leakage can be avoided.

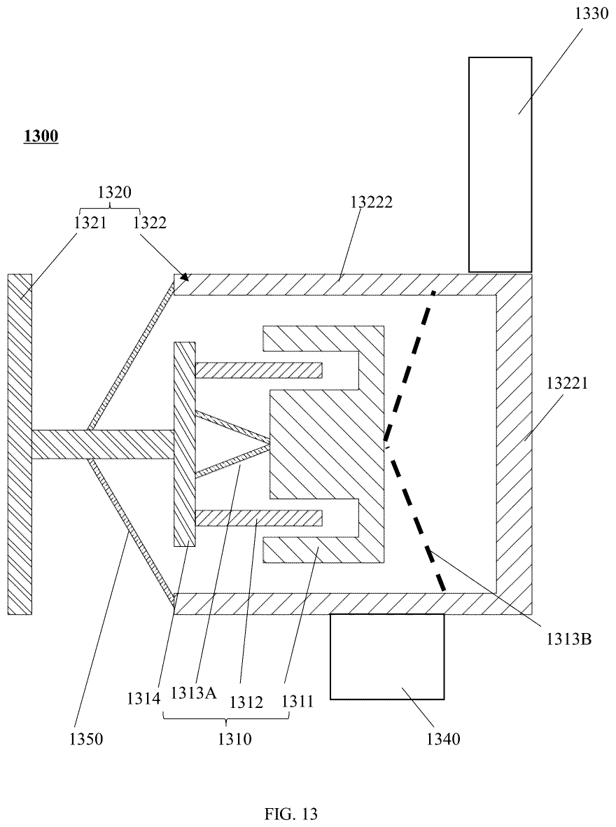

It should be noted that the back panel and the housing body in other acoustic output devices according to the embodiments of the present disclosure (e.g., the acoustic output device 400 shown in FIG. 4, the acoustic output device 900 shown in FIG. 9, the acoustic output device 1300 shown in FIG. 13, etc.) may also be connected through the elastic element, so as to avoid the acoustic output device from generating the high frequency sound leakage on the side of the back panel.

In the acoustic output device 1200, the magnetic circuit assembly 1211 may be connected to the panel 1221 by the vibration transmission sheet 1213A, which causes the problem that the magnetic circuit assembly 1211 and the additional element 1240 may attract or repel to each other to cause the deformation or inversion of the magnetic circuit assembly 1211, thereby affecting the vibration stability of the transducer device 1210. In order to avoid the magnetic circuit assembly 1211 and the additional element 1240 from being attracting or repelling to each other to cause the deformation or inversion of the magnetic circuit assembly 1211 and affecting the vibration stability of the transducer device 1210, in some embodiments, the vibration transmission sheet 1213A between the magnetic circuit assembly 1211 and the panel 1221 may be replaced with the vibration transmission sheet 1213B (indicated by dashed lines in FIG. 12). Merely by way of example, the vibration transmission sheet 1213B may be disposed between the magnetic circuit assembly 1211 and the sidewall on the shell 1222 opposite to the panel 1221. A side of the vibration transmission sheet 1213B may be connected to a side of the magnetic circuit assembly 1211 back away from the panel 1221, and a circumferential side of the vibration transmission sheet 1213B may be connected to a sidewall (the housing body 12222) of the shell 1222 adjacent to the panel 1221. By locating the vibration transmission sheet 1213B between the magnetic circuit assembly 1211 and the sidewall of the shell 1222 opposite to the panel 1221, the vibration transmission sheet 1213B can enhance the support effect of the magnetic circuit assembly 1211 on a position near the additional element 1240, and improve the vibration stability of the transducer device 1210 (especially the magnetic circuit assembly 1211). In some embodiments, in order to further improve the vibration stability of the transducer device 1210, the acoustic output device 1200 may include the vibration transmission sheet 1213A and the vibration transmission sheet 1213B.

In some embodiments, as shown in FIG. 12, the magnetic circuit assembly 1211 may include an aperture portion 12111 and a positioning rod 12112. The aperture portion 12111 may penetrate the magnetic circuit assembly 1211 in a vibration direction of the transducer device 1210 (a first direction shown in FIG. 12). An end of the positioning rod 12112 away from the panel 1221 may be connected to the back panel 12221, and another end of the positioning rod 12112 may pass through the aperture portion 12111 and connected to the panel 1221. In some embodiments, the another end of the positioning rod 12112 may be connected to the panel 1221, so that the panel 1221 vibrates together with the back panel 12221, reducing sound leakage due to unsynchronized vibrations between the panel 1221 and the back panel 12221. At the same time, the cooperation between the positioning rod 12112 and the aperture portion 12111 may further increase the stability of the magnetic circuit assembly 1211, reducing the risk that the magnetic circuit assembly 1211 and the additional element 1240 attract or repel to each other to cause the deformation or inversion of the magnetic circuit assembly 1211.

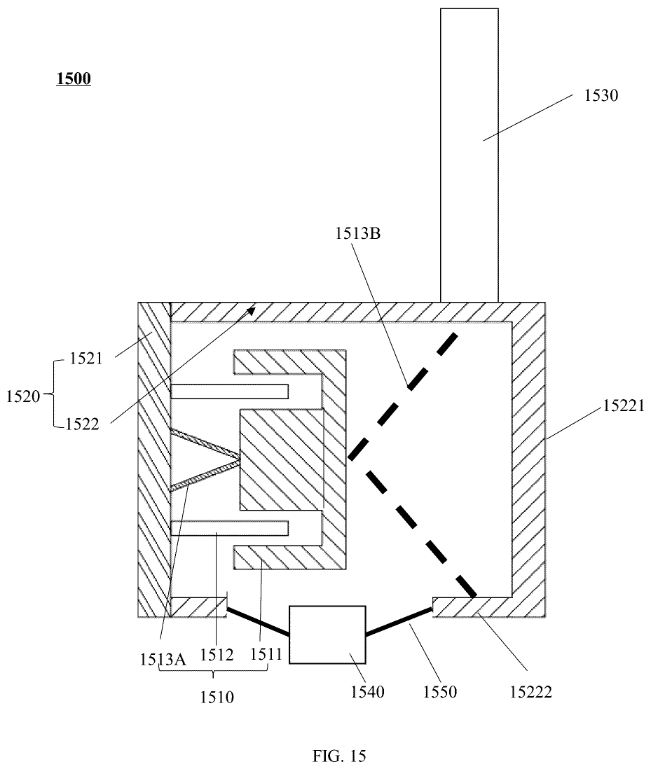

It should be noted that the magnetic circuit assembly including the aperture portion 12111 and the positioning rod 12112 is applicable to other acoustic output devices in the embodiments of the present disclosure, e.g., the acoustic output device 400 illustrated in FIG. 4, the acoustic output device 700 illustrated in FIG. 9, the acoustic output device 900 illustrated in FIG. 13, an acoustic output device 1500 illustrated in FIG. 15, etc.

FIG. 13 is a schematic diagram illustrating an exemplary structure of an acoustic output device 1300 according to some embodiments of the present disclosure. As shown in FIG. 13, the acoustic output device 1300 may include a transducer device 1310, a housing 1320, a support structure 1330, an additional element 1340, and an clastic element 1350. The transducer device 1310 may include a magnetic circuit assembly 1311, a coil 1312, a vibration transmission sheet 1313A, and a vibration plate 1314. The vibration plate 1314 may be elastically connected to the magnetic circuit assembly 1311 through the vibration transmission sheet 1313A. In some embodiments, the housing 1320 may include a panel 1321 and a shell 1322. In some embodiments, the shell 1322 may include a back panel 13221 opposite to the panel 1321 and a housing body 13222 adjacent to the panel 1321. The support structure 1330 may be rigidly connected to the panel 1321 or the shell 1322 (e.g., the back panel 13221 and the housing body 13222). In some embodiments, the clastic element 1350 may be a vibration damping sheet. The panel 1321 may be elastically connected to the shell 1322 through the vibration damping sheet. The additional element 1340 may be rigidly connected to the shell 1322, the panel 1321 may be rigidly connected to the vibration plate 1314, and the shell 1322 may be connected to the vibration plate 1314 and the panel 1321 through the vibration damping sheet. Merely by way of example, the vibration plate 1314 may be connected to the coil 1312. When the transducer device 1310 operates, the coil 1312 may drive the vibration plate 1314 together with the panel 1321 to perform a mechanical vibration. The vibration plate 1314 may be rigidly connected to the panel 1321 through a rigid member (e.g., a connecting rod). The rigid member may be connected to the shell 1322 (the sidewall of the shell 1322 adjacent to the panel 1321) through the vibration damping sheet, thereby connecting the shell 1322 and the vibration plate 1314 with the panel 1321. In some embodiments, the panel 1321 (and structure(s) (e.g., the vibration plate 1314, the coil 1312, etc.) rigidly connected to the panel 1321), the clastic element 1350, the shell 1322 (and structures (e.g., the additional element 1340, the support structure 1330, etc.) rigidly connected to the shell 1322) may form a resonance system. It should be noted that when other structures are rigidly connected to the panel 1321 or the shell 1322, the structures are also considered as a portion of the resonance system. The resonance system may generate a resonance peak within a target frequency range. The vibration transmission between the additional element 1340 and the panel 1321 may be suppressed in the frequency range greater than the resonance frequency corresponding to the resonance peak. That is, the influence of the additional element 1340 on the vibration of the panel 1321 is reduced, thereby ensuring that the sensitivity of the acoustic output device 1300 is not or less affected by the additional element 1340 in the frequency range greater than the resonance frequency corresponding to the resonance peak. In some embodiments, by setting the resonance frequency corresponding to the resonance peak at a relatively low frequency position, the frequency range in which the sensitivity of the acoustic output device 1300 is weakened due to the additional element 1340 can be reduced. In addition, in the frequency range greater than the resonance frequency corresponding to the resonance peak, a frequency response curve of the acoustic output device 1300 may be flatter due to the lesser influence of the additional element 1340 on the vibration of the panel 1321, which can ensure that the acoustic output device 1300 has a better acoustic output effect in a wider frequency range, improving the user's listening experience

Structures of the shell 1322, the support structure 1330, the additional element 1340, the magnetic circuit assembly 1311, the coil 1312, the vibration transmission sheet 1313A, etc., may be similar to structures of the shell 422, the support structure 430, the additional element 440, the magnetic circuit assembly 411, the coil 412, the vibration transmission sheet 413A, etc., in the acoustic output device 400, respectively, which are not described herein.

In some embodiments, the vibration damping sheet may be a sheet-like structure made of an clastic material (e.g., silicone, polyurethane, etc.). In some embodiments, the vibration damping sheet may be an elastic structure (e.g., a reed structure) that is inherently elastic. Due to the presence of the vibration damping sheet, the mechanical vibration generated by the transducer device 1310 may be less or even not transmitted to the shell 1322, so that the mass of the shell 1322 and the mass of the additional element 1340 do not cause an increase in the loading mass of the vibration of the transducer device 1310 within the frequency range higher than the resonance frequency corresponding to the resonance peak. Thus, the sensitivity of the acoustic output device 1300 in the frequency range higher than the resonance frequency corresponding to the resonance peak can not be affected by the additional element 1340 and the shell 1322 (as well as related components disposed in the shell 1322, such as the support structure 1330, a battery, a circuit board), and the frequency response curve of the acoustic output device 1300 can be relatively flat in the frequency range higher than the resonance frequency corresponding to the resonance peak, thereby ensuring that the acoustic output device 1300 can output a better sound quality.

In some embodiments, to avoid the acoustic output device 1300 from generating high frequency sound leakage on the side of the shell 1322 opposite to the panel 1321, the sidewall (i.e., the back panel 13221) of the shell 1322 opposite to the panel 1321 may be connected to other sidewalls (e.g., the housing body 13222) of the shell 1322 through the elastic element. In some embodiments, the manner that the housing body 12222 in the acoustic output device 1200 is connected to the back panel 12221 through the clastic element 1260 as shown in FIG. 12 can also be applied for connecting the housing body 13222 to the back panel 13221 in the acoustic output device 1300.

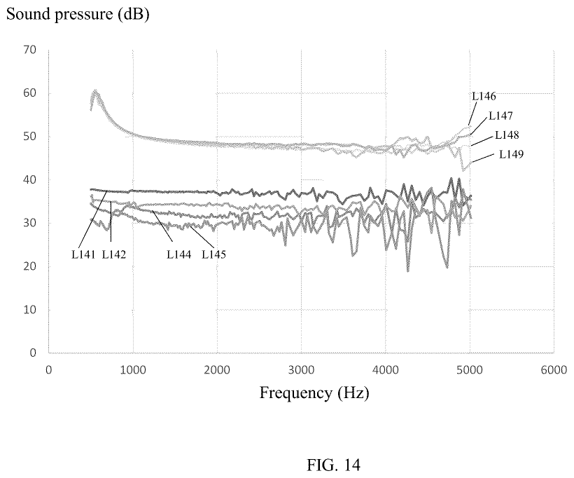

FIG. 14 is a graph of frequency response curves of acoustic output devices according to some embodiments of the present disclosure.

FIG. 14 shows the frequency response curves of the acoustic output device 200 and the acoustic output device 1300 when the additional elements have different masses. The horizontal coordinates represent frequencies (Hz), and the vertical coordinates represent sound pressures (dB) corresponding to an acoustic output device at different frequencies. A curve L141 represents a frequency response curve of the acoustic output device 200 when the mass of the additional element 40 is 0 g. The curve L142 represents a frequency response curve of the acoustic output device 200 when the mass of the additional element 40 is 1 g. The curve L144 represents a frequency response curve of the acoustic output device 200 when the mass of the additional element 40 is 2 g. The curve L145 represents a frequency response curve of the acoustic output device 200 when the mass of the additional element 40 is 3 g. The curve L146 represents a frequency response curve of the acoustic output device 1300 when the mass of the additional element 1340 is 2 g. The curve L147 represents a frequency response curve of the acoustic output device 1300 when the mass of the additional element 1340 is 0 g. The curve L148 represents a frequency response curve of the acoustic output device 1300 when the mass of the additional element 1340 is 3 g. The curve L149 represents a frequency response curve of the acoustic output device 1300 when the mass of the additional element 1340 is 1 g.

Combining the frequency response curves of the acoustic output device 200 and the frequency response curves of the acoustic output device 1300, it can be seen that, in a frequency range of 500 Hz, to 5000 Hz, the sound pressure output by the acoustic output device 1300 is overall greater than the sound pressure output by the acoustic output device 200. That is, in the frequency range of 500 Hz to 5000 Hz, the sensitivity of the acoustic output device 1300 is stronger than the sensitivity of the acoustic output device 200. Therefore, the acoustic output device 1300, with respective to the acoustic output device 200, can solve the problem of weak sensitivity caused by the arrangement of the additional element on the bone-conduction acoustic output device. In addition, according to the frequency response curves of the acoustic output device 200, it can be seen that in the frequency range of 500 Hz, to 5000 Hz, as the mass of the additional element 40 increases, the sound pressure of the acoustic output device 200 overall decreases. That is, the sensitivity of the acoustic output device 200 is weakened. It can be seen that the sensitivity of the acoustic output device 200 is affected by the mass of the additional element 40. According to the frequency response curves of the acoustic output device 1300, it can be seen that in the frequency range of 500 Hz, to 5000 Hz, the frequency response curves of the acoustic output device 1300 are relatively flat. As the mass of the additional element 1340 increases, the sound pressure of the acoustic output device 1300 does not change overall. That is, the sensitivity of the acoustic output device 1300 does not change. It can be seen that the sensitivity of the acoustic output device 1300 is not affected by the mass of the additional element 1340 to change. This makes that the acoustic output device 1300 has the relatively flat frequency response curves in the frequency range of 500 Hz-5000 Hz, ensuring that the acoustic output device 1300 can output a better sound quality.

In the acoustic output device 1300, the magnetic circuit assembly 1311 and the vibration plate 1314 may be connected through the vibration transmission sheet 1313A, which causes the problem that the magnetic circuit assembly 1311 and the additional element 1340 may attract or repel to each other to cause the deformation or inversion of the magnetic circuit assembly 1311, thereby affecting the vibration stability of the transducer device 1310. In order to avoid the magnetic circuit assembly 1311 and the additional element 1340 from being attracting or repelling to each other to cause the deformation or inversion of the magnetic circuit assembly 1311 and affecting the vibration stability of the transducer device 1310, in some embodiments, the vibration transmission sheet 1313A between the magnetic circuit assembly 1311 and the panel 1321 may be replaced with the vibration transmission sheet 1313B (indicated by dashed lines in FIG. 13). Merely by way of example, the vibration transmission sheet 1313B may be disposed between the magnetic circuit assembly 1311 and the sidewall on the shell 1322 opposite to the panel 1321. A side of the vibration transmission sheet 1313B may be connected to a side of the magnetic circuit assembly 1311 back away from the panel 1321, and a circumferential side of the vibration transmission sheet 1313B may be connected to a sidewall (the housing body 13222) of the shell 1322 adjacent to the panel 1321. By locating the vibration transmission sheet 1313B between the magnetic circuit assembly 1311 and the sidewall of the shell 1322 opposite to the panel 1321, the vibration transmission sheet 1313B can enhance the support effect of the magnetic circuit assembly 1311 on a position near the additional element 1340, and improve the vibration stability of the transducer device 1310 (especially the magnetic circuit assembly 1311). In some embodiments, in order to further improve the vibration stability of the transducer device 1310, the acoustic output device 1300 may include the vibration transmission sheet 1313A and the vibration transmission sheet 1313B.

FIG. 15 is a schematic diagram illustrating an exemplary structure of an acoustic output device 1500 according to some embodiments of the present disclosure.

As shown in FIG. 15, structures of a transducer device 1510 (including a magnetic circuit assembly 1511, a coil 1512, a vibration transmission sheet 1513A), a panel 1521, a housing 1520 (including a panel 1521 and a shell 1522), a support structure 1530, an additional element 1540, etc., in the acoustic output device 1500 may be similar to the structures of the transducer device 410 (including the magnetic circuit assembly 411, the coil 412, the vibration transmission sheet 413A), the housing 420 (including the panel 421 and the shell 422), the support structure 430, the additional element 440, etc., in the acoustic output device 400, which are not further described herein. The difference between the acoustic output device 1500 and the acoustic output device 400 may include that, in the acoustic output device 1500, the panel 1521 may be rigidly connected to the shell 1522, the additional element 1540 may be connected to a sidewall of the shell 1522 through the clastic element 1550, and the additional element 1540 and the clastic element 1550 may be served as at least a partial structure of the side wall of the shell 1522. The sidewall of the shell 1522 may include a sidewall (i.e., a back panel 15221) opposite to the panel 1521 and a sidewall (i.e., a housing body 15222) adjacent to the panel 1521. In some embodiments, the clastic element 1550 may be a ring structure with elasticity, and the additional element 1540 may be connected to the sidewall of the shell 1522 through the ring structure. Merely by way of example, the sidewall of the shell 1522 may be opened with holes or grooves matching with a shape of the additional element 1540. The ring structure may be sleeved to a circumferential side of the additional element 1540. The additional element 1540 sleeved with the ring structure may be embedded within the holes or grooves in the sidewall of the shell 1522, such that the additional element 1540 and the clastic element 1550 can be served as a portion of the sidewall. In some embodiments, instead of the ring structure with elasticity, an adhesive with elasticity may be used to adhere the circumferential side of the additional element 1540 with inner walls of the holes or grooves in the sidewall of the shell 1522. In some embodiments, the clastic element 1550 may be a reed structure. The additional element 1540 may be connected to a surface of the reed structure or embedded on the reed structure. A circumferential side of the reed structure may be connected to the panel 1521 and/or other sidewalls of the shell 1522, such that the additional element 1540 and the clastic element 1550 can be entirely served as one of the sidewall of the shell 1522 or a portion thereof. At this time, the clastic element 1550, the additional element 1540, the panel 1521, and the shell 1522 may enclose to form an accommodating chamber. In some embodiments, the reed structure may be a sheet-like structure with elasticity made of a metallic material (e.g., iron, aluminum, copper, etc.) or a non-metallic material (e.g., rubber, urethane-like material, etc.). In some embodiments, the acoustic output device 1500 may include a support plate (not shown in FIG. 15), the additional element 1540 may be disposed on the support plate, and the support plate may be connected to the sidewall of the shell 1522 through the clastic element 1550. The support plate may be disposed inside or outside the shell 1522. Alternatively, the elastic element 1550 and the support plate may be served as one of the sidewall or a portion of the sidewall.

In some embodiments, the panel 1521, the shell 1522, structure(s) rigidly connected to the panel 1521 or the shell 1522 (e.g., the coil 1512, the support structure 1530, etc.), and the additional element 1540 may be elastically connected to each other through the elastic element 1550 to form a resonance system. It should be noted that when other structures are rigidly connected to the panel 1521 or the shell 1522, the structures are also considered as a portion of the resonance system. The resonance system may generate a resonance peak within a target frequency range. The vibration transmission between the additional element 1540 and the panel 1521 may be suppressed in the frequency range greater than the resonance frequency corresponding to the resonance peak. That is, the influence of the additional element 1540 on the vibration of the panel 1521 is reduced, thereby ensuring that the sensitivity of the acoustic output device 1500 is not or less affected by the additional element 1540 in the frequency range greater than the resonance frequency corresponding to the resonance peak. In some embodiments, by setting the resonance frequency corresponding to the resonance peak at a relatively low frequency position, the frequency range in which the sensitivity of the acoustic output device 1500 is weakened due to the additional element 1540 can be reduced. In addition, in the frequency range greater than the resonance frequency corresponding to the resonance peak, a frequency response curve of the acoustic output device 1500 may be flatter due to the lesser influence of the additional element 1540 on the vibration of the panel 1521, which can ensure that the acoustic output device 1500 has a better acoustic output effect in a wider frequency range, improving the user's listening experience. In some embodiments, the clastic element 1550 may drive the additional element 1540 to vibrate with respect to the panel 1521 to generate a resonance valley in the target frequency range. In some embodiments, the target frequency range may be from 20 Hz, to 800 Hz. For example, the target frequency range may be from 100 Hz to 600 Hz. As another example, the target frequency range may be from 200 Hz to 400 Hz. In some embodiments, the frequency corresponding to the resonance valley may be less than the frequency corresponding to the resonance peak. In some embodiments, the frequency difference between the frequency corresponding to the resonance peak and the frequency corresponding to the resonance valley may not be greater than 300 Hz. In some embodiments, the frequency difference between the frequency corresponding to the resonance peak and the frequency corresponding to the resonance valley may not be greater than 200 Hz. In some embodiments, the frequency difference between the frequency corresponding to the resonance peak and the frequency corresponding to the resonance valley may not be greater than 100 Hz. In some embodiments, a difference between the resonance peak and resonance valley may be within a range of 20 decibels (dB) to 100 dB. In some embodiments, the difference between the resonance peak and the resonance valley may be within a range of 20 dB to 60 dB. In some embodiments, the difference between the resonance peak and the resonance valley may be within a range of 20 dB to 40 dB.

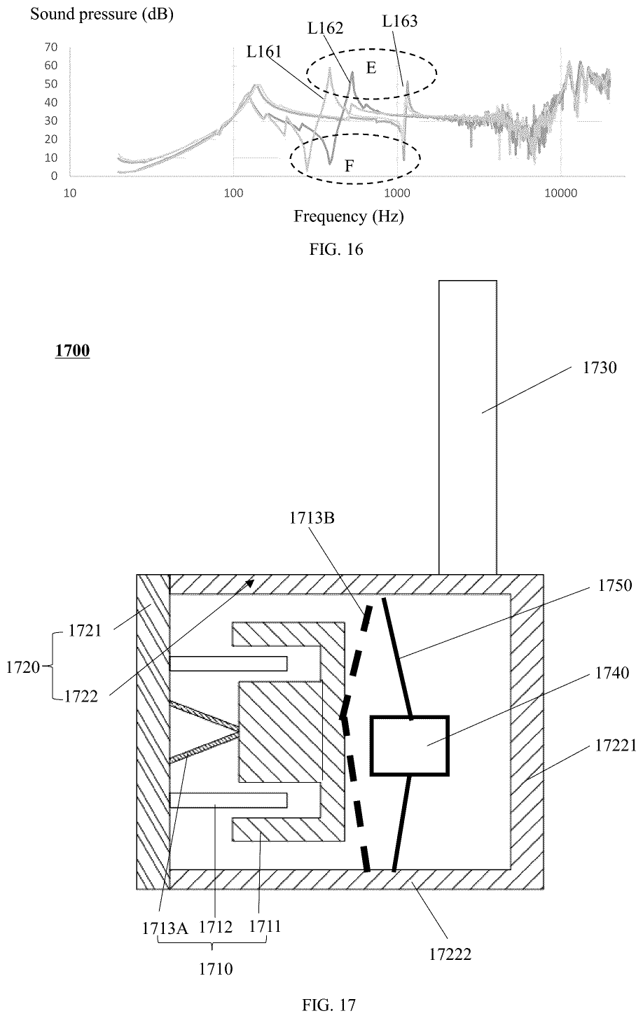

In some embodiments, by adjusting an clastic coefficient of the elastic element 1550 and the mass of the additional element 1540, the resonance peak in the target frequency range may be located in a specific frequency range, so that the frequency range in which the additional element 440 affects the acoustic output device 400 can be reduced, and the acoustic output device 1500 can have a flat frequency response curve in a wider frequency band to output a better sound quality. At the same time, the sensitivity of the acoustic output device 1500 can not be affected by the additional element 1540 in the wider frequency band. More descriptions may be found in FIG. 16.

FIG. 16 is a graph of frequency response curves of an acoustic output device according to some embodiments of the present disclosure.

FIG. 16 shows the frequency response curves of the acoustic output device 1500 when the clastic element 1550 has different clastic coefficients and the additional element 1540 has different masses. The horizontal coordinates represent frequencies (Hz), and the vertical coordinates represent sound pressures (dB) corresponding to an acoustic output device at different frequencies. A curve L161 represents a frequency response curve of the acoustic output device 1500 when the elastic coefficient of the clastic element 1550 is 8800 N/m and the mass of the additional element 1540 is 2 g. The curve L162 represents a frequency response curve of the acoustic output device 1500 when the elastic coefficient of the clastic element 1550 is 16500 N/m and the mass of the additional element 1540 is 2 g. The curve L163 represents a frequency response curve of the acoustic output device 1500 when the clastic coefficient of the clastic element 1550 is 16500 N/m and the mass of the additional element 1540 is 0.3 g. Resonance peaks in a region E represent resonance peaks located in a target frequency range generated by the clastic element 1550 driving the additional element 1540 to vibrate with respective to the panel 1521. Resonance valleys in a region F represent resonance valleys located in the target frequency range generated by the clastic element 1550 driving the additional element 1540 to vibrate with respective to the panel 1521. Combining the curves L161 and L162, it can be seen that, as the clastic coefficient of the clastic element 1550 increases, the resonance frequency corresponding to the resonance peak increases, and the frequency range in which the sensitivity of the acoustic output device 1500 is not affected by the additional element 1540 narrows. Combining the curves L162 and L163, it can be seen that, as the mass of the additional element 1540 increases, the resonance frequency corresponding to the resonance peak increases, and the frequency range in which the sensitivity of the acoustic output device 1500 is not affected by the additional element 1540 broadens. In some embodiments, by adjusting the clastic coefficient of the clastic element 1550 and/or the mass of the additional element 1540, the resonance frequency can be within a target frequency range to broaden the frequency range in which the sensitivity of the acoustic output device 1500 is not affected by the additional element 1540. In some embodiments, the target frequency range may not be greater than 700 Hz. For example, the target frequency range may not be greater than 500 Hz. As another example, the target frequency range may not be greater than 500 Hz. As yet another example, the target frequency range may not be greater than 300 Hz. As still another example, the target frequency range may not be greater than 200 Hz, etc. In the acoustic output device 1500, the magnetic circuit assembly 1511 and the panel 1521 may be connected through the vibration transmission sheet 1513A, which causes the problem that the magnetic circuit assembly 1511 and the additional element 1540 may attract or repel to each other to cause the deformation or inversion of the magnetic circuit assembly 1511, thereby affecting the vibration stability of the transducer device 1510. In order to avoid the magnetic circuit assembly 1511 and the additional element 1540 from being attracting or repelling to each other to cause the deformation or inversion of the magnetic circuit assembly 1511 and affecting the vibration stability of the transducer device 1510, in some embodiments, the vibration transmission sheet 1513A between the magnetic circuit assembly 1511 and the panel 1521 may be replaced with the vibration transmission sheet 1513B (indicated by dashed lines in FIG. 15). Merely by way of example, the vibration transmission sheet 1513B may be disposed between the magnetic circuit assembly 1511 and the sidewall on the shell 1522 opposite to the panel 1521. A side of the vibration transmission sheet 1513B may be connected to a side of the magnetic circuit assembly 1511 back away from the panel 1521, and a circumferential side of the vibration transmission sheet 1513B may be connected to a sidewall (the housing body 15222) of the shell 1522 adjacent to the panel 1521. By locating the vibration transmission sheet 1513B between the magnetic circuit assembly 1511 and the sidewall of the shell 1522 opposite to the panel 1521, the vibration transmission sheet 1513B can enhance the support effect of the magnetic circuit assembly 1511 on a position near the additional element 1540, and improve the vibration stability of the transducer device 1510 (especially the magnetic circuit assembly 1511). In some embodiments, in order to further improve the vibration stability of the transducer device 1510, the acoustic output device 1500 may include the vibration transmission sheet 1513A and the vibration transmission sheet 1513B.

FIG. 17 is a schematic diagram illustrating an exemplary structure of an acoustic output device 1700 according to some embodiments of the present disclosure.

As shown in FIG. 17, structures of a transducer device 1710 (including a magnetic circuit assembly 1711, a coil 1712, the vibration transmission sheet 1713A), a panel 1721 in a housing 1720, a support structure 1730, an additional element 1740, etc., in an acoustic output device 1700 may be similar to the structures of the transducer device 1510 (including the magnetic circuit assembly 1511, the coil 1512, the vibration transmission sheet 1513A), the panel 1521 in the housing 1520, the support structure 1530, the additional element 1540, etc., in the acoustic output device 1500 in FIG. 15, which are not further described herein. The difference between the acoustic output device 1700 and the acoustic output device 200 may include that, the additional element 1740 is independently disposed with respect to the housing 1720, and the additional element 1740 is connected to the shell 1722 through the clastic element 1750. In some embodiments, the additional element 1740 may be independently disposed outside of the housing 1720. In some embodiments, as shown in FIG. 17, the additional element 1740 may be independently disposed inside the housing 1720. In some embodiments, the clastic element 1750 may be a reed structure. One end of the reed structure may be connected to the additional element 1740, and the other end of the reed structure may be connected to a sidewall of the shell 1722 (the housing body 17222 and/or the back panel 17221). In some embodiments, the clastic element 1750 may be a ring structure with elasticity. Merely by way of example, the additional element 1740 may be disposed within the shell 1722 and independently arranged relative to the shell 1722. An inner contour of the ring structure may be connected to a circumferential side of the additional element 1740, and an outer contour of the ring structure may be connected to an inner wall of the housing body 17222. It is noted that the additional element 1740 herein may be a battery, a circuit board, a sensor that is not sensitive to the vibration direction (e.g., a temperature sensor and a humidity sensor), etc.

In the acoustic output device 1700, the magnetic circuit assembly 1711 and the panel 1721 may be connected through the vibration transmission sheet 1713A, which causes the problem that the magnetic circuit assembly 1711 and the additional element 1740 may attract or repel to each other to cause the deformation or inversion of the magnetic circuit assembly 1711, thereby affecting the vibration stability of the transducer device 1710. In order to avoid the magnetic circuit assembly 1711 and the additional element 1740 from being attracting or repelling to each other to cause the deformation or inversion of the magnetic circuit assembly 1711 and affecting the vibration stability of the transducer device 1710, in some embodiments, the vibration transmission sheet 1713A between the magnetic circuit assembly 1711 and the panel 1721 may be replaced with the vibration transmission sheet 1713B (indicated by dashed lines in FIG. 17). Merely by way of example, the vibration transmission sheet 1713B may be disposed between the magnetic circuit assembly 1711 and the sidewall on the shell 1722 opposite to the panel 1721. A side of the vibration transmission sheet 1713B may be connected to a side of the magnetic circuit assembly 1711 back away from the panel 1721, and a circumferential side of the vibration transmission sheet 1713B may be connected to a sidewall (the housing body 17222) of the shell 1722 adjacent to the panel 1721. By locating the vibration transmission sheet 1713B between the magnetic circuit assembly 1711 and the sidewall of the shell 1722 opposite to the panel 1721, the vibration transmission sheet 1713B can enhance the support effect of the magnetic circuit assembly 1711 on a position near the additional element 1740, and improve the vibration stability of the transducer device 1710 (especially the magnetic circuit assembly 1711). In some embodiments, in order to further improve the vibration stability of the transducer device 1710, the acoustic output device 1700 may include the vibration transmission sheet 1713A and the vibration transmission sheet 1713B.

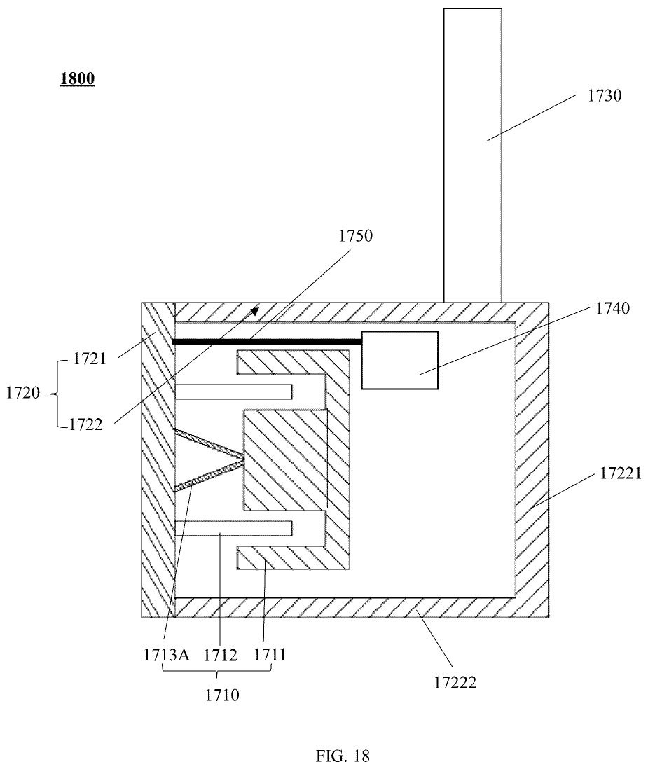

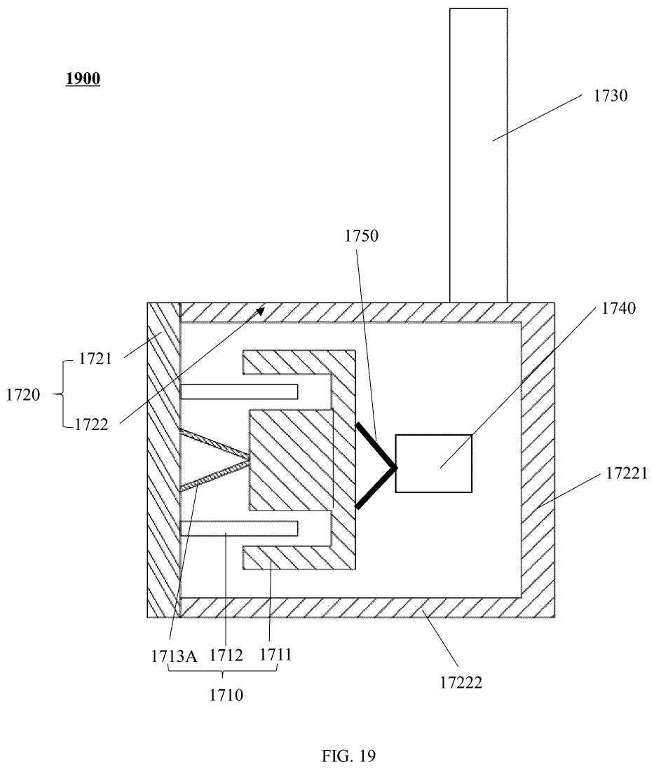

FIGS. 18 and 19 are schematic diagrams illustrating exemplary structures of acoustic output devices according to some embodiments of the present disclosure.

In some embodiments, as shown in FIG. 18, the additional element 1740 in an acoustic output device 1800 may be elastically connected to the panel 1721 through the elastic element 1750. In some embodiments, as shown in FIG. 19, the additional element 1740 in an acoustic output device 1900 may be elastically connected to the transducer device 1710 through the clastic element 1750. It is noted that the additional elements 1740 shown in FIGS. 18 and 19 may be batteries, circuit boards, or sensors (e.g., temperature sensors and humidity sensors) that are not sensitive to the vibration direction, etc. It should be noted that the additional element 1740 may also be adhered directly to the shell 1722 via glue. For example, the additional element 1740 may be adhered to the housing body 17222 via glue, and the solidified glue may have a certain elasticity and may serve the same function as the clastic element 1750. In some embodiments, the glue may include a gel type, an organic-silicone type, an acrylic type, a polyurethane type, a rubber type, an epoxy type, a hot melt type, a light curing type, or the like, or any combination thereof. Preferably, the adhesive may be an organic-silicone adhering type glue, an organic-silicone type glue.

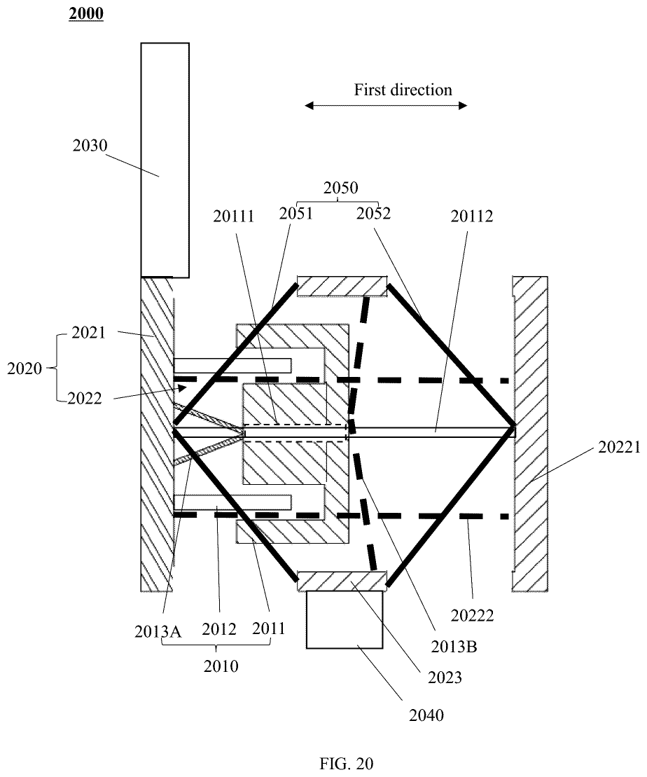

FIG. 20 is a schematic diagram illustrating an exemplary structure of an acoustic output device 2000 according to some embodiments of the present disclosure.

As shown in FIG. 20, the acoustic output device 2000 may include a transducer device 2010, a housing 2020, a support structure 2030, and an additional element 2040. The housing 2020 may include a panel 2021, a shell 2022, and a support component 2023. In some embodiments, the shell 2022 may include a back panel 20221 and a housing body 20222 (shown in dashed lines in the FIG. 20). In some embodiments, the housing body 20222 may be a columnar structure that is internally hollow and has open openings at two ends. The panel 2021 and the back panel 20221 may be disposed at the two ends of the housing body 20222 that has the open openings, respectively, and may be rigidly connected through the housing body 20222. In some embodiments, the shell 2022 may also be an integrated structure. For example, the shell 2022 may be a structure that is internally hollow and has an open opening at one end, and the panel 2021 may be located at the end of the shell 2022 with the open opening. In some embodiments, the support component 2023 may be independently disposed outside or inside the shell 2022. In some embodiments, the support component 2023 may be a cartridge structure, and the cartridge structure may be disposed around a sidewall (also referred to as the housing body 20222 or a connecting member) on the shell 2022 adjacent to the panel 2021. In some embodiments, the housing body 20222 may be a columnar structure with openings at two ends, and the columnar structure may be disposed around the housing body 20222. In some embodiments, the support component 2023 may be independently disposed with respect to the shell 2022, the panel 2021 may be rigidly connected to the shell 2022, the additional element 2040 may be rigidly connected to the support component 2023, and the support component 2023 may be connected to the shell 2022 or the panel 2021 through the clastic element 2050, so as to realize that the clastic element 2050 is in the vibration path that the additional element 40 is connected to the panel 2021. The structures of the transducer device 2010 (including the magnetic circuit assembly 2011, the coil 2012, and the vibration transmission sheet 2013A), the support structure 2030, the additional element 2040, etc., in the acoustic output device 2000 may be similar to the structures of the transducer device 10 (including the magnetic circuit assembly 11, the coil 12, and the vibration transmission sheet 13), the support structure 30, and the additional element 40, etc., in the acoustic output device 200, respectively, which are not further described herein.

In some embodiments, the magnetic circuit assembly 2011 may include an aperture portion 20111 and a positioning rod 20112. The aperture portion 20111 may penetrate the magnetic circuit assembly 20111 along a vibration direction of the transducer device 2010 (the first direction shown in FIG. 20). One end of the positioning rod 20112 away from the panel 2021 may be connected to the back panel 20221 of the shell 2022 opposite to the panel 2021, and another end of the positioning rod 20112 may pass through the aperture portion 20111 and be connected to the panel 2021. It should be noted that, the positioning rod 20112 may also play a role in fixing the panel 2021 and the back panel 20221. At this time, the housing body 20222 may not be disposed, or the panel 2021 and the back panel 20221 may not be fixedly connected to the housing body 20222. In some embodiments, the positioning rod 20112 and the housing body 20222 may also be disposed at the same time. More descriptions regarding the aperture portion 20111 and the positioning rod 20112 may be found in the relevant descriptions of the aperture portion 12111 and the positioning rod 12112 illustrated in FIG. 12, which are not repeated herein.

In some embodiments, the clastic element 2050 may include a first elastic element 2051 and a second elastic element 2052. One end of the support component 2023 may be connected to the panel 2021 through the first clastic element 2051, and the other end of the support component 2023 may be connected to a sidewall (or referred to as the back panel 20221) of the shell 2022 opposite to the panel 2021 through the second elastic element. In such a setting, the first elastic element 2051, the second clastic element 2052, the support component 2023, the additional element 2040 attached to the support component 2023, the panel 2021, the shell 2022, and structure(s) (e.g., the coil 2012, the support structure 2030, etc.) rigidly connected to the panel 2021 or the shell 2022 may form a resonance system. It should be noted that when other structures are rigidly connected to the panel 2021 or the shell 2022, the structures are also considered as a portion of the resonance system. The resonance system may generate a resonance peak within a target frequency range. The vibration transmission between the additional element 2040 and the panel 2021 may be suppressed in the frequency range greater than the resonance frequency corresponding to the resonance peak. That is, the influence of the additional element 2040 on the vibration of the panel 2021 is reduced, thereby ensuring that the sensitivity of the acoustic output device 2000 is not or less affected by the additional element 2040 in the frequency range greater than the resonance frequency corresponding to the resonance peak. In some embodiments, by setting the resonance frequency corresponding to the resonance peak at a relatively low frequency position, the frequency range in which the sensitivity of the acoustic output device 2000 is weakened due to the additional element 2040 can be reduced. In addition, in the frequency range greater than the resonance frequency corresponding to the resonance peak, a frequency response curve of the acoustic output device 2000 may be flatter due to the lesser influence of the additional element 2040 on the vibration of the panel 2021, which can ensure that the acoustic output device 2000 has a better acoustic output effect in a wider frequency range, improving the user's listening experience. Furthermore, by disposing the first clastic element 2051, the second clastic element 2052, and the support component 2023, the stable support of the additional element 2040 can be realized, so as to reduce the wobbling of the additional element 2040, thereby avoiding the influence on the sensitivity of the acoustic output device 2000. It should be noted that, in some embodiments, the clastic element 2050 may include only the first elastic element 2051 or the second clastic element 2052.

In some embodiments, the housing body 20222 may include a plate-like structure or a rod-like structure. The two ends of the housing body 20222 may be rigidly connected to the panel 2021 and the back panel 20221, respectively. For example, the housing body 20222 may include two plate-like structures, and two ends of each of the two plate-like structures may be rigidly connected to the panel 2021 and the back panel 20221, respectively.

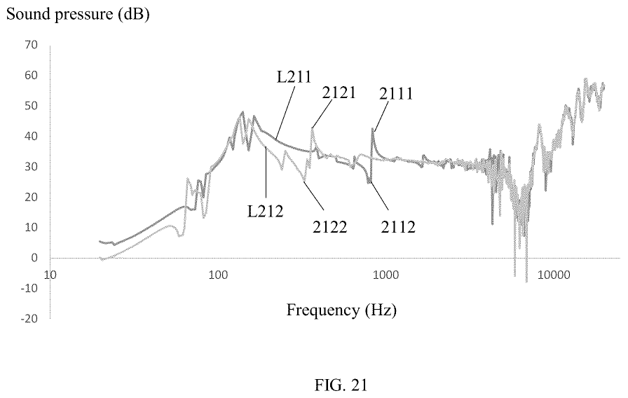

FIG. 21 is a graph of frequency response curves of an acoustic output device according to some embodiments of the present disclosure.

As shown in FIG. 21, the horizontal coordinates represent frequencies (Hz), and the vertical coordinates represent sound pressures (dB) corresponding to an acoustic output device at different frequencies. A curve L211 represents a frequency response curve of the acoustic output device 2000 when the mass of the additional element 2040 of the acoustic output device 2000 is 0 (equivalent to that the acoustic output device 2000 does not include the additional element 2040). The curve L211 has a resonance peak 2111 and a resonance valley 2112 in a frequency range from 200 Hz to 2000 Hz. A curve L212 represents a frequency response curve when the additional element 2040 in the acoustic output device 2000 has a certain mass. The curve L212 has a resonance peak 2121 and a resonance valley 2122 in a frequency range from 200 Hz to 2000 Hz. Combining the curves L211 and L212, it can be seen that, in a frequency range higher than the resonance frequency corresponding to the resonance peak, the acoustic output device 2000 has a relatively flat frequency response curve. At this time, the acoustic output device 2000 can output a better sound quality. In addition, from the resonance frequency corresponding to the resonance peak 2121 being smaller than the resonance frequency corresponding to the resonance peak 2111, it can be seen that the resonance frequency of the acoustic output device is negatively correlated to the mass of the additional element. That is, as the mass of the additional element 2040 increases, the resonance frequency corresponding to the resonance peak of the acoustic output device 2000 may be lower (closer to the low frequency). In some embodiments, by adjusting the mass of the additional element 2040 (e.g., increasing the mass of the additional element 2040), the acoustic output device 2000 can have a flat frequency response curve over a wider frequency range.

In some embodiments, as shown in FIG. 20, each of the first clastic element 2051 and the second elastic element 2052 may be a reed structure. The first clastic element 2051 and the second clastic element 2052 may be disposed on two sides of the transducer device 2010 along its vibrational direction, respectively. A side of the first clastic element 2051 facing the panel 2021 may be connected to the panel 2021, and a circumferential side of the first elastic element 2051 may be connected to one end of the support component 2023. A side of the second elastic element 2051 back away from the transducer device 2010 may be connected to a sidewall (the back panel 20221) of the shell 2022 opposite to the panel 2021. In some embodiments, the support structure 2030 may be rigidly connected to the support component 2023. Alternatively, the support structure 2030 may be rigidly connected to the panel 2021 or the back panel 20221.

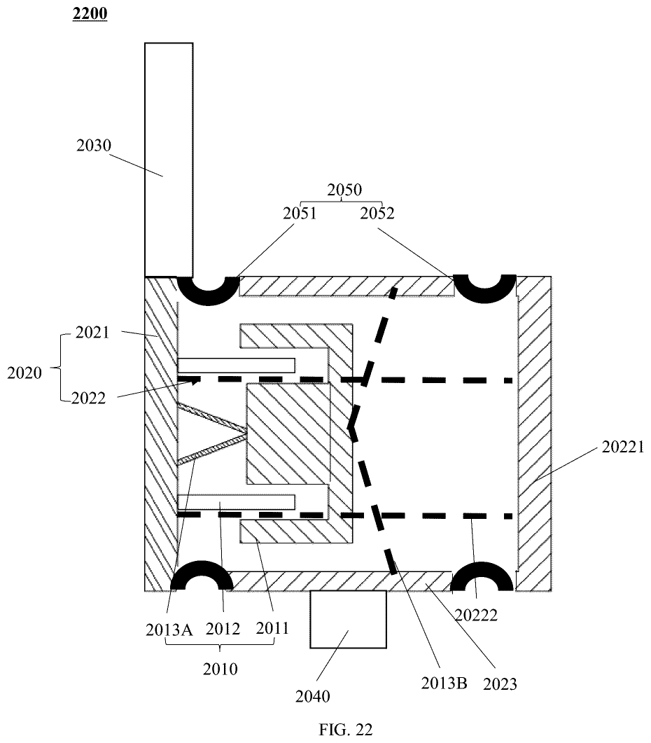

FIG. 22 is a schematic diagram illustrating an exemplary structure of an acoustic output device 2200 according to some embodiments of the present disclosure.

In some embodiments, as shown in FIG. 22, the first elastic element 2051 and the second elastic element 2052 in the acoustic output device 2200 may be ring structures with elasticity. The first clastic element 2051 and the second clastic element 2052 may be disposed at two ends of the support component 2023, respectively. One end of the support component 2023 may be connected to the panel through the first elastic element 2051, and the other end of the support component 2023 may be connected to a sidewall (or the back panel 20221) of the shell 2022 opposite to the panel 2021 through the second elastic element 2052. Merely by way of example, the support component 2023 may be a structure (e.g., a sleeve structure) that is internally hollow and has open openings at two ends. An inner contour of the ring structure may be connected to the circumferential sides of the panel 2021 and the back panel 20221, and an outer contour of the ring structure may be connected to the open openings at the two ends of the support component 2023. In some embodiments, the ring structure may be made of an elastic material such as silicone, polyurethane, etc.

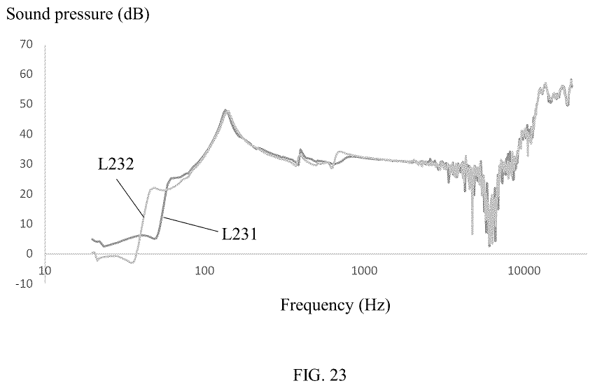

FIG. 23 is a graph of frequency response curves of an acoustic output device according to some embodiments of the present disclosure.

As shown in FIG. 23, the horizontal coordinates represent frequencies (Hz), and the vertical coordinates represent sound pressures (dB) corresponding to an acoustic output device at different frequencies. A curve L231 represents a frequency response curve of the acoustic output device 2200 when the mass of the additional element 2040 of the acoustic output device 2000 is 2 g. A curve L232 represents a frequency response curve of the acoustic output device 2200 when the mass of the additional element 2040 of the acoustic output device 2000 is 3.5 g. Combining the curves L231 and L232, it can be seen that, a portion of the curve L231 in the frequency range of 1000 Hz to 5000 Hz is flatter than a portion of the curve L232 in the frequency range of 1000 Hz to 5000 Hz and basically overlaps with the portion of the curve L232 in the frequency range of 1000 Hz to 5000 Hz. Thus, the sensitivity of the acoustic output device 2200 is not affected by the mass of the additional element 2040 in the frequency range of 1000 Hz to 5000 Hz.

In some embodiments, the first clastic element 2051 and the second clastic element 2052 may also be glue with elasticity. The first elastic element 2051 may adhere one end of the support component 2023 to the panel 2021, and the second clastic element 2052 may adhere the other end of the support component 2023 to the back panel 20221. In some embodiments, the glue may include a gel type, an organic-silicone type, an acrylic type, a polyurethane type, a rubber type, an epoxy type, a hot melt type, a light curing type, or the like, or any combination thereof. Preferably, the adhesive may be an organic-silicone adhering type glue, an organic-silicone type glue.

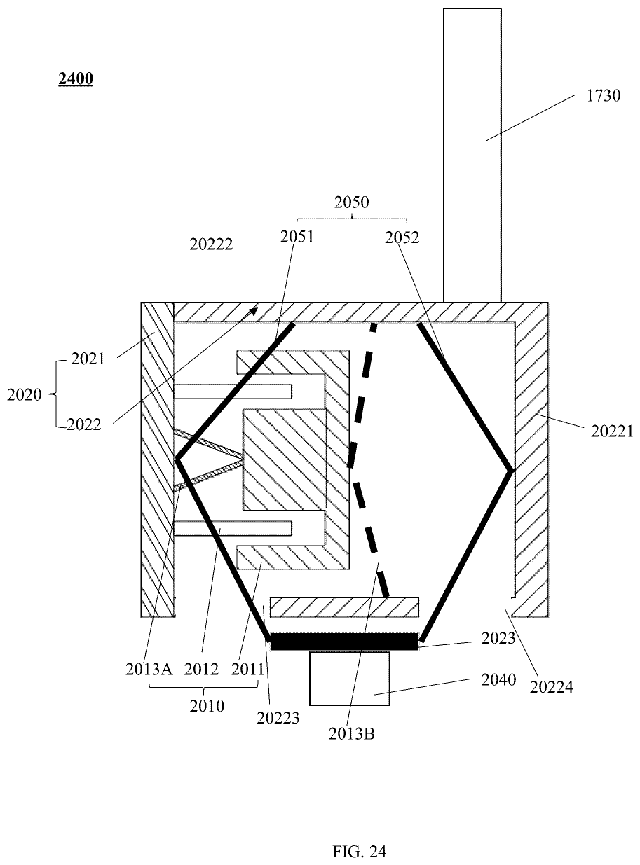

FIG. 24 is a schematic diagram illustrating an exemplary structure of an acoustic output device 2400 according to some embodiments of the present disclosure. As shown in FIG. 24, in some embodiments, the support component 2023 in the acoustic output device 2400 may be a plate-like structure, and the plate-like structure may be independently arranged with respect to the shell 2022. The additional element 2040 may be rigidly connected to the plate-like structure. One end of the plate-like structure may be connected to the panel 2021 through the first elastic element 2051, and the other end of the plate-like structure may be connected to the sidewall (the backplate 20221) of the shell 2022 opposite to the panel 2021 through the second clastic element 2052. In some embodiments, as shown in FIG. 24, the first clastic element 2051 and the second elastic element 2052 in the acoustic output device 2400 may be reed structures. Merely by way of example, when the support component 2023 is independently disposed outside the shell 2022, a sidewall in the housing body 20222 facing the support component 2023 may be opened with a first gap 20223 and a second gap 20224 for the reed structures to pass through. A side of the first clastic element 2051 near the panel 2021 may be connected to the panel 2021, a circumferential side of the first elastic element 2051 located inside the shell 2022 may be connected to another sidewall of the housing body 20222, and the remaining circumferential sides of the first clastic element 2051 may pass through the first gap 20223 to be connected to one end of the support component 2023. A side of the second clastic element 2052 back away from the transducer device 2010 may be connected to the back panel 20221, a circumferential side of the second elastic element 2052 located inside the shell 2022 may be connected to another sidewall of the housing body 20222, and the remaining circumferential sides of the second elastic element 2051 may pass through the second gap 20224 to be connected to the other end of the support component 2023. In some embodiments, when the support component 2023 is independently disposed inside the shell 2022, the sidewall of the housing body 20222 facing the 2023 does not need to open the first gap 20223 and the second gap 20223 for the reed structures to pass through. In other embodiments, a gap for arranging the support component 2023 may be disposed on the housing body 20222. The support component 2023 may be elastically connected to the shell 2022 or the panel 2021 through the first elastic element 2051 and second clastic element 2052, or may be connected to the housing body 20222 through the elastic element or glue. For example, the clastic element (e.g., a reed, a ring structure with elasticity) is disposed on the circumferential side of the support component 2023, and the support component 2023 is elastically connected to the housing body 20222 through the clastic element. As another example, the circumferential side of the support component 2023 may be adhered to the housing body 20222 through the glue, and the solidified glue may act as the elastic element.

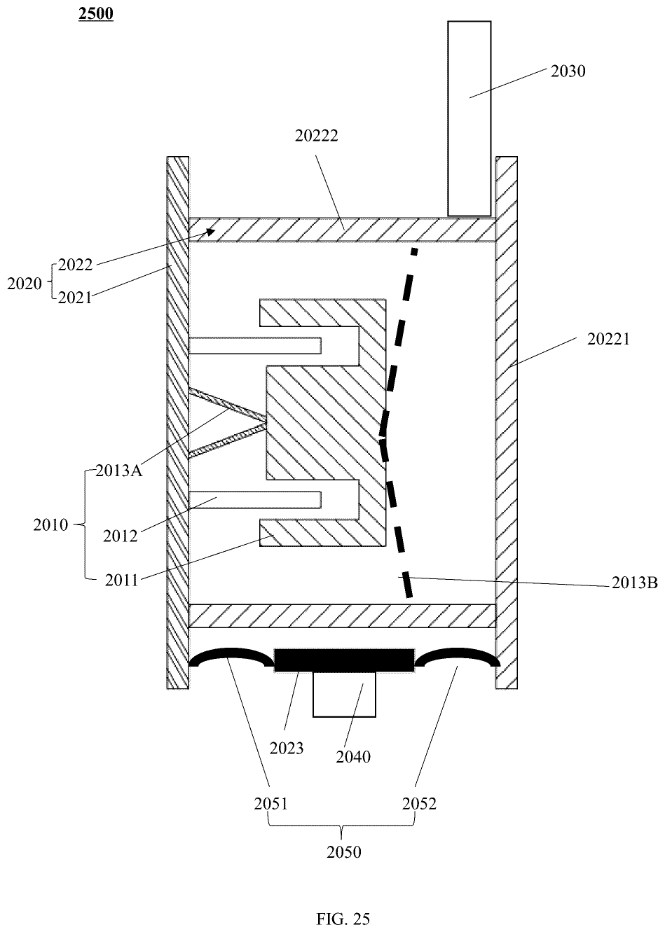

FIG. 25 is a schematic diagram illustrating an exemplary structure of an acoustic output device 2500 according to some embodiments of the present disclosure.

As shown in FIG. 25, in some embodiments, the support component 2023 in the acoustic output device 2500 may be a plate-like structure. The first elastic element 2051 and the second clastic element 2052 may be a spring, a reed, a membrane structure, etc., with elasticity. Merely by way of example, the first clastic element 2051 and the second elastic element 2052 are disposed at two ends of the plate-like structure, respectively. One end of the plate-like structure may be connected to the panel 2021 through the first clastic element 2051, and the other end of the plate-like structure may be connected to the back panel 20221 through the second elastic element 2051. In other embodiments, a gap for arranging the support component 2023 may be disposed on the housing body 20222. The support component 2023 may be elastically connected to the shell 2022 or the panel 2021 through the first clastic element 2051 and second elastic element 2052, or may be connected to the housing body 20222 through the elastic element or glue. For example, the clastic element (e.g., a reed, a ring structure with elasticity) is disposed on the circumferential side of the support component 2023, and the support component 2023 is elastically connected to the housing body 20222 through the elastic element. As another example, the circumferential side of the support component 2023 may be adhered to the housing body 20222 through the glue, and the solidified glue may act as the clastic element.

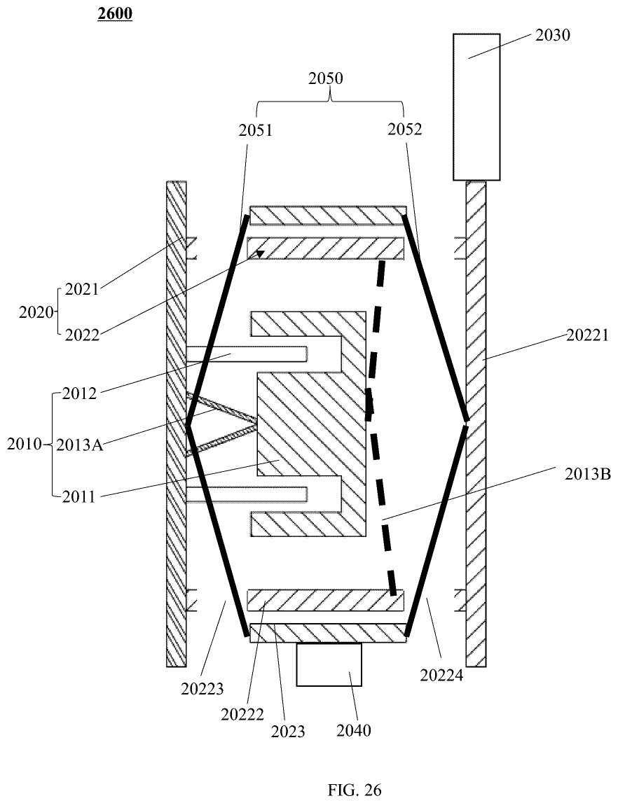

FIG. 26 is a schematic diagram illustrating an exemplary structure of an acoustic output device according to some embodiments of the present disclosure. As shown in FIG. 26, in some embodiments, the support component 2023 in the acoustic output device 2600 may be a cartridge structure, and the cartridge structure may be sleeved to the exterior of the housing body 20222. The additional element 2040 may be rigidly connected to the cartridge structure. One end of the cartridge structure may be connected to the panel 2021 through the first clastic element 2051, and the other end of the cartridge structure may be connected to the back panel 20221 through the second elastic element 2052. In some embodiments, as shown in FIG. 26, the first clastic element 2051 and the second clastic element 2052 in the acoustic output device 2600 may be reed structures. Merely by way of example, when the cartridge structure is sleeved on the exterior of the housing body 20222, the housing body 20222 may be opened with a first gap 20223 and a second gap 20224 for the reed structures to pass through. A side of the first clastic element 2051 near the panel 2021 may be connected to the panel 2021, and a circumferential side of the first clastic element 2051 may pass through the first gap 20223 to be connected to the 2023. A side of the second elastic element 2052 back away from the transducer device 2010 may be connected to the back panel 20221, and a circumferential side of the second clastic element 2052 may pass through the second gap 20224 to be connected to the other end of the support component 2023. In some embodiments, when the cartridge structure is located inside the shell 2022, the housing body 20222 does not need to open the first gap 20223 and the second gap 20224 for the reed structures to pass through.

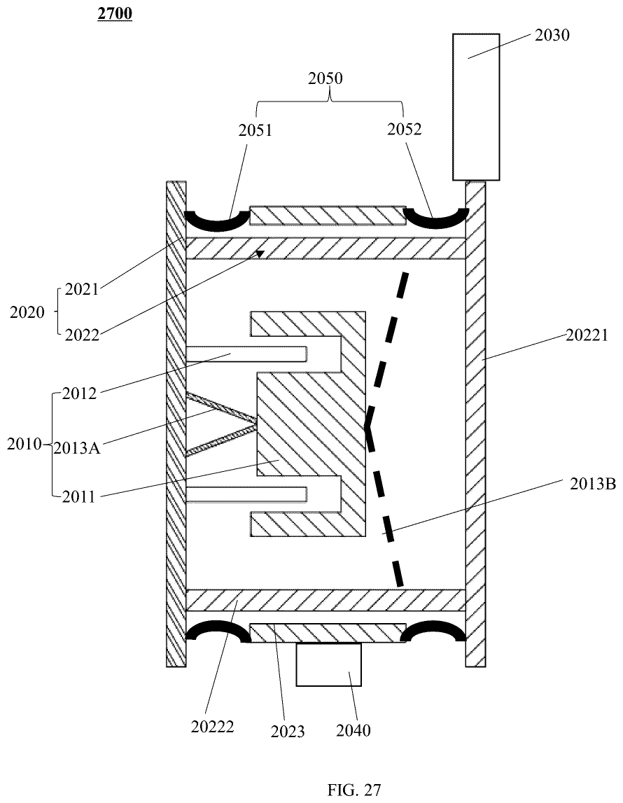

FIG. 27 is a schematic diagram illustrating an exemplary structure of an acoustic output device according to some embodiments of the present disclosure. As shown in FIG. 27, in some embodiments, the 2023 in the acoustic output device 2700 may be a cartridge structure, and the first elastic element 2051 and the second clastic element 2052 may be ring structures with elasticity. Merely by way of example, the first clastic element 2051 and the second clastic element 2052 may be disposed at two ends of the cartridge structure, respectively. An inner contour of the first elastic element 2051 may be connected to a circumferential side of the panel 2021, and an outer contour of the first elastic element 2051 may be connected to one end of the cartridge structure. An inner contour of the second clastic element 2052 may be connected to the circumferential side of the back panel 20221, and an outer contour of the second clastic element 2052 may be connected to the other end of the cartridge structure.

In some embodiments, a vibration transmission layer may be covered on the panel 2021 or a sidewall of the exterior of the shell 2022 in the acoustic output device 2700. The vibration transmission layer may be configured to contact with a user's skin. That is, the panel 2021 or the sidewall of the exterior of the shell may be in contact with the user's skin through the vibration transmission layer. In some embodiments, the Shore hardness of the vibration transmission layer may be less than the Shore hardness of the panel 2021 or the sidewall of the exterior of the shell 2022. That is, the vibration transmission layer may be softer than the panel 2021 or the sidewall of the exterior of the shell 2022. In some embodiments, the vibration transmission layer is made of a soft material, such as silicone, and the panel 2021 or the sidewall of the exterior of the shell 2022 is made of a hard material, such as a polycarbonate, a fiberglass reinforced plastic, etc. Therefore, the wearing comfort of the acoustic output device 2700 can be improved, and the acoustic output device 2700 can be fit more closely to the user's skin, thereby improving the sound quality of the acoustic output device 2700. In some embodiments, the vibration transmission layer may be detachably connected to the panel 2021 or the sidewall of the exterior of the shell 2022 to allow for easy replacement by the user. It should be noted that, covering the vibration transmission layer on the panel or the sidewall of the exterior of the shell may be applicable not only to the acoustic output device 2700, but also to the acoustic output devices in other embodiments of the present disclosure, such as the acoustic output device 400 shown in FIG. 4, the acoustic output device 700 shown in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

In the acoustic output devices 2000, 2200, 2400, 2500, 2600, and 2700, the magnetic circuit assembly 2011 and the panel 2021 may be connected through the vibration transmission sheet 2013A, which causes the problem that the magnetic circuit assembly 2011 and the additional element 2040 may attract or repel to each other to cause the deformation or inversion of the magnetic circuit assembly 2011, thereby affecting the vibration stability of the transducer device 2010. In order to avoid the magnetic circuit assembly 2011 and the additional element 2040 from being attracting or repelling to each other to cause the deformation or inversion of the magnetic circuit assembly 2011 and affecting the vibration stability of the transducer device 2010, in some embodiments, the vibration transmission sheet 2013A between the magnetic circuit assembly 2011 and the panel 2021 may be replaced with the vibration transmission sheet 2013B (indicated by dashed lines in FIGS. 20, 22, 24, 25, 26, and 27). Alternatively, in some embodiments of the present disclosure, each of the acoustic output devices 2000, 2200, 2400, 2500, 2600, and 2700 may include both the vibration transmission sheet 2013A and the vibration transmission sheet 2013B. By supporting the magnetic circuit assembly 2011 through the vibration transmission sheet 2013A and the vibration transmission sheet 2013B, the vibration stability of the transducer device 2010 can be improved. In some embodiments, the vibration transducer 2013A and the vibration transmission sheet 2013B may include a center region and a plurality of support rods. The plurality of support rods may be disposed at intervals along a circumferential side of the center region. The center region may be connected to a side of the magnetic circuit assembly away from the panel, and an end of each support rod away from the center region may be connected to the shell. Merely by way of example, the count of the support rods may be four. At this time, the structure of the vibration transmission sheet 2013A and the vibration transmission sheet 2013B may be approximately regarded as an “X”-shaped structure. The “X”-shaped structure may provide elasticity in the vibration direction of the transducer device. In addition, the plurality of support rods may have high structural strengths in the vibration direction of the transducer device, which can provide a good support effect on the magnetic circuit assembly to avoid the deformation or inversion of the transducer device during the vibration. In some embodiments, the vibration transmission sheet may further include an edge region. The edge region may be connected to an end of each support rod away from the center region, and a circumferential side of the edge region may be connected to the shell. More descriptions regarding the structure of the vibration transmission sheet may be found elsewhere in the present disclosure (e.g., FIGS. 46 and 47, and relevant descriptions thereof).

Merely by way of example, as shown in FIGS. 24 and 25, the support component 2023 may be a plate-like structure, the vibration transmission sheet 2013B may be disposed between the magnetic circuit assembly 2011 and the sidewall (i.e., the back panel 20221) of the shell 2022 opposite to the panel 2021. One side of the vibration transmission sheet 2013B may be connected to the side of the magnetic circuit assembly 2011 back away from the panel 2021, and the circumferential side of the vibration transmission sheet 2013B may be connected to the housing body 20222. As shown in FIGS. 26 and 27, when the support component 2032 is a cartridge structure, one side of the vibration transmission sheet 2013B may be connected to the side of the magnetic circuit assembly 2011 back away from the panel 2021, and the circumferential side of the vibration transmission sheet 2013B may be connected to the housing body 20222. By locating the vibration transmission sheet 2013B between the magnetic circuit assembly 2011 and the sidewall of the shell 2022 opposite to the panel 2021, and connecting the vibration transmission sheet 2013B to the sidewall disposed with the additional element, the vibration transmission sheet 2013B can provide support in a relative movement direction between the magnetic circuit assembly 2011 and the additional element 2040. Therefore, the vibration transmission sheet 2013B can enhance the support effect of the magnetic circuit assembly 2011 on a position near the additional element 2040, and improve the vibration stability of the transducer device 2010 (especially the magnetic circuit assembly 2011). In order to further improve the vibration stability of the transducer device 2010, the acoustic output devices 2000, 2200, 2400, 2500, 2600, and 2700 may include the vibration transmission sheet 2013A and the vibration transmission sheet 2013B.

It should be noted that the two ends of the support component 2023 shown in FIG. 20 and FIG. 22 may also be rigidly connected to the panel 2021 and the back panel 20221, respectively. The additional element 2040 may be adhered to the support component 2023 via glue, and the solidified glue may have a certain elasticity and may serve the same function as the elastic element 2050. In some embodiments, the glue may include a gel type, an organic-silicone type, an acrylic type, a polyurethane type, a rubber type, an epoxy type, a hot melt type, a light curing type, or the like, or any combination thereof. Preferably, the adhesive may be an organic-silicone adhering type glue, an organic-silicone type glue.

In the acoustic output device according to the embodiments of the present disclosure, the additional element can be connected to the panel by the vibration path including at least one elastic element, which can solve the problem that the sensitivity of the bone conduction acoustic output device is weakened due to the additional installation of the additional element on the bone conduction loudspeaker. However, when the additional element disposed on the basis of the bone conduction loudspeaker is an air-conduction loudspeaker, the sound leakage of the acoustic output device can be increased. Specifically, when the additional element is an air-conduction loudspeaker, the mechanical vibration generated by the transducer device drives a diaphragm inside the air-conduction loudspeaker to vibrate. Thus, the sound leakage generated by the acoustic output device is not only from the air vibration outside of the acoustic output device driven by the shell, but also from the vibration of the diaphragm in the air-conduction loudspeaker generated by the vibration of the transducer device, which increases the overall sound leakage of the loudspeaker, thereby reducing the user's listening experience. The influence of the sound leakage of the acoustic output device 200 when the additional element 40 is the air-conduction loudspeaker may be described in detail below in combination with the sound leakage frequency response curves of the bone conduction acoustic output device 100 and the acoustic output device 200 when the additional element 40 is the air-conduction loudspeaker.

FIG. 28 is a graph of sound leakage frequency response curves of acoustic output devices according to some embodiments of the present disclosure. As shown in FIG. 28, the horizontal coordinates represent frequencies (Hz), and the vertical coordinates represent sound pressures (dB) of sound leakage corresponding to acoustic output devices at different frequencies. A curve L281 represents a sound leakage frequency response curve of the acoustic output device 100 measured at a sidewall of the shell 22 of the acoustic output device 100 adjacent to the panel 21. A curve L282 represents a sound leakage frequency response curve of the bone conduction acoustic output device 200 measured at the sidewall of the shell 22 of the bone conduction acoustic output device 200 adjacent to the panel 21 when the additional element 40 is the air-conduction loudspeaker and the vibration direction of the diaphragm of the air-conduction is parallel to the vibration direction of the transducer device 10. The curve L283 represents a sound leakage frequency response curve of the bone conduction acoustic output device 200 measured at the sidewall of the shell 22 of the bone conduction acoustic output device 200 adjacent to the panel 21 when the additional element 40 is the air-conduction loudspeaker and the vibration direction of the diaphragm of the air-conduction is approximately perpendicular to the vibration direction of the transducer device 10. The sound leakage frequency response curves of the acoustic output device 100 and the acoustic output device 200 may be measured by detecting the air-conduction sound at the sidewall of the shell 22 adjacent to the panel 21, which also applies to the acquisition of leakage frequency response curves of other loudspeakers in the embodiments of the present disclosure. Combining the curves L281 and L282, it can be seen that when the vibration direction of the diaphragm in the air-conduction loudspeaker is parallel to the vibration direction of the transducer device 10, the leakage sound pressure of the loudspeaker 200 is overall higher than that of the bone conduction loudspeaker 100 in a medium-high frequency band (5000 Hz to 10000 Hz). It can be seen that when the air-conduction loudspeaker is disposed on the basis of the bone conduction loudspeaker, if the vibration direction of the diaphragm in the air-conduction loudspeaker is parallel to the vibration direction of the transducer device, the sound leakage of the acoustic output device may be increased. Combining the curve L281, the curve L282, and the curve L283, it can be seen that when the vibration direction of the diaphragm of the air-conduction loudspeaker is approximately perpendicular to the vibration direction of the transducer device 10, the sound pressure of the sound leakage of the acoustic output device 200 is lower than or equal to the sound pressure of the sound leakage of the bone conduction acoustic output device 100 in the medium-high frequency band (500 Hz, to 10000 Hz). It can be seen that when the air-conduction loudspeaker is disposed on the basis of the bone conduction loudspeaker, if the vibration direction of the vibration direction of the diaphragm of the air-conduction loudspeaker is approximately perpendicular to the vibration direction of the transducer device, the sound leakage of the acoustic output device can be reduced.

Based on the above problem that disposing the air-conduction loudspeaker on the bone conduction loudspeaker increases the sound leakage of the acoustic output device, some embodiments of the present disclosure provide an acoustic output device. A vibration direction of a transducer device in the acoustic output device may be approximately perpendicular to a vibration direction of a diaphragm of an air-conduction loudspeaker. The approximately perpendicular can be understood as that an included angle between the vibration direction of the diaphragm and the vibration direction of the transducer device is within a range of 75 degrees to 100 degrees, which effectively reduces the sound leakage of the acoustic output device and ensures that the user can have a better listening experience. A detailed description will be performed in combination with the acoustic output device 400 shown in FIG. 4.

As shown in FIG. 4, the additional element in the acoustic output device 400 may be an air-conduction loudspeaker, and the air-conduction loudspeaker may include the diaphragm 441. The diaphragm 441 may vibrate under the driven of the transducer device in the air-conduction loudspeaker to drive the air to vibrate, so that the user can hear air-conduction sound. The second direction shown in FIG. 4 represents the vibration direction of the transducer device 410, and the first direction may represents the vibration direction of the diaphragm 441. In order to ensure that the air-conduction loudspeaker does not increase the sound leakage of the acoustic output device 400, in some embodiments, an included angle between the first direction and the second direction may be within a range of 75 degrees to 100 degrees. For example, the included angle between the first direction with the second direction may be within a range of 80 degrees to 95 degrees. As another example, the included angle between the first direction and the second direction may be 90 degrees.

As shown in FIG. 4, in some embodiments, the air-conduction loudspeaker may be disposed on a sidewall (also referred to as the housing body) of the shell 422 adjacent to the panel 421.

FIG. 29 is a schematic diagram illustrating an exemplary structure of an acoustic output device 2900 according to some embodiments of the present disclosure. As shown in FIG. 29, in some embodiments, an air-conduction loudspeaker in the acoustic output device 2900 may also be disposed at a sidewall (also referred to as a back panel) of the shell 422 opposite to the panel.

It should be noted that when the additional element is the air-conduction loudspeaker, reducing the sound leakage of the acoustic output device by forming the included angle between the vibration direction of the diaphragm of the air-conduction loudspeaker and the vibration direction of the transducer device may be applied not only to the acoustic output device 400, but also to other acoustic output devices according to the embodiments of the present disclosure, such as the acoustic output device 700 shown in FIG. 7, the acoustic output device 900 shown in FIG. 9, the acoustic output device 1200 shown in FIG. 12, the acoustic output device 1300 shown in FIG. 13, and the acoustic output device 1500 shown in FIG. 15, etc. In addition, when the additional element includes component(s) that are sensitive to a certain vibration direction, such as a vibration sensor, an inertial acceleration sensor, a microphone, etc., the vibration direction to which the component(s) are sensitive may be disposed to have a certain included angle (e.g., within a range of 75 degrees to 100 degrees) with the vibration direction of the transducer device, so as to prevent the operation of the component(s) from being affected by the vibration of the transducer device in the acoustic output device. In addition, in some embodiments, the additional element may include other components or structures that are not sensitive to the vibration direction, such as a circuit board, a battery, etc., which can be disposed at any location on the shell.

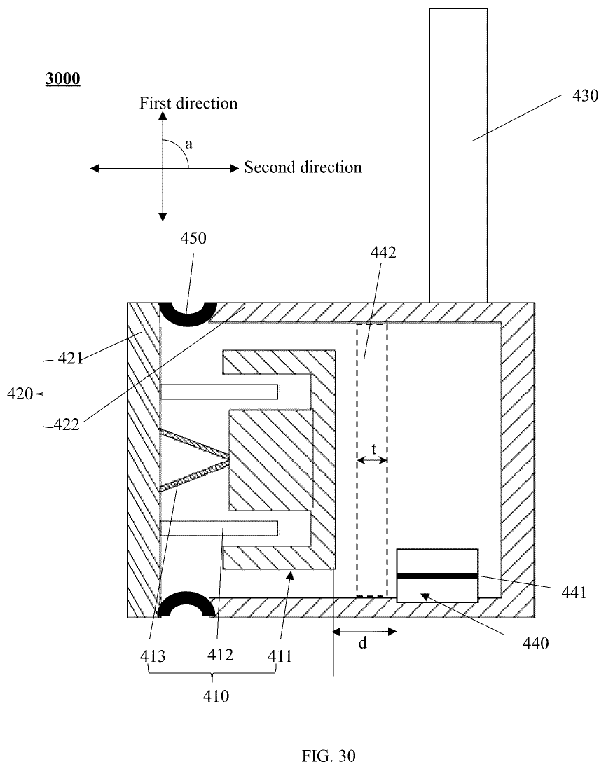

FIG. 30 is a schematic diagram illustrating an exemplary structure of an acoustic output device 3000 according to some embodiments of the present disclosure. In order to reduce the overall volume of the acoustic output device 3000, the additional element may be disposed in the interior of the shell 422, as shown in FIG. 30. When the additional element is disposed in the interior of the shell 422, the additional element may be rigidly connected to an inner side of a sidewall of the shell 422 that is adjacent or opposite to the panel 421. In some embodiments, when the additional element is an air-conduction loudspeaker, the shell 422 may be disposed with sound-conduction holes (not shown in the FIG. 30), and the sound-conduction holes may output sound generated by the air-conduction loudspeaker to the external environment.

The magnetic circuit assembly of the transducer device 410 may include a magnet. When the additional element is a component (e.g., an air-conduction loudspeaker, an air-conduction microphone, ctc.) that is sensitive to the vibration direction, and the air-conduction loudspeaker is disposed in the shell 422 and is close to the transducer device, the air-conduction loudspeaker and the magnetic field of the transducer device 410 may interfere with each other. Taking the air-conduction loudspeaker as an example for illustration, as shown in FIG. 30, in some embodiments, there is a spacing d between the air-conduction loudspeaker and the transducer device 410 along the vibration direction of the diagram 441 in the air-conduction loudspeaker. In some embodiments, the larger the spacing d is, the less the interfere between the air-conduction loudspeaker and the magnetic field of the transducer device 410 may be. In some embodiments, the spacing d may not be less than 0.8 millimeters (mm). In some embodiments, the spacing d may not be less than 1 mm. In some embodiments, the spacing d may not be less than 1.2 mm.

In order to avoid the problem that the air-conduction loudspeaker and the magnetic field of the transducer device 410 interfere with each other, in some embodiments, a dividing member 442 may be disposed between the air-conduction loudspeaker and the transducer device 410, and the air-conduction loudspeaker and the transducer device 410 may be disposed on two sides of the dividing member 442, respectively. In some embodiments, the dividing member 442 may be a plate-like structure. The greater a thickness t of the dividing member 442 is, the less the interfere between the air-conduction loudspeaker and the magnetic field of the transducer device 410 may be. In some embodiments, the thickness t of the dividing member 442 may not be less than 0.8 mm. In some embodiments, the thickness t of the dividing member 442 may not be less than 1 mm. In some embodiments, the thickness t of the dividing member 442 may not be less than 1.2 mm. In some embodiments, in order to further reduce the overall volume of the acoustic output device 3000, other components (e.g., a battery, a circuit board, etc.) in the acoustic output device 3000 may also be configured as the dividing member 442 between the transducer device 410 and the air-conduction loudspeaker.

It should be noted that the air-conduction loudspeaker is located inside the shell, and the spacing between the air-conduction loudspeaker and the transducer device in the vibration direction of the diaphragm and/or the provision of the dividing member between the air-conduction loudspeaker and the transducer device are also applicable to the acoustic output devices in other embodiments of the present disclosure, such as the acoustic output device 700 shown in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

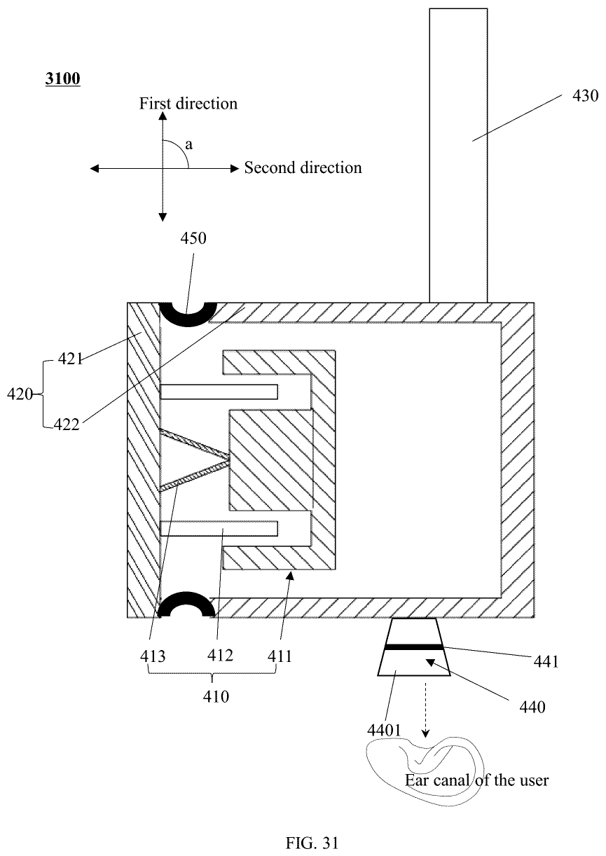

FIG. 31 is a schematic diagram illustrating an exemplary structure of an acoustic output device 3100 according to some embodiments of the present disclosure. As shown in FIG. 31, when a user wears the acoustic output device 3100, a sound outlet 4401 of an air-conduction loudspeaker may orient toward the car canal of the user. In this way, air-conduction sound output from the air-conduction loudspeaker can be directly transmitted into the car canal of the user to ensure that the sound output from the air-conduction loudspeaker has sufficient volume to be heard by the user.

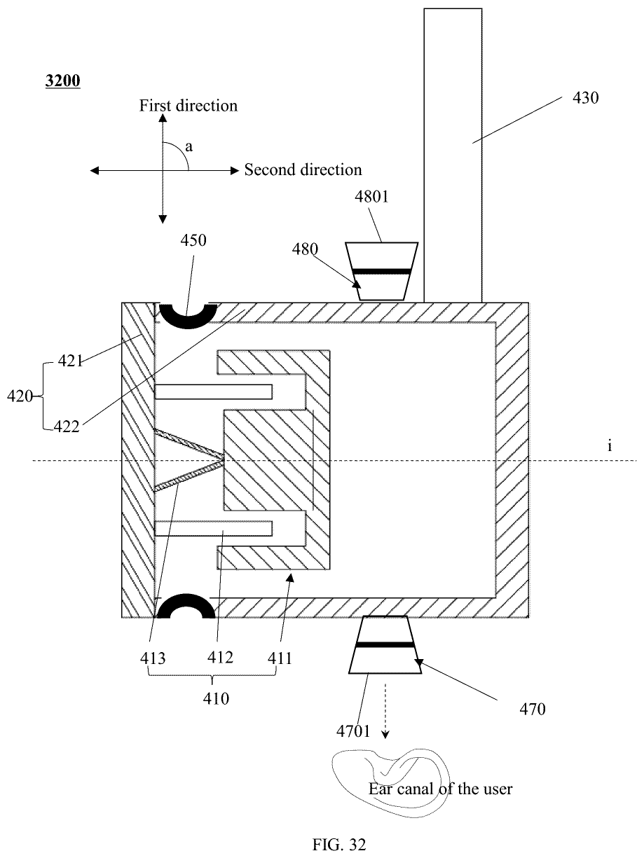

FIG. 32 is a schematic diagram illustrating an exemplary structure of an acoustic output device 3200 according to some embodiments of the present disclosure. As shown in FIG. 32, in the acoustic output device 3200, an air-conduction loudspeaker may include a first air-conduction loudspeaker 470 and a second air-conduction loudspeaker 480. The first air-conduction loudspeaker 470 and the second air-conduction may be distributed on two sides of the shell 422, respectively. The first air-conduction loudspeaker 470 and the second air-conduction loudspeaker 480 may be disposed approximately symmetrically about a symmetry axis i of the transducer device 410, which avoids causing the acoustic output device 3200 to wobble due to the asymmetry of the additional mass, thereby affecting the sound quality of the acoustic output device 3200. In some embodiments, when a user wears the acoustic output device 3200, a sound outlet 4701 of the first air-conduction loudspeaker 470 may directly orient toward the car canal of the user, and a sound outlet 4801 of the second air-conduction loudspeaker 480 may be back away from the car canal of the user. In this way, air-conduction sound output from the first air-conduction loudspeaker 470 can be directly transmitted to the car canal of the user, avoiding sound output from the second air-conduction loudspeaker 480 from interfering with the air-conduction sound output from the first air-conduction loudspeaker 470, thereby enabling the sound output from the first air-conduction loudspeaker 470 to have a sufficient volume to be heard by the user. In some embodiments, a phase of sound waves output from the first air-conduction loudspeaker 470 and a phase of sound waves output from the second air-conduction loudspeaker 480 may satisfy a particular condition (e.g., opposite or nearly opposite phases). The sound waves output from the sound outlet 4701 of the first air-conduction loudspeaker 470 and the sound waves output from the sound outlet 4801 of the second air-conduction loudspeaker 480 may be approximately considered as two point sound sources. The sound waves output from the second air-conduction loudspeaker 480 may counteract the sound waves output from the first air-conduction loudspeaker 470 at a location away from the opening of the human car canal, reducing the volume of sound leakage from the acoustic output device 3200 in a far field. In some embodiments, the second air-conduction loudspeaker 480 may be replaced with other additional elements, such as a battery, a circuit board, a transducer, etc. The other additional elements and the first air-conduction loudspeaker 470 may be approximately symmetrical about the symmetry axis of the transducer device 410.

It should be noted that the air-conduction loudspeaker including the first air-conduction loudspeaker 470 and the second air-conduction loudspeaker 480 are also applicable to the acoustic output devices in other embodiments of the present disclosure, for example, the acoustic output device 700 illustrated in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

In combination with FIG. 5, it is shown that the acoustic output device 400 may have a flat frequency response curve in the medium-high frequency band (in a frequency range higher than the resonance frequency corresponding to the resonance peak). That is, the bone conduction sound output by the acoustic output device 400 at the medium-high frequency can have a good sound quality. Thus, in order to ensure that the acoustic output device 400 can have a better acoustic output effect in the full frequency range, the additional element in the acoustic output device 400 may be an air-conduction acoustic output device, and the low frequency sound may be output by the air-conduction loudspeaker. Furthermore, the acoustic output device 400 may also include a frequency division module, and the frequency division module may generate a medium-high frequency signal and a low frequency signal by performing frequency division on an initial electrical signal based on a frequency division point. An electrical signal that is less than a frequency corresponding to the frequency division point may be determined as the low frequency signal, and an electrical signal that is higher than the frequency corresponding to the frequency division point may be determined as the medium-high frequency signal. In some embodiments, the frequency division point may be within a range of 200 Hz to 800 Hz. For example, the frequency division point may be within a range of 200 Hz to 700 Hz. As another example, the frequency division point may be within a range of 200 Hz, to 600 Hz. As yet another example, the frequency division point may be within a range of 300 Hz to 500 Hz. The transducer device 410 in the acoustic output device 400 may output bone conduction sound based on the medium-high frequency signal. The air-conduction loudspeaker may output air-conduction sound based on the low frequency signal. Further, the transducer device 410 may generate a medium-high frequency vibration based on the electrical signal to drive the panel 421 to vibrate at the medium-high frequency, and the panel 421 may transmit the medium-high frequency vibration to the auditory nerves of the user through a bone conduction path by fitting with the user, so that the user can hear the bone conduction sound of the medium-high frequency. The transducer device in the air-conduction loudspeaker may drive the diaphragm 441 to vibrate based on the low frequency signal, and the diaphragm 441 may drive the air to vibrate, so that the user can hear the air-conduction sound of the low frequency. The air-conduction sound of the low frequency and the bone conduction sound of the medium-high frequency can enable the acoustic output device 400 to have the better acoustic output in the full frequency range. In some embodiments, a frequency corresponding to the frequency division point may not be less than a maximum value within a target frequency range. In some embodiments, the frequency corresponding to the frequency division point may not be less than a resonance frequency corresponding to a resonance peak within the target frequency range. When the frequency division point is greater than the resonance frequency, the effect of the additional element (the air-conduction loudspeaker) on the sensitivity of the bone conduction loudspeaker is relatively small, which can cause the bone conduction loudspeaker to have a better acoustic output effect in the medium-high frequency band. Meanwhile, the air-conduction loudspeaker may output the air-conduction sound based on the low frequency signal to compensate for the poor output effect of the bone conduction loudspeaker at the low frequency. In some embodiments, in order to enable the bone conduction loudspeaker to have relatively strong sensitivity in the sound production frequency band, a difference between the frequency division point and the resonance frequency may not be less than 100 Hz. For example, the difference between the frequency division point and the resonance frequency may not be less than 200 Hz. In some embodiments, the sound output by the bone conduction loudspeaker and the air-conduction loudspeaker may also have overlapping parts in a frequency domain, and the frequency domain of the overlapping parts may cover the resonance frequency corresponding to the resonance peak within the target frequency range. At this time, although the introduction of the additional element weakens the sensitivity of the bone conduction loudspeaker near the resonance frequency, the air-conduction sound output by the air-conduction acoustic output device near the resonance frequency can compensate for the weak sensitivity of the bone conduction loudspeaker. With the combination of the bone conduction sound and the air-conduction sound, the user can still distinctly hear the sound near the resonance frequency.

It should be noted that the frequency division module is also applicable to the acoustic output devices in other embodiments of the present disclosure, for example, the acoustic output device 700 shown in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

In response to the problem that by disposing an additional element on the basis of the bone conduction loudspeaker, the sensitivity of the acoustic output device is weakened, and the magnetic circuit assembly and the additional element can attract or repel to each other to cause the deformation or inversion of the magnetic circuit assembly, thereby affecting the vibration stability of the transducer device, the embodiments of the present disclosure also provide an acoustic output device. In some embodiments, the acoustic output device may include a transducer device, a housing, and an additional element. The transducer device may generate mechanical vibrations based on an electrical signal. The transducer device includes a magnetic circuit assembly, a coil, and a vibration transmission sheet. The housing may be configured to accommodate the transducer device. The housing may include a panel and a shell, and the transducer device may transmit the mechanical vibrations to a user through the panel. In the acoustic output device according to the embodiments of the present disclosure, the vibration transmission sheet has elasticity, the magnetic circuit assembly is elastically connected to the housing through the vibration transmission sheet, and the additional element is connected to the magnetic circuit assembly to remain elastically connected to the panel. For example, the magnetic circuit assembly may be elastically connected to the panel through the vibration transmission sheet, such that the additional element is connected to the magnetic circuit assembly to remain elastically connected to the panel. As another example, the magnetic circuit assembly may be connected to a sidewall (or a back panel) of the shell opposite to the panel through the vibration transmission sheet. As yet another example, there may be a plurality of vibration transmission sheets, and the plurality of vibration transmission sheets may include a first vibration transmission sheet and a second vibration transmission sheet. The magnetic circuit assembly may be connected to the panel and the back panel through the first vibration transmission sheet and the second vibration transmission sheet, respectively, such that the additional element can be elastically connected to the panel when connected to the magnetic circuit assembly. The additional element may be directly or indirectly connected to the magnetic circuit assembly. For example, the additional element may be directly rigidly connected to the magnetic circuit assembly. As another example, both the additional element and the magnetic circuit assembly may be rigidly connected to the shell. As yet another example, the acoustic output device may further include a support component, the additional element may be rigidly connected to the support component, and the support component may be rigidly connected to the magnetic circuit assembly. In the acoustic output device according to the embodiments of the present disclosure, by connecting the additional element to the magnetic circuit assembly, the additional element and the magnetic circuit assembly can prevent being attracted or repelled to each other to cause the deformation or inversion of the magnetic circuit assembly, and affecting the vibration stability of the transducer device. In the acoustic output device according to the embodiments of the present disclosure, the additional element and the magnetic circuit assembly may vibrate with respect to the panel to generate a resonance peak located within a target frequency, which can ensure that the sensitivity of the acoustic output device is not affected by the additional element in a frequency range greater than the resonance frequency, and the sensitivity of the acoustic output device including the additional element is not affected by the additional element in the frequency range greater than the resonance frequency. Therefore, the problem of a weak in the sensitivity of the bone conduction acoustic output device due to the additional element disposed on the bone conduction loudspeaker can be avoided. In addition, the acoustic output device according to the embodiments of the present disclosure has a flatter frequency response curve of the acoustic output device in the frequency range that is larger than the resonance frequency corresponding to the resonant peak, which ensures that the acoustic output device has a better good acoustic output effect, improving the user's listening experience. Further, when the transducer device generates a low frequency (lower than the frequency range of the resonance frequency corresponding to the resonance peak) mechanical vibration, the low frequency (lower than the frequency range of the resonance frequency corresponding to the resonance peak) vibration of the panel can be transmitted to the additional element to drive the additional element to vibrate with the vibration of the panel. A mass of the additional element can increase a loading mass of the vibration of the transducer device, which causes the sensitivity of the acoustic output device to be affected by the additional element in the frequency range lower than the frequency range of the resonance frequency corresponding to the resonance peak (similar to the acoustic output device 200). When the transducer device generates a high frequency (higher than the resonance frequency range corresponding to the resonance peak) mechanical vibration, the high frequency vibration of the panel can not lead to the vibration of the additional element due to an elastic connection (e.g., the presence of the vibration transmission sheets) between the additional element or the magnetic circuit assembly and the panel, and the mass of the additional element does not affect the loading mass of the vibration of the transducer device. Thus, the sensitivity of the acoustic output device can not be affected by the additional element in the frequency range higher than the resonance frequency corresponding to the resonance peak.

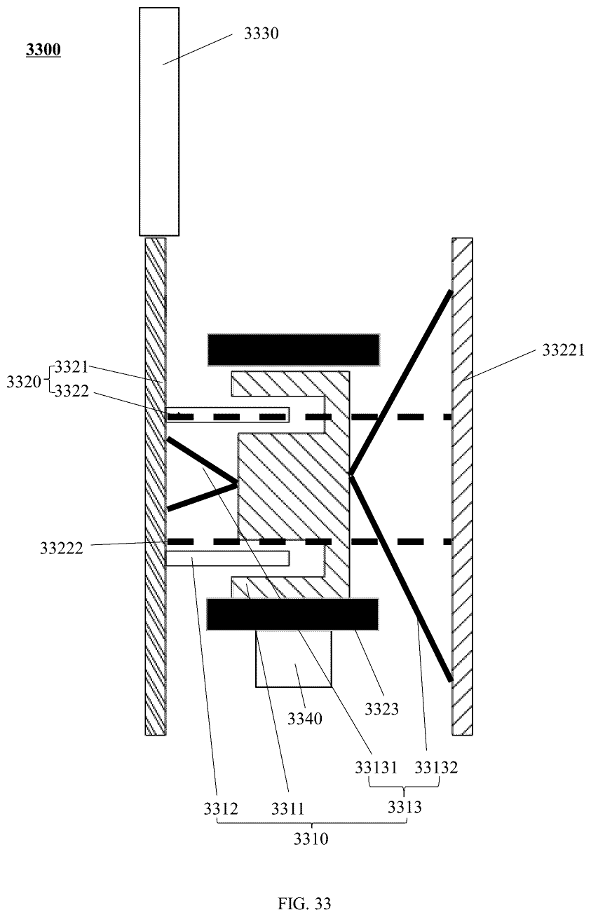

The acoustic output device according to some embodiments of the present disclosure may be described in detail below in combination with FIGS. 33-46.

FIG. 33 is a schematic diagram illustrating an exemplary structure of an acoustic output device 3300 according to some embodiments of the present disclosure. As shown in FIG. 33, the acoustic output device 3300 includes a transducer device 3310, a shell 3320, a support structure 3330, and an additional element 3340. The transducer device 3310 may include a magnetic circuit assembly 3311, a coil 3312, and a vibration transmission sheet 3313. The coil 3312 may be disposed in the magnetic circuit assembly 3311. The housing 3320 may include a panel 3321, a shell 3322. The panel 3321 and the shell 3322 may form an accommodating chamber for accommodating the transducer device 3310, and the coil 3312 may be connected to the panel 3321. Further, the shell 3322 may include a back panel 33221 opposite to the panel 3321 and a housing body 33222 adjacent to the panel 3321. The support structure 3330 may be rigidly connected to the panel 3321. Structures of the magnetic circuit assembly 3311, the coil 3312, the panel 3321, the shell 3322 (including the back panel 33221 and the housing body 33222), the support component 3323, the support structure 3330, and the additional element 3340 may be similar to the structures of the magnetic circuit assembly 2011, the coil 2012, the panel 2021, the shell 2022 (including the back panel 20221 and the housing body 20222), the support component 2023, the support structure 2030, and the additional element 2040 of the acoustic output device 2000, respectively, which are not repeated herein.

In some embodiments, as shown in FIG. 33, the panel 3321 and the back panel 33221 may be located at two ends of the housing body 33222, respectively, and may be rigidly connected to the housing body 33222, such that the panel 3321 and the back panel 33221 can vibrate together to reduce the generation of sound leakage. In some embodiments, the housing body 33222 may be a columnar structure that is internally hollow and have open openings at two ends. The panel 3321 and the back panel 33221 may be located at two ends of the housing body 33222 that have the open openings, and the back panel 33221 may be rigidly connected to the panel 3321 through the housing body 33222. In some embodiments, the shell 3322 may also be an integrated structure. For example, the shell 3322 may be a structural body that is internally hollow and has an open opening at one end, and the panel 3321 may be disposed at the end of the shell 3322 with the open opening. In some embodiments, the housing body 33222 may be include a gap (not shown in FIG. 33), and a circumferential side of the magnetic circuit assembly 3311 may protrude from the gap to the exterior of the housing body 3322 and be rigidly connected to the support component 3323. The additional element 3340 may be rigidly connected to the support component 3323. In this way, the support component 3323 can provide a better support effect on the magnetic circuit assembly 3311, avoiding the magnetic circuit assembly 3311 from being attracted or repelled by the additional element 3340 to cause the deformation or inversion of the magnetic circuit assembly 3311, and affecting the vibration stability of the transducer device 3310.

The vibration transmission sheet 3313 may include a first vibration transmission sheet 33131 and a second vibration transmission sheet 33132. The first vibration transmission sheet 33131 may be disposed between the magnetic circuit assembly 3311 and the panel 3321, and elastically connect the magnetic circuit assembly 3311 and the panel 3321. The second vibration transmission sheet 33132 may be disposed between the magnetic circuit assembly 3311 and the back panel 33221, and elastically connect the magnetic circuit assembly 3311 and the back panel 33221. Merely by way of example, a side of the magnetic circuit assembly 3311 near the panel 3321 may be elastically connected to the panel 3321 through the first vibration transmission sheet 33131, and a side of the magnetic circuit assembly 3311 near the back panel 3321 may be elastically connected to the panel 3321 through the second vibration transmission sheet 33132. In some embodiments, the count of vibration transmission sheets may also be one. For example, the vibration transmission sheet 3313 may include the first vibration transmission sheet 33131, and the magnetic circuit assembly 3311 may be elastically connected to the panel 3321 through the first vibration transmission sheet 33131. As another example, the magnetic circuit assembly 3313 may include the second vibration transmission sheet 33132, and the magnetic circuit assembly 3311 may be elastically connected to the back panel 33221 through the second vibration transmission sheet 33132. In some embodiments, the first vibration transmission sheet 33131 and the second vibration transmission sheet 33132 may include a center region and a plurality of support rods. The plurality of support rods may be disposed at intervals along a circumferential side of the center region. The center region may be connected to a side of the magnetic circuit assembly away from the panel, and an end of each support rod away from the center region may be connected to the shell. Merely by way of example, the count of the support rods may be four. At this time, the structure of the first vibration transmission sheet 33131 and the second vibration transmission sheet 33132 may be approximately regarded as an “X”-shaped structure. The “X”-shaped structure may provide elasticity in the vibration direction of the transducer device. In addition, the plurality of support rods may have high structural strengths in the vibration direction of the transducer device, which can provide a good support effect on the magnetic circuit assembly 3311 to avoid the deformation or inversion of the transducer device during the vibration. In some embodiments, the first vibration transmission sheet 33131 and the second vibration transmission sheet 33132 may further include an edge region. The edge region may be connected to an end of each support rod away from the center region, and a circumferential side of the edge region may be connected to the shell. More descriptions regarding the structure of the vibration transmission sheet may be found elsewhere in the present disclosure (e.g., FIGS. 46 and 47, and relevant descriptions thereof).

In some embodiments, the additional element 3340 and the magnetic circuit assembly 3311 may vibrate with respect to the panel 3321 to generate a resonance peak located in a target frequency range. In the frequency range greater than the resonance frequency corresponding to the resonance peak, the vibration transmission between the additional element 3340 and the panel 3321 may be suppressed. That is, the influence of the additional element 3340 on the vibration of the panel 3321 is reduced, thereby ensuring that the sensitivity of the acoustic output device 3300 is not or less affected by the additional element 3340 in the frequency range greater than the resonance frequency corresponding to the resonance peak. In some embodiments, the sensitivity of the acoustic output device 3300 may not be affected by the additional element 3340 in the frequency range that is greater than the resonant frequency corresponding to the resonance peak. In some embodiments, the lower the resonance frequency corresponding to the resonance peak in the target frequency range, the wider the frequency band in which the acoustic output device 3300 can have a flat frequency response curve. In some embodiments, by adjusting an clastic coefficient of the vibration transmission sheet 33131 and/or the second vibration transmission sheet 33132, and the mass of the additional element 3340 to adjust the resonance frequency corresponding to the resonance peak, the frequency range in which the additional element 3340 affects the acoustic output device 3300 may be reduced, and the acoustic output device 3300 may have a flat frequency response curve in a wider frequency band. In some embodiments, the target frequency range may be within a range of 20 Hz to 800 Hz. For instance, the target frequency range may be within a range of 100 Hz to 600 Hz. As another example, the target frequency range may be within a range of 150 Hz to 500 Hz. As still another example, the target frequency range may be within a range of 200 Hz, to 400 Hz.

In some embodiments, the additional element 3340 and the magnetic circuit assembly 3311 may vibrate with respect to the panel 3321 to generate a resonance valley located in the target frequency range. Furthermore, the closer the frequency corresponding to the resonance peak to the frequency corresponding to the resonance valley, the less the influence on the flatness of the frequency response curve of the acoustic output device 3300 in the overall frequency band. In order to make the frequency response curve of the acoustic output device 43300 in the overall frequency band flatter, in some embodiments, the frequency corresponding to the resonance valley may be smaller than the frequency corresponding to the resonance peak. In some embodiments, a frequency difference between the frequency corresponding to the resonance peak and the frequency corresponding to the resonance valley may not be greater than 300 Hz. In some embodiments, the frequency difference between the frequency corresponding to the resonance peak and the frequency corresponding to the resonance valley may not be greater than 200 Hz. In some embodiments, the difference between the frequency corresponding to the resonance peak and the frequency corresponding to the resonance valley may not be greater than 100 Hz. The difference between the resonance peak and the resonance valley also has an influence on the flatness of the frequency response curve of the acoustic output device 3300. For example, the smaller the difference between the resonance peak and the resonance valley, the flatter the frequency response curve of the acoustic output device 3300 in the overall frequency band. In order to make the frequency response curve of the acoustic output device 3300 in the overall frequency band flatter, in some embodiments, the difference between the resonance peak and the resonance valley may be within a range of 20 dB to 100 dB. In some embodiments, the difference between the resonance peak and the resonance valley may be within a range of 20 dB to 60 dB. In some embodiments, the difference between the resonance peak and the resonance valley may be within a range of 20 dB to 40 dB.

In some embodiments, the clastic element may be disposed between an end of the support component 3323 and the panel 3321 and between the other end of the support component 3323 and the back panel 33221, so that gaps between the end of the support component 3323 and the panel 3321 and between the other end of the support component 3323 and the back panel 33221 can be sealed through the clastic element. Alternatively, the gaps between the end of the support component 3323 and the panel 3321 and between the other end of the support component 3323 and the back panel 33221 may be disposed with a filler material or connected with the clastic element, so as to form the shell 3320 of the acoustic output device 3300. In some embodiments, the filler material and the clastic element may be an clastic material such as silicone, polyurethane, etc., which further reduces the vibration transmission from the panel 3321 and the back panel 33221 to the additional element 3340, further reducing the influence of the mass of the additional element on the loading mass of the vibration of the transducer device. Therefore, the influence of the additional element on the sensitivity of the acoustic output device 3300 can be reduced.

In some embodiments, the housing body 33222 may also be a plate-like structure or a rod-like structure, and two ends of the housing body 33222 may be rigidly connected to the panel 3321 and the back panel 33221, respectively. For example, the housing body 33222 may include two plate-like structures, and two ends of each of the two plate-like structures may be rigidly connected to the panel 3321 and the back panel 33221, respectively.

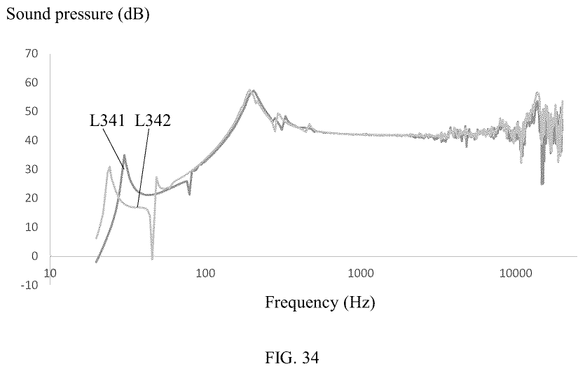

FIG. 34 is a graph of frequency response curves of an acoustic output device according to some embodiments of the present disclosure.

As shown in FIG. 34, the horizontal coordinates represent frequencies (Hz), and the vertical coordinates represent sound pressures (dB) corresponding to acoustic output devices at different frequencies. A curve L341 represents a frequency response curve of the acoustic output device 3300 without the additional element 3340. A curve L342 represents a frequency response curve of the acoustic output device 3300 with the additional element 3340. Combining the curves L341 and L342, it can be seen that, the acoustic output device 3300 generates a resonance peak in a frequency range from 10 Hz to 100 Hz. In a frequency range higher than the resonance frequency corresponding to the resonance peak, the curve L341 and the curve L342 tend to overlap, and have a relatively flat frequency response in a frequency range from 200 Hz to 10000 Hz curve. It can be seen that, the sensitivity of the acoustic output device 3300 can not be affected by the mass of the additional element 3340 and has a relatively flat frequency response curve in the frequency range higher than the resonance frequency corresponding to the resonance peak. Thus, the acoustic output device can have a better acoustic output effect.

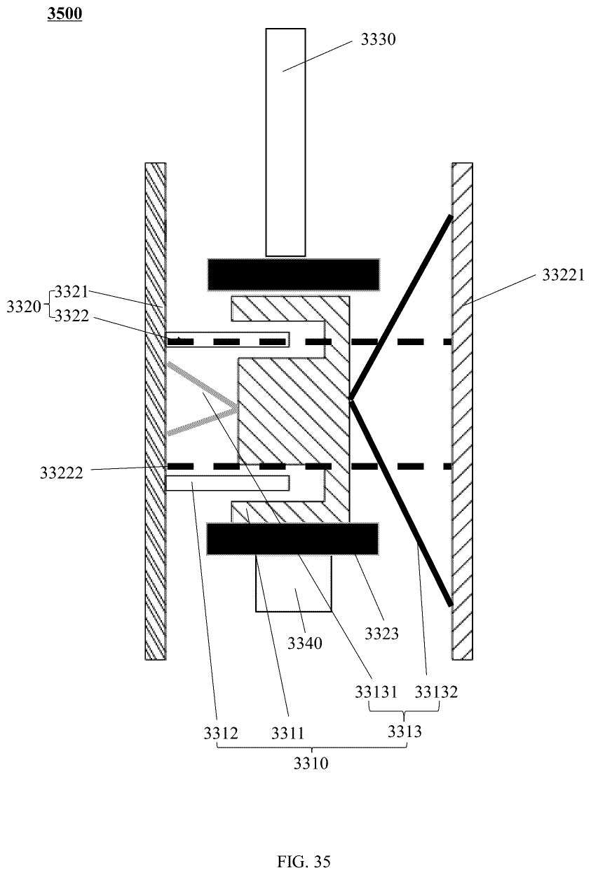

FIG. 35 is a schematic diagram illustrating an exemplary structure of an acoustic output device 3500 according to some embodiments of the present disclosure. The difference between the acoustic output device 3500 shown in FIG. 35 and the acoustic output device 3300 shown in FIG. 33 may include that the support structure 3330 in the acoustic output device 3500 may be rigidly connected to the support component 3323.

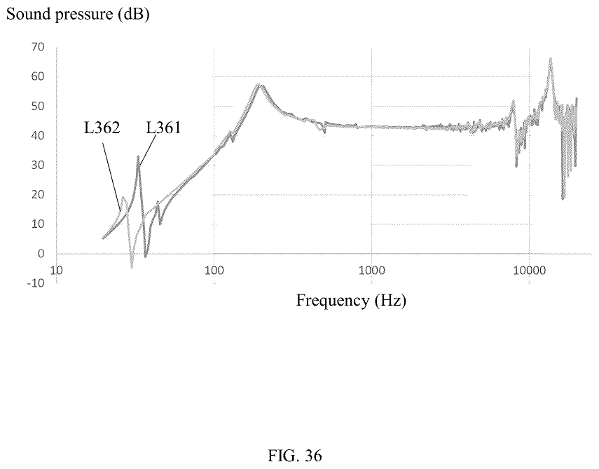

FIG. 36 is a graph of frequency response curves of an acoustic output device according to some embodiments of the present disclosure. As shown in FIG. 36, the horizontal coordinates represent frequencies (Hz), and the vertical coordinates represent sound pressures (dB) corresponding to acoustic output devices at different frequencies. A curve L361 represents a frequency response curve of the acoustic output device 3500 when the mass of the additional element 3340 is 0 g. A curve L362 represents a frequency response curve of the acoustic output device 3500 when the mass of the additional element 3340 has a certain mass (the mass is not 0 g). Combining the curves L361 and L362, it can be seen that, the acoustic output device 3500 generates a resonance peak in a frequency range from 10 Hz to 100 Hz. In a frequency range higher than the resonance frequency corresponding to the resonance peak, the curve L361 and the curve L362 tend to overlap, and have a relatively flat frequency response in a frequency range from 200 Hz to 10000 Hz curve. It can be seen that, the sensitivity of the acoustic output device 3500 can not be affected by the mass of the additional element 3340 and has a relatively flat frequency response curve in the frequency range higher than the resonance frequency corresponding to the resonance peak. Thus, the acoustic output device can have a better acoustic output effect. In some embodiments, the support structure 3330 may also be rigidly connected to the back panel 33221.

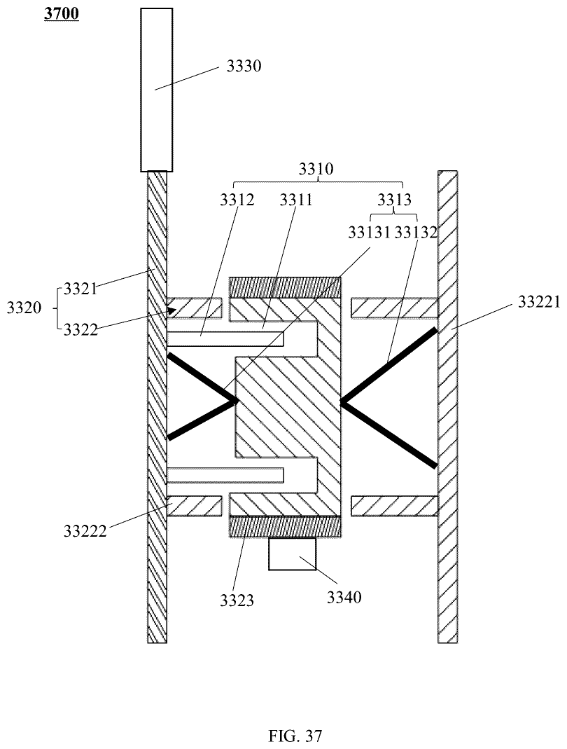

FIG. 37 is a schematic diagram illustrating an exemplary structure of an acoustic output device 3700 according to some embodiments of the present disclosure. As shown in FIG. 37, the support component 3323 in the acoustic output device 3700 may be a cartridge structure, and the cartridge structure may be disposed around a circumferential side of the magnetic circuit assembly 3311 along a circumferential side of the housing body 33222. The circumferential side of the magnetic circuit assembly 3311 may be rigidly connected to an inner surface of the cartridge structure, and the additional element 3340 may be rigidly connected to the cartridge structure. Merely by way of example, when the support component 3023 is located on an outer side of the shell 3022, the circumferential side of the magnetic circuit assembly 3311 may extend through a gap disposed in the housing body 33222 to the exterior of the shell 3022 and be rigidly connected to the support component 3323. In some embodiments, the support component 3323 may also be disposed on an inner side of the shell 3322, and the circumferential side of the magnetic circuit assembly 3311 may be rigidly connected to the support component 3323 without passing through the housing body 33222. In some embodiments, the clastic element may be disposed between an end of the support component 3323 and the panel 3321 and between the other end of the support component 3323 and the back panel 33221, so that gaps between the end of the support component 3323 and the panel 3321 and between the other end of the support component 3323 and the back panel 33221 can be scaled through the elastic element. Alternatively, the gaps between the end of the support component 3323 and the panel 3321 and between the other end of the support component 3323 and the back panel 33221 may be disposed with a filler material or connected with the clastic element, so as to form the shell 3320 of the acoustic output device 3300. In some embodiments, the filler material and the clastic element may be an elastic material such as silicone, polyurethane, etc., which further reduces the vibration transmission from the panel 3321 and the back panel 33221 to the additional element 3340, further reducing the influence of the mass of the additional element on the loading mass of the vibration of the transducer device. Therefore, the influence of the additional element on the sensitivity of the acoustic output device 3500 can be reduced.

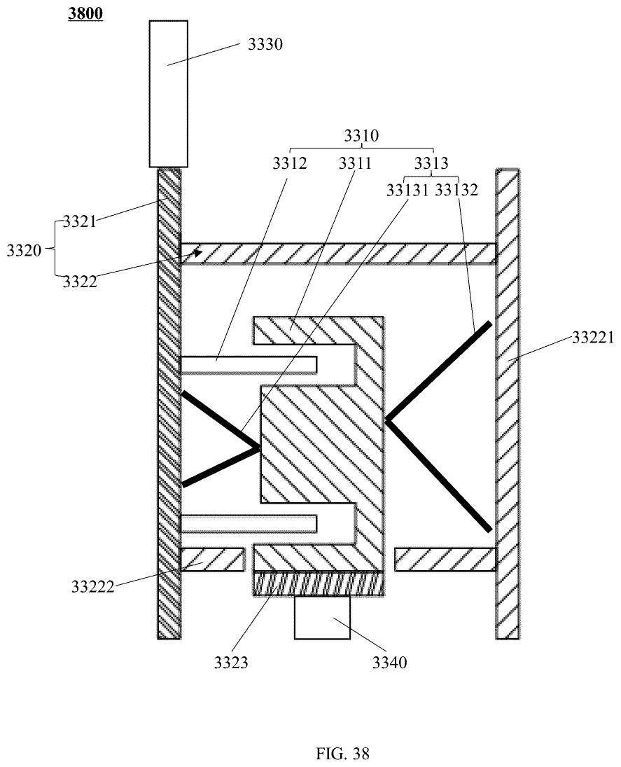

FIG. 38 is a schematic diagram illustrating an exemplary structure of an acoustic output device 3800 according to some embodiments of the present disclosure.

As shown in FIG. 38, the support component 3323 in the acoustic output device 3800 may be a plate-like structure. The plate-like structure may be disposed on one side of the housing main body 33222, and two sides of the magnetic circuit assembly 3311 may be elastically connected to the panel 33222 and the back panel 33221, respectively, by the clastic element. The magnetic circuit assembly 3311 may be rigidly connected to the plate-like structure, and the additional element 3340 may be rigidly connected to the plate-like structure. In the embodiment of the present disclosure, the elastic element may be a spring, a vibration transmission sheet, or other structures with elasticity. In the embodiment of the present disclosure, the clastic element may include the first vibration transmission sheet 33131 and the second vibration transmission sheet 33132 disposed on the two sides of the magnetic circuit assembly 3311. The first vibration transmission sheet 33131 may connect the magnetic circuit assembly 3311 and the panel 33222, and the second vibration transmission sheet 33132 may connect the magnetic circuit assembly 3311 and the back panel 33221. Merely by way of example, when the plate-like structure is disposed on an outer side of the shell 3022, a side of the magnetic circuit assembly 3311 facing the housing body 33222 near the plate-like structure may protrude through a notch disposed on the housing body 33222 to the exterior of the shell 3322 and be rigidly connected to the plate-like structure. In some embodiments, the plate-like structure may also be disposed on an inner side of the shell 3322, and a side of the magnetic circuit assembly 3311 may be connected to the plate-like structure without passing through the housing body 33222. In some embodiments, the plate-like structure may also be disposed on the notch, and two ends of the plate-like structure may be connected to the housing body 3322 through the clastic element or by filling with an elastic material. It should be noted that the support structure 3300 in FIG. 38 is not limited to being rigidly connected to the panel 3321, but may also be rigidly connected to the housing body 33222 or the back panel 33221. Furthermore, the count of the plate-like structure is not limited to the one shown in FIG. 38, but may also be two, three, or more.

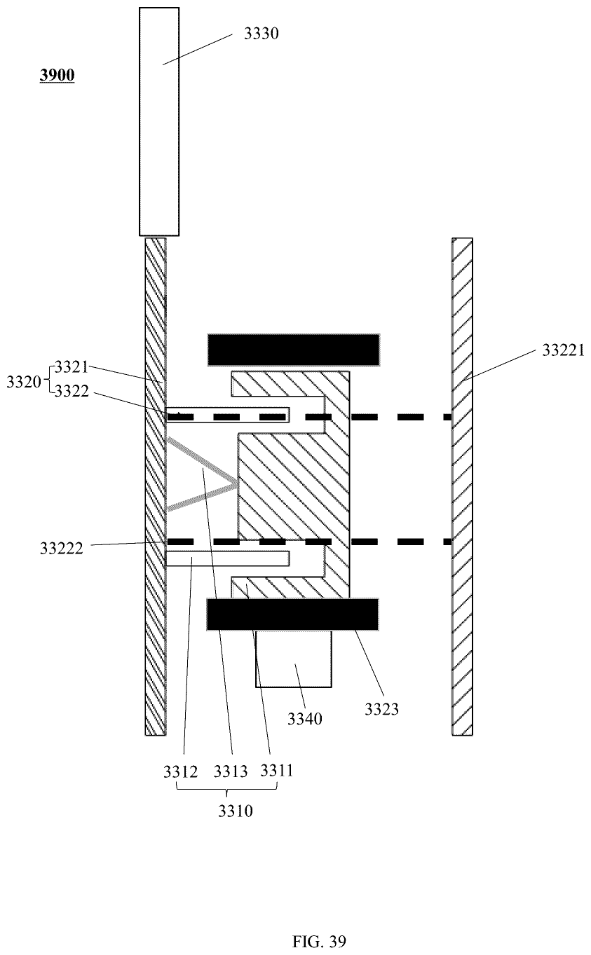

FIG. 39 is a schematic diagram illustrating an exemplary structure of an acoustic output device 3900 according to some embodiments of the present disclosure.

As shown in FIG. 39, the difference between the acoustic output device 3900 and the acoustic output device 3300 shown in FIG. 33 may include that the count of the vibration transmission sheet 3313 in the acoustic output device 3900 is only one (for case of description, the vibration transmission sheet is still denoted by the term vibration transmission sheet 3313 in FIG. 39), and the vibration transmission sheet 3313 is disposed between the magnetic circuit assembly 3311 and the panel 3321, and elastically connects the magnetic circuit assembly 3311 and the panel 3321. It should be noted that the support structure 3300 in FIG. 39 is not limited to being rigidly connected to the panel 3321, but may also be rigidly connected to the housing body 33222 or the back panel 33221.

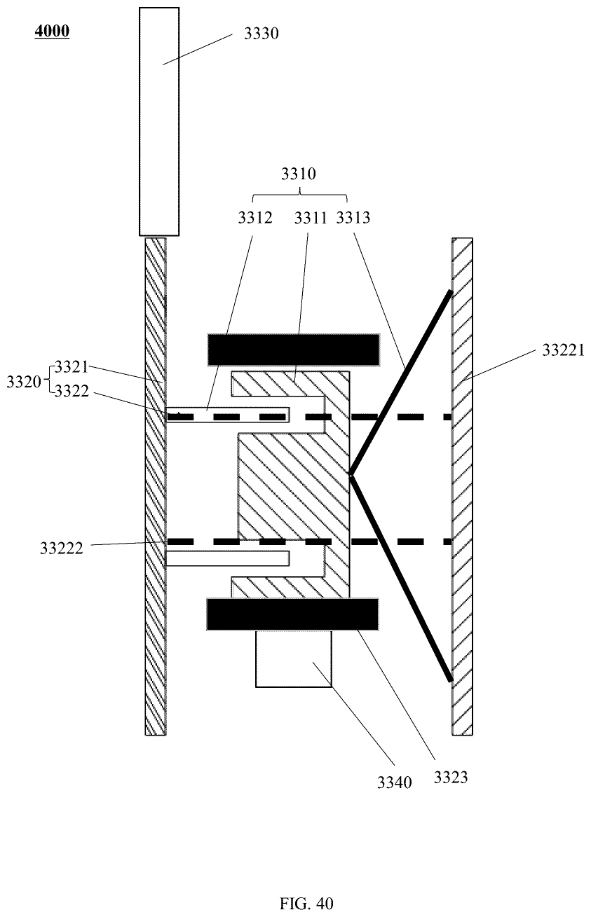

FIG. 40 is a schematic diagram illustrating an exemplary structure of an acoustic output device according 4000 to some embodiments of the present disclosure.

As shown in FIG. 40, the difference between the acoustic output device 4000 and the acoustic output device 3300 shown in FIG. 33 may include that the count of the vibration transmission sheet 3313 in the acoustic output device 4000 is only one (for case of description, the vibration transmission sheet is still denoted by the term vibration transmission sheet 3313 in FIG. 40), and the vibration transmission sheet 3313 is disposed between the magnetic circuit assembly 3311 and the panel 3321, and elastically connects the magnetic circuit assembly 3311 and the panel 3321.

It is to be noted that the support component being a cartridge structure or a plate-like structure is also applicable to the support component 3323 in the acoustic output devices 3900 and 4000. More descriptions may be found in descriptions about the acoustic output device 3700 shown in FIG. 37 or the acoustic output device 3800 shown in FIG. 38, which are not repeated herein. In addition, the support structure 3300 in FIG. 40 is not limited to being rigidly connected to the panel 3321, but may also be rigidly connected to the housing body 33222 or the back panel 33221.

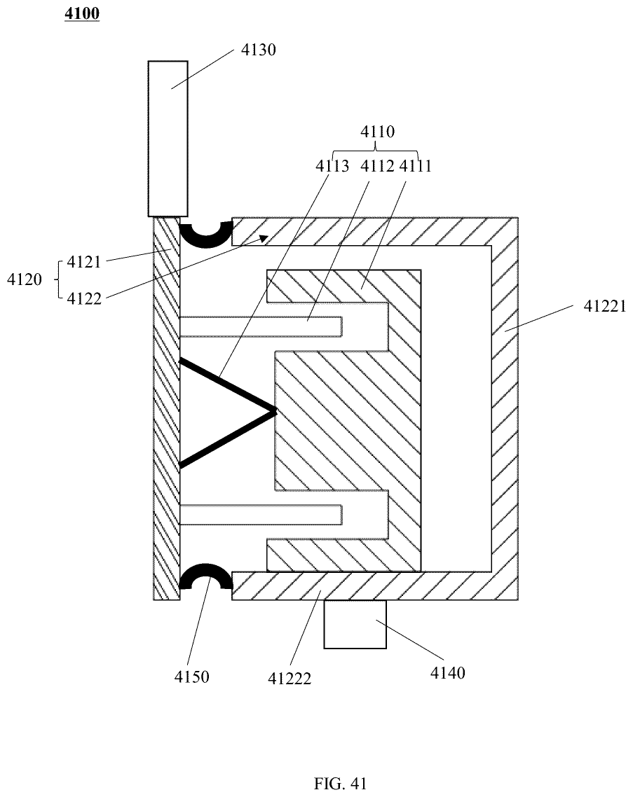

FIG. 41 is a schematic diagram illustrating an exemplary structure of an acoustic output device according 4100 according to some embodiments of the present disclosure.

As shown in FIG. 41, structures of a transducer device 4110 (including a magnetic circuit assembly 4111, a coil 4112, and a vibration transmission sheet 4113), a housing 4120 (including a panel 4121 and a shell 4122), a support structure 4130, and an additional element 4140, etc. of the acoustic output device 4100 may be similar to the structures of the transducer device 410 (including the magnetic circuit assembly 411, the coil 412, and the vibration transmission sheet 413A), the support structure 430, the additional element 440, etc., of the acoustic output device 400. The main difference between the acoustic output device 4100 and the acoustic output device 400 may include that the additional element 4140 in the acoustic output device 4100 is rigidly connected to the sidewall (i.e., the housing body 41222) of the shell 4122 adjacent to the panel 4121, and the magnetic circuit assembly 4111 is rigidly connected to the housing body 41222. In this way, the housing body 41222 can provide a better support effect on the magnetic circuit assembly 4111, avoiding the magnetic circuit assembly 4111 from being attracted or repelled by the additional element 4140 to cause the deformation or inversion of the magnetic circuit assembly 4111, and affecting the vibration stability of the transducer device 4110.

In some embodiments, as shown in FIG. 41, the shell 4122 may be regarded as a structural body that is internally hollow and has an open opening facing the panel 4121. Further, the shell 4122 may include a back panel 41221 (a sidewall on the shell 4122 opposite to the panel) and a housing body 41222 (a sidewall on the shell 4122 adjacent to the panel 4121), and the panel 4121 and the back panel 41221 may be located at two ends of the housing body 41222, respectively. The vibration transmission sheet 4113 may be disposed between the panel 4121 and the magnetic circuit assembly 412, and elastically connect the magnetic circuit assembly 4111 to the panel 4121.

In some embodiments, as shown in FIG. 41, the panel 4121 and one end of the housing body 41222 may be connected through the elastic element 4450. As a result of the presence of the vibration transmission sheet 4113 and the clastic element 4150, the additional element 4140 and the magnetic circuit assembly 4111 may vibrate with respect to the panel 4221 to generate a resonance peak in a target frequency range. Further, the vibration transmission sheet 4113 and the elastic element 4150 may reduce or prevent the panel 4121 from transmitting vibrations in a frequency range higher than a resonance frequency corresponding to the resonance peak to the additional element 4140. Therefore, the mass of the additional element has no effect on the loading mass of the vibration of the transducer device in the frequency range higher than the resonance frequency corresponding to the resonance peak, thereby ensuring that the sensitivity of the acoustic output device is not affected by the additional element in the frequency range higher than the resonance frequency corresponding to the resonance peak. It should be noted that the clastic element being a reed structure, a ring structure with elasticity, or a glue with elasticity is also applicable to the elastic element 4150 in the acoustic output device 4100. More descriptions may be found in descriptions about the acoustic output device 400 shown in FIG. 4.

It should be noted that the support structure 4100 of FIG. 41 is not limited to being rigidly connected to the panel 4121, but may also be rigidly connected to the housing body 41222 or the back panel 41221.

It is to be noted that, the solution that in the acoustic output device 900 illustrated in FIG. 9, opening the pressure relief holes 9221 on the shell 922 to reduce the resonance frequency corresponding to the resonance peak generated by the vibration of the additional element driven by the elastic element with respect to the panel thereby broadening the frequency range in which the sensitivity of the acoustic output device is not or less affected by the additional element, is applicable to the acoustic output device 4100. The solution that in the acoustic output device 1200, elastically connecting the back panel of the acoustic output device 1200 to the sidewall of the shell adjacent to the panel to reduce the high frequency sound leakage, is also applicable to the acoustic output device 4100.

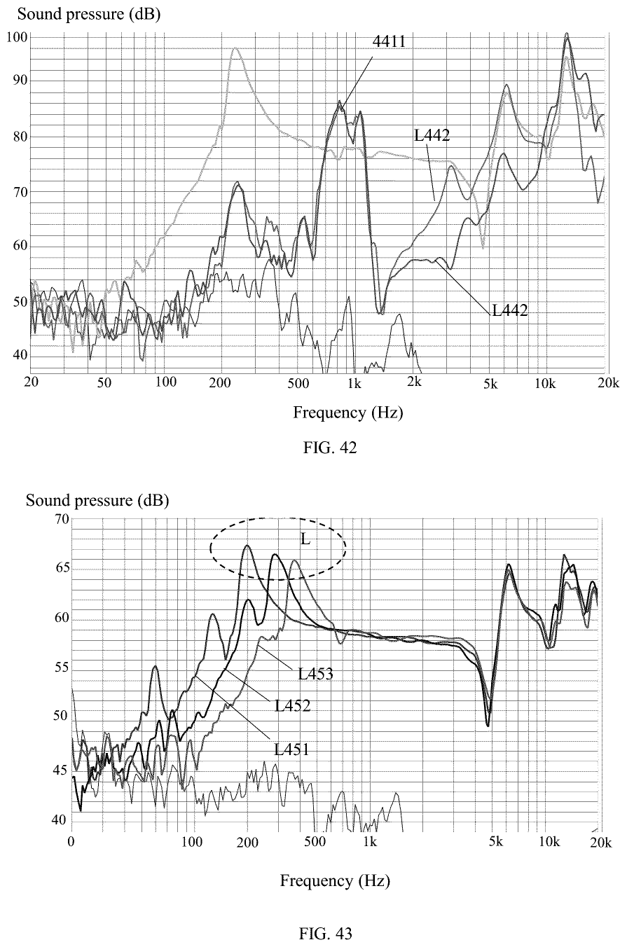

Since the additional element has a certain mass, there may be a certain distance between the center of mass of the entire acoustic output device and a direction of a driving force of the magnetic circuit assembly in the transducer device, resulting in the vibration and wobbling of the magnetic circuit assembly in the transducer device, which not only affects the vibration stability of the transducer device but also increases sound leakage. The influence of the additional element on the sound leakage of the acoustic output device will be illustrated in the following in combination with FIG. 42.

FIG. 42 is a graph of frequency response curves of an acoustic output device according to some embodiments of the present disclosure.

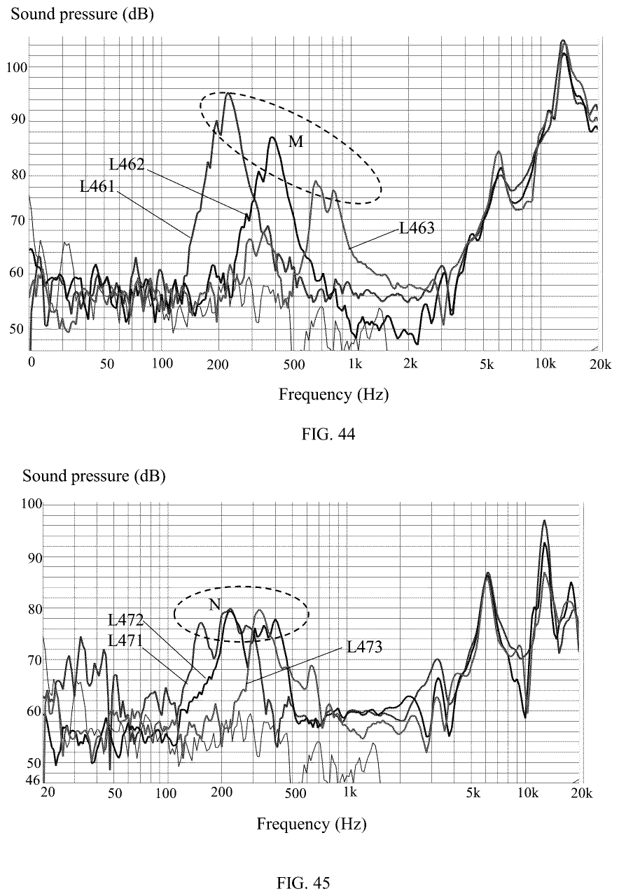

As shown in FIG. 42, a curve L441 represents a sound leakage frequency response curve corresponding to a side of the housing body 33222 of the acoustic output device 3300 where the additional element is disposed. A curve L442 represents a sound leakage frequency response curve corresponding to a side of the housing body 33222 back away from the side where the additional element is disposed. The sound leakage frequency response curves L441 and L442 may be measured by collecting air-conduction sound on the side of the housing body 33222 in the acoustic output device 3300. From the curves L441 and L442, it can be seen that the acoustic output device 3300 generates a sound leakage resonance peak 4411 in a frequency range from 500 Hz to 2000 Hz. The sound leakage resonance peak 4411 is generated by the magnetic circuit assembly 3311 when there is a vibrational wobble. The presence of the sound leakage resonance peak 4421 causes the acoustic output device 3300 to generate a relatively large sound leakage in an operating frequency band (e.g., from 500 Hz to 2000 Hz). Accordingly, in some embodiments, by adjusting the position of the sound leakage resonance peak 4411, a resonance frequency corresponding to the sound leakage resonance peak may be as far as possible from the operating frequency band, so as to avoid the acoustic output device from having the large sound leakage in the operating frequency band. In some embodiments, the resonance frequency corresponding to the sound leakage resonance peak may be adjusted by adjusting clastic coefficients of the first vibration transmission sheet 33131 and/or the second vibration transmission sheet 33132. For example, the elastic coefficients of the vibration transmission sheets may be adjusted, or a position of a connection point between the reed structure and other structures may be adjusted, so as to reduce the case of the deformation or inversion of the reed structure. For instance, the clastic coefficient of the vibration transmission sheet can be adjusted, thereby adjusting the inversion stiffness (the difficulty of the inversion and deformation) of the vibration transmission sheet. By designing X-shaped vibration transmission sheets, a relatively large inversion stiffness can be obtained. At the same time, the clastic coefficient of the vibration transmission sheet (deformation along the vibration direction) can be maintained as much as possible. More descriptions regarding the adjusting the resonance frequency corresponding to the resonance peak of the leakage sound may be found in FIG. 44 and FIG. 45, and relevant descriptions thereof.

FIG. 43 is a graph of frequency response curves of an acoustic output device according to some embodiments of the present disclosure. The frequency response curves in FIG. 43 may be measured by collecting air-conduction sound on a side of the panel 3321 in the acoustic output device 3300. As shown in FIG. 43, a curve L451 represents a frequency response curve of the acoustic output device 3300 when clastic coefficients of the first vibration transmission sheet 33131 and the second vibration transmission sheet 33132 are K1. A curve L452 represents a frequency response curve of the acoustic output device 3300 when the clastic coefficients of the first vibration transmission sheet 33131 and the second vibration transmission sheet 33132 are K2. A curve L453 represents a frequency response curve of the acoustic output device 3300 when the clastic coefficients of the first vibration transmission sheet 33131 and the second vibration transmission sheet 33132 are K3, wherein K1<K2<K3. Resonance peaks in a region L represent resonance peaks in the target frequency range generated by the additional element 3340 and the magnetic circuit assembly 3311 in the acoustic output device 3300 with respect to the panel 3321. Combining the curves L451, L452, and L453, it can be seen that in a resonance frequency higher than the resonance frequency corresponding to the resonance peak, the acoustic output device 3300 has a relatively flat frequency response curve, with a better acoustic output effect. As the clastic coefficients of the first vibration transmission sheet 33131 and the second vibration transmission sheet 33132 increase, the resonance frequencies corresponding to the resonance peaks increase. In order to have a flatter frequency response curve in a wider frequency range, in some embodiments, the resonance peaks may be adjusted to be within the target frequency range by adjusting the clastic coefficients of the first vibration transmission sheet 33131 and the second vibration transmission sheet 33132 and/or the mass of the additional element. In some embodiments, the target frequency range may not be greater than 800 Hz. For instance, the target frequency range may not be greater than 700 Hz. As another example, the target frequency range may not be greater than 500 Hz. As yet another example, the target frequency range may not be greater than 300 Hz. As still another example, the target frequency range may not be greater than 200 Hz.

FIG. 44 is a graph of sound leakage frequency response curves of an acoustic output device according to some embodiments of the present disclosure. The sound leakage frequency response curves in FIG. 44 may be measured by collecting air-conduction sound on a side of the shell 3322 in the acoustic output device 3300 opposite to the additional element 3340. As shown in FIG. 44, a curve L461 represents a sound leakage frequency response curve of the acoustic output device 3300 when the clastic coefficients of the first vibration transmission sheet 33131 and the second vibration transmission sheet 33132 are K1. A curve L462 represents a sound leakage frequency response curve of the acoustic output device 3300 when the clastic coefficients of the first vibration transmission sheet 33131 and the second vibration transmission sheet 33132 are K2. A curve L463 represents a sound leakage frequency response curve of the acoustic output device 3300 when the elastic coefficients of the first vibration transmission sheet 33131 and the second vibration transmission sheet 33132 are K3, wherein K1<K2<K3. Leakage resonance peaks in a region M represent leakage resonance peaks on each sound leakage frequency response curve. Combining the curves L461, L462, and L463, it can be seen that, as the clastic coefficients of the first vibration transmission sheet 33131 and the second vibration transmission sheet 33132 increase, the resonance frequencies corresponding to the sound leakage resonance peaks increase. In some embodiments, the resonance frequency corresponding to the resonance of the sound leakage resonance curve may be made smaller than the resonance frequency of the frequency response curve of the acoustic output device by adjusting the clastic coefficients of the first vibration transmission sheet 33131 and the second vibration transmission sheet 33132, so that the side on the shell 3322 of the acoustic output device 3300 opposite to the additional element 3340 has a smaller sound leakage. In some embodiments, the resonance frequency corresponding to the resonance of the sound leakage resonance curve may be less than 700 Hz. For instance, the resonance frequency corresponding to the resonance of the sound leakage resonance curve may be less than 500 Hz. As another example, the resonance frequency corresponding to the resonance of the sound leakage resonance curve may be less than 300 Hz. As yet another example, the resonance frequency corresponding to the resonance of the sound leakage resonance curve may be less than 200 Hz.

FIG. 45 is a graph of sound leakage frequency response curves of an acoustic output device according to some embodiments of the present disclosure. The sound leakage frequency response curves in FIG. 45 may be measured by collecting air-conduction sound from a side of the shell 3322 of the acoustic output device 3300 where the additional element 3340 is located on.

As shown in FIG. 45, a curve L471 represents a sound leakage frequency response curve of the acoustic output device 3300 when the clastic coefficients of the first vibration transmission sheet 33131 and the second vibration transmission sheet 33132 are K1. A curve L472 represents a sound leakage frequency response curve of the acoustic output device 3300 when the elastic coefficients of the first vibration transmission sheet 33131 and the second vibration transmission sheet 33132 are K2. A curve L473 represents a sound leakage frequency response curve of the acoustic output device 3300 when the clastic coefficients of the first vibration transmission sheet 33131 and the second vibration transmission sheet 33132 are K3, wherein K1<K2<K3. Leakage resonance peaks in a region N represent leakage resonance peaks on each leakage frequency response curve. Combining the curves L471, L472, and L473, it can be seen that, as the clastic coefficients of the first vibration transmission sheet 33131 and the second vibration transmission sheet 33132 increase, the resonance frequencies corresponding to the sound leakage resonance peaks increase. In some embodiments, the resonance frequency corresponding to the resonance of the sound leakage resonance curve may be made smaller than the resonance frequency of the frequency response curve of the acoustic output device by adjusting the clastic coefficients of the first vibration transmission sheet 33131 and the second vibration transmission sheet 33132, so that the side on the shell 3322 of the acoustic output device 3300 with the additional element 3340 has a smaller sound leakage. In some embodiments, the resonance frequency corresponding to the resonance of the sound leakage resonance curve may be less than 700 Hz. For instance, the resonance frequency corresponding to the resonance of the sound leakage resonance curve may be less than 500 Hz. As another example, the resonance frequency corresponding to the resonance of the sound leakage resonance curve may be less than 300 Hz. As yet another example, the resonance frequency corresponding to the resonance of the sound leakage resonance curve may be less than 200 Hz. In some embodiments, the clastic coefficients of the first vibration transmission sheet 33131 and the second vibration transmission sheet 33132 may be related to their structures. By designing the structures of the first vibration transmission sheet 33131 and the second vibration transmission sheet 33132, the first vibration transmission sheet 33131 and the second vibration transmission sheet 33132 may have relatively large elastic coefficients, thereby causing the resonance frequency of the sound leakage resonance peak of the acoustic output device 3300 to be far away from the operating frequency band. In some embodiments, when the first vibration transmission sheet 33131 and the second vibration transmission sheet 33132 adopt a structure of a vibration transmission sheet 4800 as shown in FIGS. 46 and 47, the first vibration transmission sheet 33131 and the second vibration transmission sheet 33132 may have the relatively large clastic coefficients, and the acoustic output device 3300 may have a relatively small sound leakage in a relatively wide operating frequency band. The structure of the vibration transmission sheet will be described in detail below in combination with FIGS. 46 and 47.

(a) to (c) in FIG. 46 are schematic diagrams illustrating structures of vibration transmission sheets form a top view according to some embodiments of the present disclosure. (a) to (c) in FIG. 47 are schematic diagrams illustrating stereoscopic structures of vibration transmission sheets according to some embodiments of the present disclosure.

As shown in FIG. 46 and FIG. 47, the vibration transmission sheet 4800 may include a center region 4810, an edge region 4820, and a plurality of support rods 4830 connecting the center region 4810 and the edge region 4820. When the vibration transmission sheet 4800 is configured to connect the magnetic circuit assembly and the housing (e.g., the panel or the back panel), the center region 4810 of the vibration transmission sheet 4800 may be connected to the magnetic circuit assembly, and the edge region 4820 of the vibration transmission sheet 4800 may be connected to the housing. Merely by way of example, when the first vibration transmission sheet 33131 in the acoustic output device 3300 is the vibration transmission sheet 4800, the center region 4810 of the vibration transmission sheet 4800 may be connected to a side of the magnetic circuit assembly 3311 near the panel 3321, and the edge region 4820 of the vibration transmission sheet 4800 may be connected to the panel 3321. When the second vibration transmission sheet 33132 in the acoustic output device 3300 is the vibration transmission sheet 4800, the center region 4810 of the vibration transmission sheet 4800 may be connected to a side of the magnetic circuit assembly 3311 near the back panel 33221, and the edge region 4820 of the vibration transmission sheet 4800 may be connected to the back panel 33221.

In some embodiments, in a natural state of the vibration transmission sheet 4800, the edge region 4820 of the vibration transmission sheet 4800 may not be coplanar with the center region 4810 of the vibration transmission sheet 4800. In this way, a pre-tensioning force can be generated when the magnetic circuit assembly in the acoustic output device is connected to the panel and/or the back panel. The presence of the pre-tensioning force can avoid a situation that an elastic force of the vibration transmission sheet 4800 is zero when the transducer device vibrates, thereby improving the stability of the vibration of the transducer device in the acoustic output device. The natural state of the vibration transmission sheet 4800 refers to a structural state in which the vibration transmission sheet 4800 is assembled to the transducer device of the acoustic output device and no excitation signals are input into the transducer device to generate mechanical vibrations. It should be noted that the edge region 4820, the center region 4810 of the vibration transmission sheet 4800, and the support rods 4830 may also be in a same plane.

In some embodiments, as shown in FIG. 46 and FIG. 47, the count of support rods 4830 in the vibration transmission sheet 4800 may be four. The four support rods 4830 may be disposed along the circumference side of the center region 4810 of the vibration transmission sheet 4800 and symmetrically distributed about a centerline of the center region 4810, thereby increasing the overall elastic coefficient of the vibration transmission sheet 4800.

In order to further increase the overall clastic coefficient of the vibration transmission sheet 4800, in some embodiments, as illustrated in FIG. 46 and FIG. 47, the support rod 4830 may include one or more meandering bending structures 4831 disposed in an extension direction of the support rod 4830. In some embodiments, as shown in FIG. 47, the center region 4810 of the vibration transmission sheet 4800 may be disposed with a through hole 4811. The through hole 4811 may be configured for insertion of a convex column on the magnetic circuit assembly, thereby realizing a fixed connection between the center region 4810 and the magnetic circuit assembly through the cooperation of the convex column and the through hole.

When the additional element has a metallic material or a magnet inside, the additional element and the magnetic circuit assembly of the transducer device may attracted to each other. In order to reduce magnetic attraction influence of the additional element on the magnetic circuit assembly and avoid the magnetic circuit assembly in the transducer device from being biased, a stiffness of the vibration transmission sheet 4800 along any direction (also referred to as a radial direction) in a plane perpendicular to the vibration direction may be greater than a stiffness threshold. For example, an equivalent stiffness on the radial direction of the vibration transmission sheet 4800 may be determined to be greater than 4.7×104 N/m based on a width of a magnetic gap and a magnetic attraction force between the magnetic circuit assembly and the additional element. As another example, the equivalent stiffness on the radial direction of the vibration transmission sheet 4800 may be greater than 6.4×104 N/m. By optimizing the stiffness of the vibration transmission sheet 4800 with elasticity in the length and width directions in a plane perpendicular to the vibration direction, the magnetic attraction force between the magnetic circuit assembly and the additional element can be resisted, thus avoiding the bias in the magnetic circuit assembly in the transducer device, and ensuring stability during the vibration.

In some embodiments of the present disclosure, the magnetic circuit assembly may further include a magnet assembly, a magnetic guide cover (not shown in the figures), and at least one vibration transmission sheet. The transmission sheet may be connected between the magnetic guide cover and the magnet assembly for elastically supporting the magnet assembly within the magnetic guide cover. In one embodiment of the present disclosure, the transducer device may include two vibration transmission sheets, i.e., a first vibration transmission sheet and a second vibration transmission sheet. The first vibration transmission sheet and the second vibration transmission sheet may be distributed on two sides of the magnet assembly along a vibration direction of the magnet assembly, respectively, for elastically supporting the magnet assembly, respectively. In some embodiments, the vibration transmission sheet and the magnetic circuit assembly may be arranged along the vibration direction, and a side of the vibration transmission sheet perpendicular to the vibration direction may be connected to an end of the magnetic guide cover perpendicular to the vibration direction, so as to fix the magnet assembly. In some embodiments, by disposing the vibration transmission sheet with the specific stiffness, the vibration transmission sheet may also resist the magnetic attraction force between the magnet assembly and the magnetic guide cover, avoiding the magnet assembly in the transducer device from being biased. In some embodiments, am equivalent stiffness of the at least one vibration transmission sheet in the radial direction may be greater than 4.7×104 N/m. For example, the transducer device may include only one vibration transmission sheet. As another example, the transducer device may include only at least two vibration transmission sheets 4800, e.g., the first vibration transmission sheet and the second vibration transmission sheet. The equivalent stiffness of each of the first vibration transmission sheet and the second vibration transmission sheet in the radial direction may be greater than 4.7×104 N/m.

In some embodiments, relevant dimensional data of the vibration transmission sheet 4800 may be determined based on requirement(s) of the equivalent stiffness of the vibration transmission sheet 4800 in the radial direction. In some embodiments, along a length direction of the vibration transmission sheet 4800, a ratio of a distance between a starting point and an ending point of a support rod 4830 to a length of the support rod 4830 may be within a range of 0 to 1.2. The distance between the starting point and the ending point of the support rod 4830 along the length direction of the vibration transmission sheet 4800 refers to a distance between a connection point connecting the support rod 4830 and the center region 4810 of the vibration transmission sheet and a connection point connecting the support rod 4830 and the edge region of the vibration transmission sheet along the length direction of the vibration transmission sheet 4800. For example, as shown in (b) of FIG. 47, along the length direction of the vibration transmission sheet 4800, a ratio of a distance SE between the starting point S and the ending point E of the support rod 4830 to a total length of the curved support rod 4830 may be within a range of 0.7 to 0.85. In some embodiments, along a width direction of the vibration transmission sheet 4800, a ratio of the distance between the starting point and the ending point of the support rod 4830 and the length of the support rod 4830 may be within a range of 0 to 0.5. The distance between the starting point and the ending point of the support rod 4830 along the width direction of the vibration transmission sheet 4800 refers to a distance between the connection point connecting the support rod 4830 and the central region 4810 of the vibration transmission sheet and the connection point connecting the support rod 4830 and the edge region of the vibration transmission sheet along the width direction of the vibration transmission sheet 4800. For example, as shown in (b) of FIG. 47, a ratio of the distance S′E′ between the starting point S and the ending point E of the support rod 4830 to the total length of the curved support rods 4830 along the width direction of the vibration transmission sheet 4800 may be within a range of 0.15 to 0.35.

In some embodiments, the length of the support rod 4830 may be within a range of 7 mm to 25 mm. In some embodiments, a thickness of the support rod along the axial direction of the transducer device (i.e., the thickness of the vibration transmission sheet) may be within a range of 0.1 mm to 0.2 mm. In some embodiments, a ratio of the thickness of the vibration transmission sheet along the axial direction of the transducer device to a width of any one of the support rods 4830 in a radial plane of the transducer device may be within a range of 0.16 to 0.75. The ratio of the thickness to the width may be within an exemplary range of 0.2 to 0.7, 0.26 to 0.65, 0.3 to 0.6, 0.36 to 0.55, 0.4 to 0.5, etc. In some embodiments, the thickness of the vibration transmission sheet 4800 may be within a range of 0.1 mm to 0.2 mm, and the width of the support rod 4830 may be within a range of 0.25 mm to 0.5 mm. For example, the thickness of the vibration transmission sheet 4800 may be within a range of 0.1 mm to 0.15 mm, and the width of the support rod 1251 may be within a range of 0.4 mm to 0.48 mm.

It is to be noted that the structure of the vibration transmission sheet 4800 illustrated in FIG. 46 and FIG. 47 can be applicable to the vibration transmission sheet in any acoustic output device according to the embodiments of the present disclosure, such as the first vibration transmission sheet 33131 and the second vibration transmission sheet 33132 in the acoustic output device 3300, the vibration transmission sheet 3313 in the acoustic output device 3900 and acoustic output device 4000, the vibration transmission sheet 413A and the vibration transmission sheet 413B in the acoustic output devices 400 and 700, the vibration transmission sheet 913A and the vibration transmission sheet 913B in the acoustic output device 900, the vibration transmission sheet 1213A and the vibration transmission sheet 1213B in the acoustic output device 1200, the vibration transmission sheet 2013A and the vibration transmission sheet 2013B in the acoustic output devices 2000, 2200, 2400, 2500, 2600, 2700, etc.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An acoustic output device, comprising:
a transducer device configured to generate a mechanical vibration based on an electrical signal, wherein the transducer device includes a magnetic circuit assembly and an elastic support component;
a housing configured to accommodate the transducer device, wherein the housing includes a panel and a shell, the transducer device transmits the mechanical vibration to a user through the panel; and
an additional element connected to the panel through a vibration path, the vibration path at least including an elastic element, wherein
the additional element is located at a sidewall of the shell adjacent to the panel, and the elastic support component connects the magnetic circuit assembly and the sidewall disposed with the additional element.

2. The acoustic output device of claim 1, wherein at least a portion of a connection end of the elastic support component that is connected to the sidewall is located within an orthographic projection of the additional element on the sidewall.

3. The acoustic output device of claim 1, wherein the elastic support component is connected to a side of the magnetic circuit assembly back away from the panel and is connected to an intermediate region on the side of the magnetic circuit assembly back away from the panel.

4. The acoustic output device of claim 1, wherein the elastic element is a vibration damping sheet, and the panel is elastically connected to the shell through the vibration damping sheet.

5. The acoustic output device of claim 4, wherein the transducer device further includes a vibration plate, the vibration plate being rigidly connected to the panel, and the shell being connected to the vibration plate and the panel through the vibration damping sheet.

6. The acoustic output device of claim 5, further comprising:
a support structure configured to wear the acoustic output device on an ear or a head region of the user without blocking an ear canal of the user, wherein the support structure is rigidly connected to the shell.

7. The acoustic output device of claim 1, wherein the elastic element is a ring structure with elasticity, the panel being in sealed connection with the shell through the ring structure so as to form an accommodating chamber for accommodating the transducer device.

8. (canceled)

9. The acoustic output device of claim 4 or 7, wherein the panel and a sidewall of the shell opposite to the panel are connected through the elastic element and the sidewall adjacent to the panel.

10. The acoustic output device of claim 1, wherein
the panel is rigidly connected to the shell,
the additional element is connected to the sidewall of the shell adjacent to the panel through the elastic element,
the additional element and the elastic element are part of the sidewall of the shell adjacent to the panel, and
the magnetic circuit assembly is connected to another portion of the sidewall of the shell adjacent to the panel through the elastic support component.

11. The acoustic output device of claim 1, wherein
the panel is rigidly connected to the shell,
the additional element is independently arranged relative to the shell, and
the additional element is connected to the sidewall of the shell adjacent to the panel through the elastic element.

12. The acoustic output device of claim 10 or 11, wherein the elastic element is a reed structure or a ring structure with elasticity.

13. (canceled)

14. The acoustic output device of claim 1, wherein the magnetic circuit assembly includes an aperture portion and a positioning rod,
the aperture portion penetrates the magnetic circuit assembly in a vibration direction of the transducer device,
an end of the positioning rod away from the panel is connected to a back panel in the shell opposite to the panel, and another end of the positioning rod passes through the aperture portion and is connected to the panel.

15. The acoustic output device of claim 1, wherein the elastic support component includes a center region, an edge region, and a plurality of support rods connecting the edge region and the center region,
the center region of the elastic support component is connected to a side of the magnetic circuit assembly back away from the panel, and the edge region of the elastic support component is connected to the sidewall of the shell adjacent to the panel.

16. The acoustic output device of claim 15, wherein in a natural state of the elastic support component, the edge region of the elastic support component is not coplanar with the center region of the elastic support component.

17. The acoustic output device of claim 15, wherein the plurality of support rods includes four support rods, and the four support rods are disposed at intervals along a circumferential side of the center region of the elastic support component.

18. (canceled)

19. The acoustic output device of claim 1, wherein the additional element includes an air-conduction loudspeaker, wherein an included angle between a vibration direction of a diaphragm of the air-conduction loudspeaker and a vibration direction of the transducer device is within a range of 75 degrees to 100 degrees.

20-21. (canceled)

22. An acoustic output device, comprising:
a transducer device configured to generate a mechanical vibration based on an electrical signal, wherein the transducer device includes a magnetic circuit assembly and an elastic support component;
a panel and a back panel opposite to the panel, wherein the panel is rigidly connected to the back panel through a housing body, and the transducer device transmits the mechanical vibration to a user through the panel;
a support component; and
an additional element rigidly connected to the support component, wherein the support component is disposed between a plane in which the panel is located and a plane in which the back panel is located, the support component is connected to a housing through an elastic element, and the magnetic circuit assembly is connected to the housing body or the support component through the elastic support component.

23-24. (canceled)

25. The acoustic output device of claim 22, wherein the elastic element includes a first elastic element and a second elastic element, one end of the support component is connected to the panel through the first elastic element, and another end of the support component is connected to the back panel in the housing body through the second elastic element.

26. The acoustic output device of claim 25, wherein
the first elastic element and the second elastic element are reed structures, the first elastic element is located between the magnetic circuit assembly and the panel,
the second elastic element is located between the magnetic circuit assembly and the back panel,
a side of the first elastic element back away from the magnetic circuit assembly is connected to the panel,
a side of the second elastic element back away from the magnetic circuit assembly is connected to the back panel,
a peripheral side of the first elastic element is connected to one end of the support component, and
a peripheral side of the second elastic element is connected to another end of the support component.

27. The acoustic output device of claim 25, wherein
the first elastic element and the second elastic element are ring structures with elasticity,
the first elastic element and the second elastic element are located at two ends of the support component, respectively,
one end of the support component is connected to the panel through the first elastic element, and
another end of the support component is elastically connected to the back panel through the second elastic element.

28-37. (canceled)
